(19) United States
(12) Patent Application Publication
(10) Pub. No.: US 2007/0219847 A1
(43) Pub. Date: Sep. 20, 2007

(54) Internet-based marketing and sales application and method for targeted marketing of a product and/or service

(76) Inventor: Kazimierz Ogonowski, Toronto (CA)

Correspondence Address: BAKER & DANIELS LLP;111 E. WAYNE STREET, SUITE 800, FORT WAYNE, IN, 46802, US

(21) Appl. No.: 11/375,738

(22) Filed: Mar. 15, 2006

(51) Int. Cl. G07G 1/00

(52) U.S. Cl. 705/10

(57) ABSTRACT

A method for determining a secondary value having a second-highest priority in a list of values in a spreadsheet is provided. A primary value having a highest priority in the list of values is determined. The secondary value is determined to be equal to the primary value if more than one of the values in the list is equal to the primary value. The secondary value is determined to be equal to one of the list of values not equal to the primary value having a relative highest priority if only one of the values in the list is equal to the primary value.

### FIELD OF THE INVENTION

The present invention relates generally to marketing and sales and in particular to a distributed computer network embodying a marketing and sales application, to a method for managing a rollover and to a method for verifying data in a spreadsheet.

### BACKGROUND OF THE INVENTION

It is well known that marketing activities often translate directly into business opportunities. Although many businesses take advantage of changes in marketing techniques, some well-established business sectors have failed to do so. The insurance industry is an example of such a business sector and has typically made use of a shotgun marketing approach to target potential prospects. During this approach, a service such as Dunn & Bradstreet is hired by an insurer to develop a list of potential prospects. The prospects in the list are passed along to a telemarketer who is responsible for calling the prospects to determine if they are interested in the insurance offered by the insurer. In many instances a significant number of prospects in the developed list are inappropriate. The costs associated with enlisting a telemarketer to call the prospects in the list can be significant. Thus, having lists of prospects with significant numbers of inappropriate prospects is problematic. Also, there is no control of data collected by the telemarketer relating to the called prospects. As will be appreciated there is a need for improved marketing and sales techniques in this and other business sectors.

Additionally, in many industries, it is not uncommon for a product and/or service provider to make a decision to discontinue a line of business representing an insurance product. Where the product is insurance, the insurer may be obligated to honor the current policies for the remainder of the term, which is typically one year. In such instances, policyholders are advised that the insurer will discontinue coverage after the end of the policyholders' policy year. The policy year end dates are typically distributed over the course of the year. Where an agent, commonly referred to in the insurance industry as an “insurance broker” or simply “broker”, has placed business with the current insurer, the broker is generally interested in placing the block of insurance business, generally referred to as a book of insurance, with another insurer himself; otherwise the individual policyholders may seek alternate insurers themselves or via other brokers, thus removing the broker from the revenue stream. In such cases, it can be advantageous for a broker to proactively contact an alternate insurer for the insurance product sought, such that the broker is able to provide policyholders with a readily available alternative. Further, the broker may be in a position to benefit the policyholders by obtaining discounted rates for the insurance to be purchased, additional features for the insurance, or some other benefit where the broker is looking to transfer a block of business. Often, the discounts are related to the portion of the block of business that the broker believes will actually transfer to the new insurer.

This transfer of a block of business is commonly referred to as a “rollover”. Once an agreement between the broker and the new insurer has been established, the broker markets the insurance provided by the new insurer to the policyholders (“prospects”). The broker typically contacts each policyholder near to the policy expiry date of the current insurance policy to allow the policyholder to quickly obtain continued insurance coverage and thereby provide seamless coverage to the policyholder.

Presently, brokers typically use internal tools or information management systems to manage the reminders for the policy expiry date notices. In the case of a rollover, the broker can either set reminders in some type of database system in which the data is maintained for each policyholder or can export the data to an information management system such as a personal information manager. By using such a system however, the insurer must rely on the broker for updated information and cannot monitor the updated status of the rollover.

Additionally, where the broker is responsible for a number of marketing campaigns and rollovers, manual intervention is typically required to produce useful reports and summaries to assist the broker in managing the campaigns and rollovers. Further, where an insurer is operating a number of campaigns and rollovers, the insurer is not able to view their current status and relies on information reports provided by the brokers.

It is therefore an object of the present invention to provide a novel distributed computer network embodying a marketing and sales application, a method for managing a rollover and a method for verifying data in a spreadsheet.

### SUMMARY OF THE INVENTION

Accordingly, in one aspect there is provided a distributed computer network comprising:

an item provider computer system maintaining at least one dataset in a database, said at least one dataset identifying a block of business comprised of a list of prospects that have purchased products from another item provider through an agent, said item provider computer system running a marketing and sales application, said agent having indicated interest in transferring said block of business from said other item provider to said item provider; and

at least one agent client computer system communicating with said item provider computer system over a secure Internet connection to enable said agent to interact with said marketing and sales application, said agent being provided with on-line access to said dataset to track said block of business in said database.

In one embodiment, the item provider computer system includes at least one web server and at least one database server. The said at least one web server communicates with the at least one agent computer system. The at least one database server accesses the database in response to the at least one web server and provides data to the web server for display by the at least one agent computer system. The database can maintain a plurality of different datasets representing a plurality of different blocks of business. The item provider computer system communicates with a plurality of agent client computer systems.

The agent can access the item provider computer service to indicate whether a prospect obtains products from the item provider. The item provider is able to track a transfer rate equal to the portion of business transferred from the other item provider to the item provider over all of the block of business.

When the item is insurance, the gathered data that is used to determine when the agent contacts each prospect, is the expiry date (“ex-date”) of each prospect's existing insurance policy with the other item provider. The agent contacts each prospect a fixed number of days prior to the ex-date.

The items can be inputted by the item provider and can be verified by the agent.

In another aspect, there is provided a distributed computer network comprising:

an item provider computer system maintaining at least one campaign in a database, said at least one campaign identifying a first list of prospects for purchasing an item, said item provider computer system running a marketing and sales application, said marketing and sales application allowing an item provider user to electronically appoint an agent for said at least one campaign, said item provider computer system additionally maintaining at least one rollover in said database, said rollover identifying a second list of prospects that have purchased said item from another item provider via said agent, said agent being interested in selling said item from said item provider to said prospects in said second list; and

at least one agent client computer system communicating with said item provider computer system over a secure Internet connection to enable said agent to interact with said marketing and sales application, said agent being provided with on-line access to said second list of prospects in said database, and said agent being provided with on-line access to said first list of prospects in said database when said agent is electronically appointed.

The items can have an expiry date, wherein each of the prospects in the first list have previously purchased the items, and wherein the expiry dates for the first and second lists of prospects are maintained by the item provider computer system. Further, the item provider computer system can be operable to present a combined list of the prospects on the first and second lists in date order.

In a further aspect, there is provided an Internet-based marketing and sales application to facilitate targeted marketing of an item supplied by an item provider, said marketing and sales application comprising:

means for maintaining at least one dataset in a database, said at least one dataset representing a block of business purchased from another item provider through an agent, said agent having indicated interest in transferring said block of business from said other item provider to said item provider; and

means for managing said dataset electronically to track what portion of said block of business is transferred to said item provider.

The block of business can be comprised of a plurality of insurance policies issued to a number of policyholders. Further, the means for managing can include means to track expiry dates associated with the insurance policies.

In a still further aspect, there is provided a method for managing a rollover comprising the steps of:

receiving a dataset for a rollover, said dataset comprising a number of policyholders that purchased insurance policies from another insurance provider and managed by an agent;

storing said dataset in a computer system; and

providing said agent with access to said dataset stored in said computer system to indicate whether each of said policyholders will purchase a corresponding insurance policy from an insurance provider.

The dataset can include an expiry date for each of the insurance policies and premiums corresponding to the insurance policies from the other insurance provider.

The dataset is stored in a database and the step of providing is performed by providing the agent access to a web server in communication with the database.

The method can include the step of receiving transfer information from the agent indicating whether the policyholders will purchase insurance policies from the insurance provider.

In accordance with a still yet further aspect, there is provided a method for determining a secondary value having a second-highest priority in a list of values in a spreadsheet, comprising:

determining a primary value having a highest priority in said list of values;

determining if more than one of said values in said list is equal to said primary value; and

determining said secondary value to be equal to said primary value if more than one of said values in said list is equal to said primary value, and as one of said list of values not equal to said primary value having a relative highest priority if only one of said values in said list is equal to said primary value.

In still yet another aspect, there is provided a method for verifying data in a spreadsheet, said data including a set of records, comprising:

determining if each of a subset of said set of records having a first common trait share a second common trait; and

indicating whether said subset of said sets of records share said second common trait.

In still yet another aspect, there is provided a method of verifying data in a spreadsheet, comprising:

placing a set of records in said spreadsheet;

locating a subset of said records corresponding to an entity;

checking whether said records in said subset are valid; and

providing a visual notification when at least one of the following conditions is met: the number of said records in said subset is undesirable, and at least one of said records in the subset are invalid.

### BRIEF DESCRIPTION OF THE DRAWINGS

Embodiments will now be described more fully with reference to the accompanying drawings in which:

FIGS. 1a to 1c are flowcharts showing the steps performed during a method for targeted marketing of a product and/or service;

FIGS. 2a to 2c show an exemplary marketing material mailer;

FIG. 3 is an exemplary script used by a telemarketer during performance of the method of FIGS. 1a to 1c.

FIG. 4 is an exemplary lead sheet used by a telemarketer during performance of the method of FIG. 1a to 1c.

FIG. 5 shows an exemplary thank you letter mailer;

FIG. 6 is a schematic block diagram of a database structure;

FIG. 7 is a diagram illustrating a distributed computer architecture including an insurer computer system, a telemarketer computer system and broker computer systems communicating over the Internet;

FIGS. 8a to 8jj are screen shots of web pages accessible to an administrator user accessing a marketing and sales application running on the insurer computer system illustrated in FIG. 7;

FIGS. 9a to 9g are screen shots of web pages accessible to a telemarketer user accessing the marketing and sales application;

FIGS. 10a to 10o are screen shots of web pages accessible to a broker user accessing the marketing and sales application;

FIG. 11 is a flowchart showing the steps performed during another method for targeted marketing of a product and/or service;

FIGS. 12a to 12z are screen shots of web pages accessible to an administrator user accessing a marketing and sales application carrying out the method of FIG. 11 and running on the insurer computer system illustrated in FIG. 7;

FIGS. 13a to 13k are screen shots of web pages accessible to a broker user accessing the marketing and sales application;

FIG. 14 is a schematic diagram of the layout of a Microsoft Excel workbook for analyzing the performance of policies generated as a result of the targeted marketing method of FIG. 1;

FIG. 15 shows a portion of a data import sheet of the workbook of FIG. 14;

FIGS. 16a to 16d show a portion of an annual summary sheet of the workbook of FIG. 14;

FIG. 17 shows a portion of a price summary sheet of the workbook of FIG. 14;

FIG. 18 shows a portion of a policy summary sheet of the workbook of FIG. 14;

FIG. 19 shows a portion of a campaign summary sheet of the workbook of FIG. 14;

FIGS. 20a to 20c show a portion of a broker summary sheet of the workbook of FIG. 14;

FIG. 21 shows a portion of a new policies summary sheet of the workbook of FIG. 14;

FIG. 22 shows a formula used to validate data in the workbook of FIG. 14;

FIG. 23 shows a formula used to determine the second-highest loss from a range of values in the workbook of FIG. 14;

FIG. 24 shows a data validation calculation in accordance with another aspect of the present invention;

FIG. 25 shows a data validation formula from the data validation calculation of FIG. 24; and

FIG. 26 shows another data validation formula from the data validation calculation of FIG. 24.

### DETAILED DESCRIPTION OF THE EMBODIMENTS

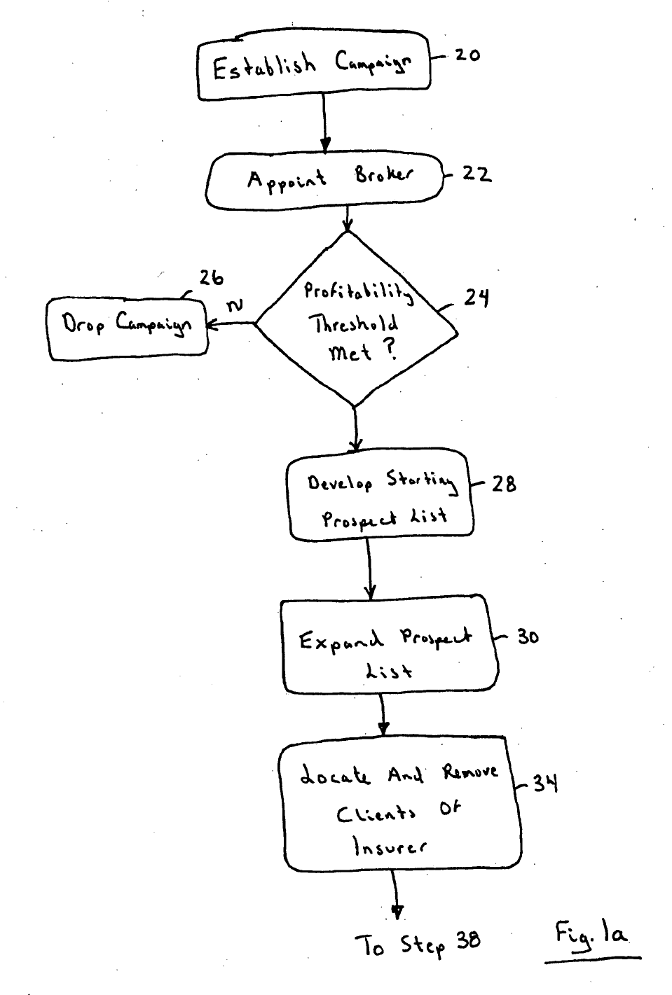

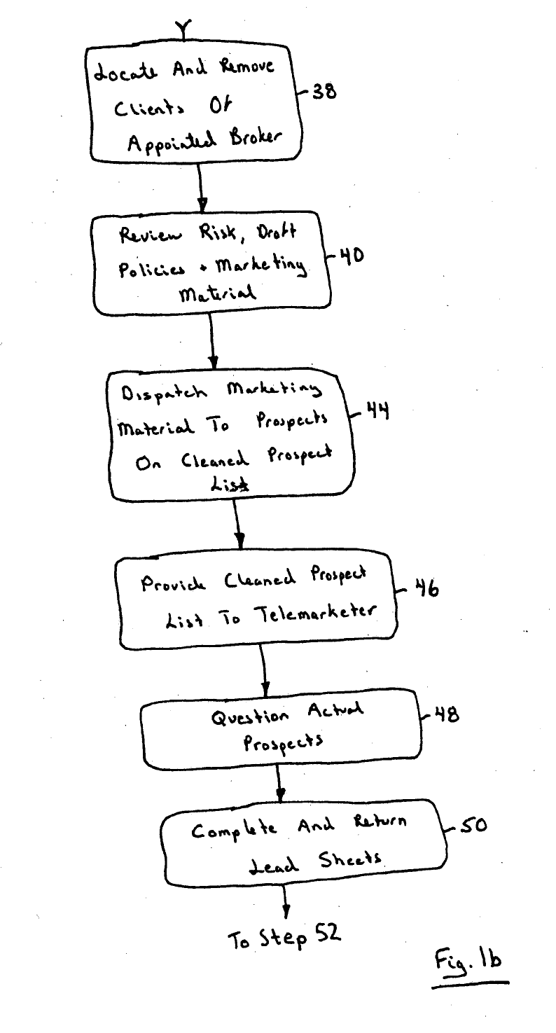

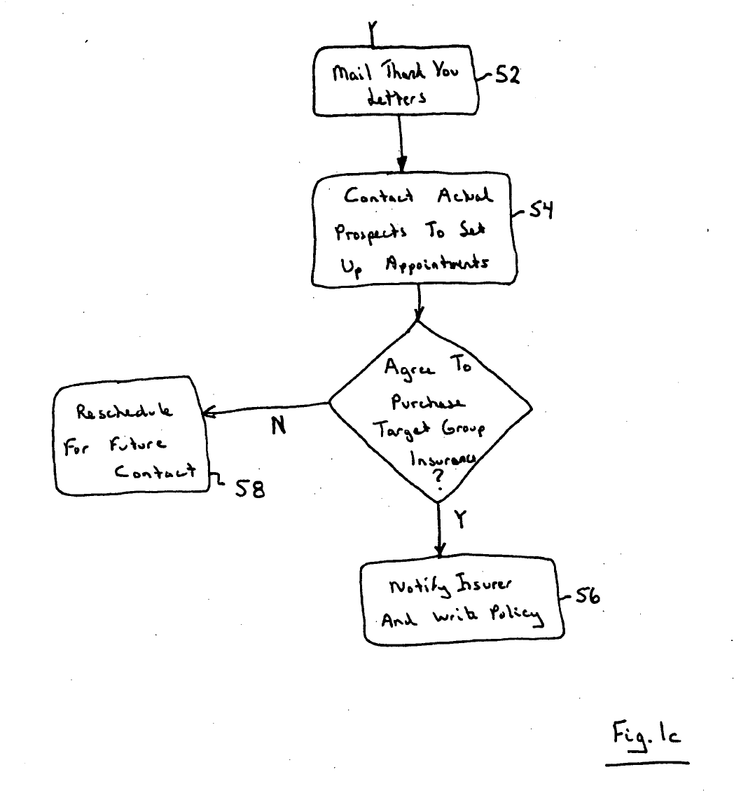

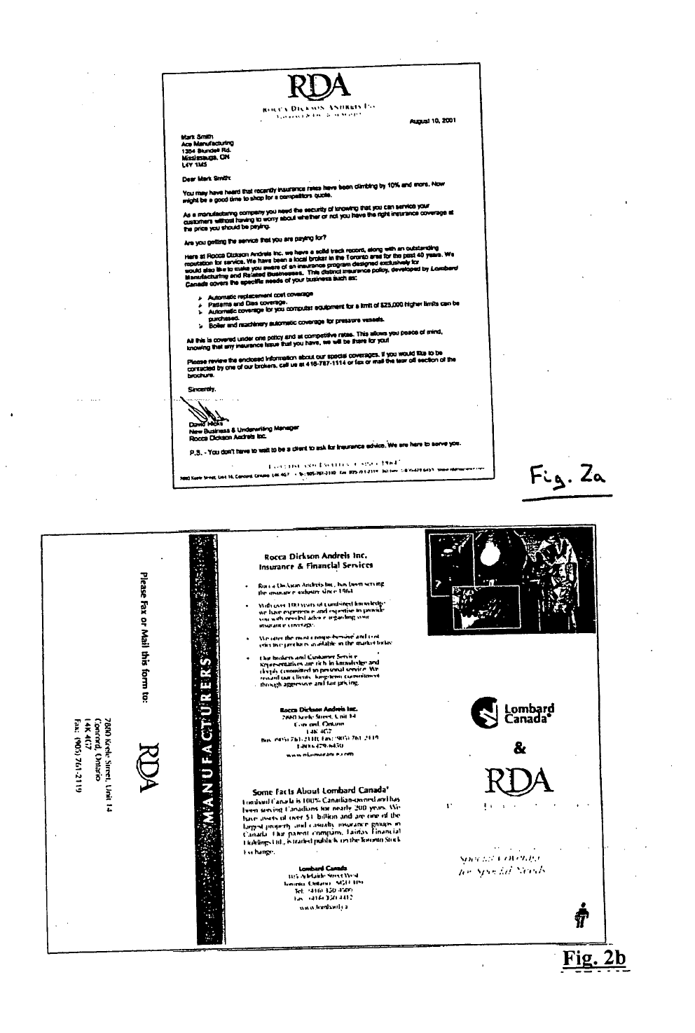

A distributed computer network embodying a marketing and sales application for targeted marketing of a product and/or service (herein referred generically to as “marketed item”) and methods for managing a rollover and for verifying data in a spreadsheet are provided. In one method, a campaign for the item is established. The campaign identifies a list of prospects within a specified geographical region. A broker and a telemarketer are appointed to the campaign. The telemarketer contacts the prospects in the list to determine the prospects potentially interested in the item (“actual prospects”). The appointed broker is provided with a list of the actual prospects so that the appointed broker may contact the actual prospects in an attempt to sell the item to the actual prospects. As will be appreciated, by providing the appointed broker with a list of actual prospects, the appointed broker is given targeted leads. In this embodiment, the marketed item is insurance. As mentioned previously, the insurance industry has been slow to change marketing techniques used to offer insurance to prospective clients (“prospects”). The method for targeted marketing of insurance will now be generally described with particular reference to FIGS. 1a to 1c.

Initially, a campaign for marketing and selling insurance to a particular target group within a specified geographical region is conceived by the insurer (step 20). The target group relates to a particular industry sector and will typically include a plurality of prospects operating businesses within the specified geographical region. Once the target group of the campaign is determined, a broker for that particular target group is appointed by the insurer (step 22). The target group and appointed broker are then verified to ensure they are profitable (step 24). A number of different brokers may be considered during step 22 before the profitability threshold of step 24 is met. If a profitable target group and broker combination for the campaign cannot be determined at step 24, the campaign is dropped (step 26). After a profitable target group and broker combination is determined at step 24, a starting prospect list for the campaign is developed that includes potential prospects in the target group (step 28). The starting prospect list is developed using a number of list resources such as Info Canada, Dunn & Bradstreet, association lists, brokers lists and other list sources that identify potential prospects within the specified geographical region. The prospect list identifies the prospects by name, address and other relevant information available.

Once the starting prospect list has been completed, the starting prospect list is expanded using Internet searches, library resources and/or other research (step 30). The expanded prospect list is then run through a two-stage cleaning process. During the first cleaning stage, the expanded prospect list is examined to locate and remove listed prospects that are already clients of the insurer (step 34). During the second cleaning stage, the modified prospect list is examined to locate and remove listed prospects that are already clients of the appointed broker (step 38). Prospects deleted from the expanded prospect list of course, create a starting market for the target group insurance. With the prospect list cleaned, underwriters of the insurer review the risks associated with the target group and draft policies and marketing material (step 40).

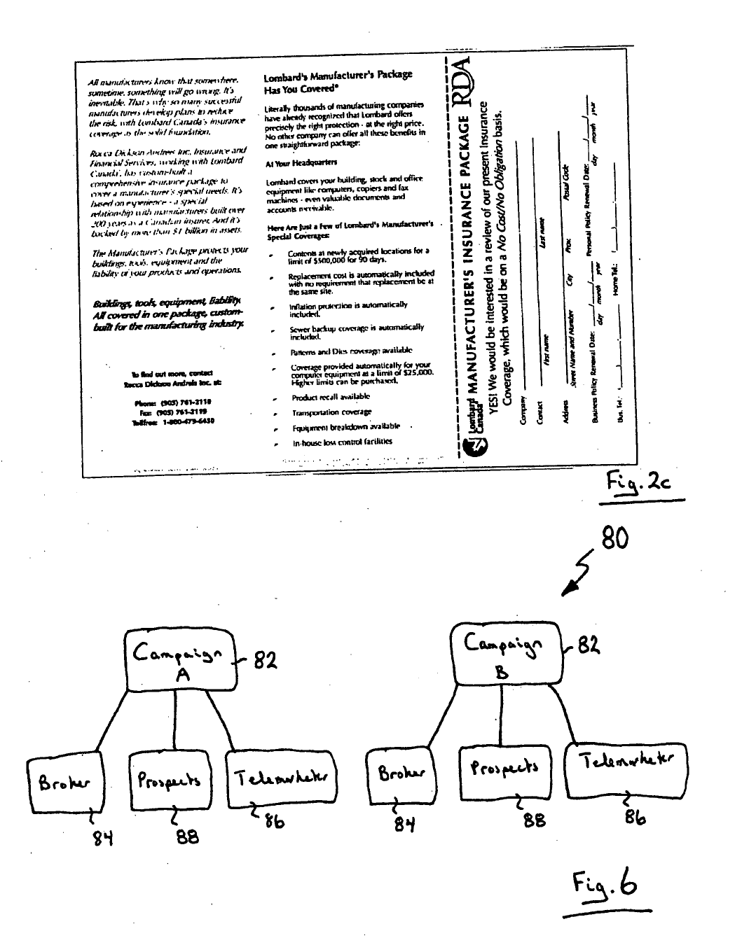

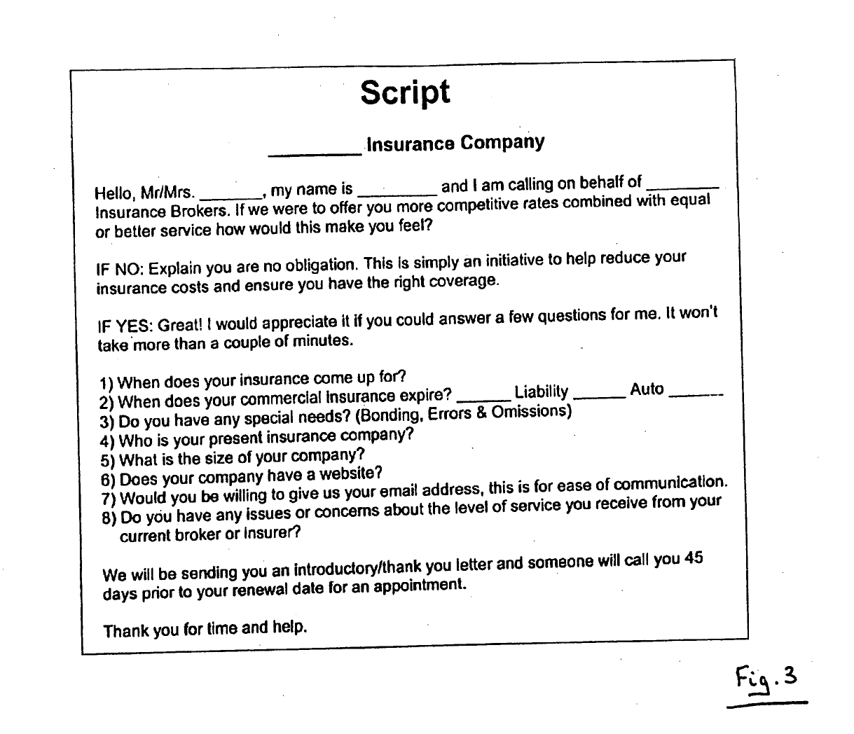

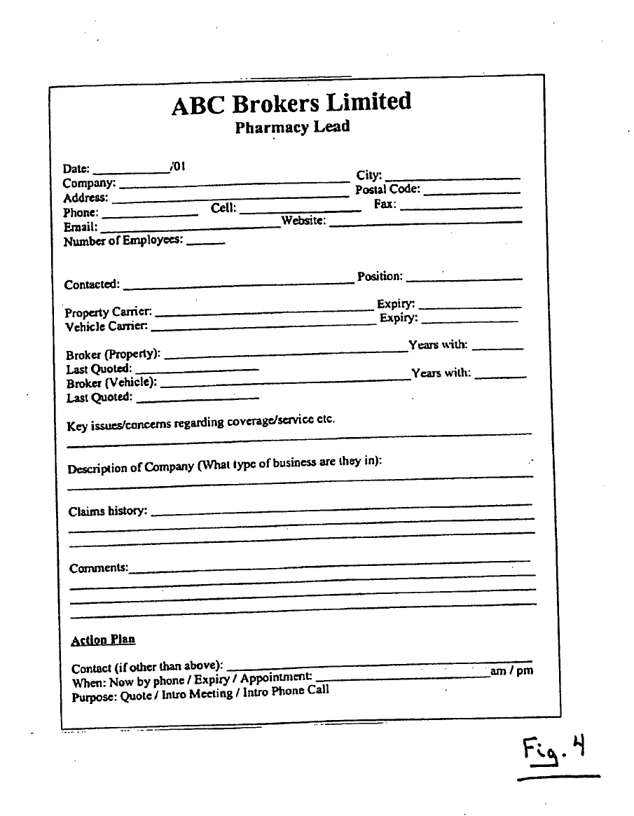

Following step 40, a three stage marketing process is performed. Initially, marketing material is mailed directly to the prospects on the cleaned prospect list (step 44). The marketing material is generated and mailed by the insurer but is on the letterhead of the appointed broker. FIGS. 2a to 2c show an exemplary marketing material mailer.

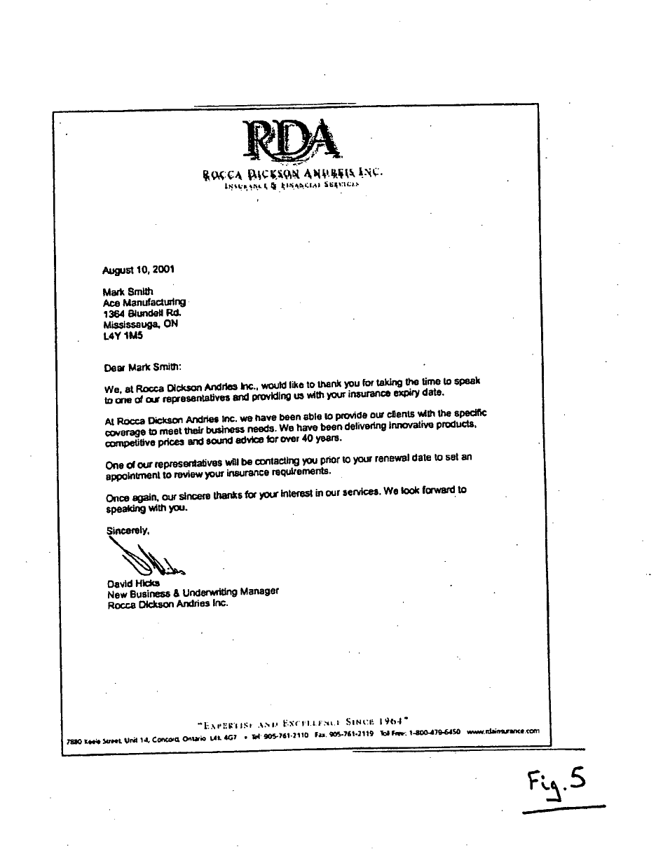

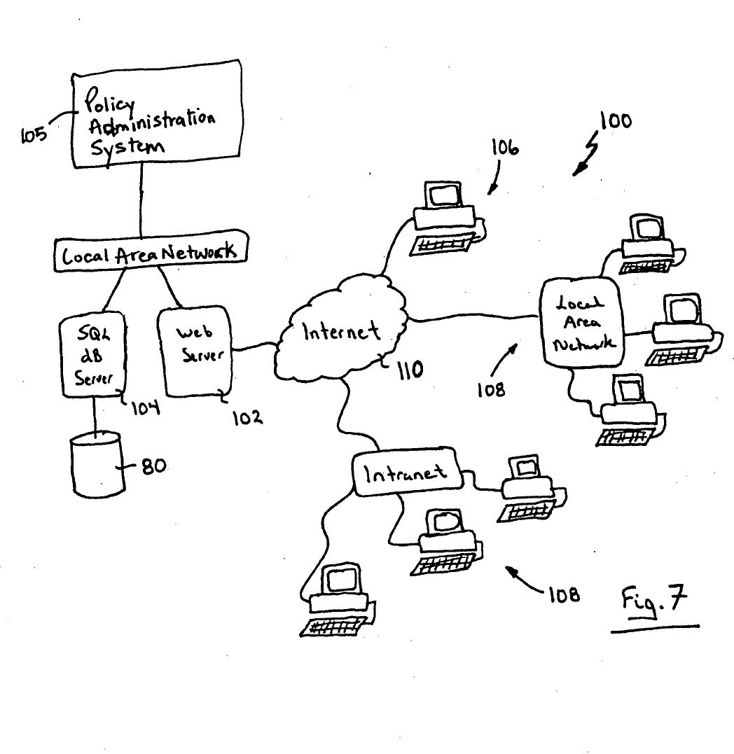

After the marketing material has been mailed, the cleaned prospect list is given to an appointed telemarketer (step 46). The appointed telemarketer in turn contacts the prospects on the cleaned prospect list to determine which prospects on the cleaned prospect list are prospects that are actually interested in the target group insurance (“actual prospects”). Actual prospects are asked a series of questions following a script such as that shown in FIG. 3 (step 48). Lead sheets are completed by the telemarketer based on the information gathered in response to the series of questions as shown in FIG. 4. The completed lead sheets are returned to the insurer allowing the insurer to identify the actual prospects listed on the cleaned prospect list (step 50). The collected data is also used to enhance the information in the prospect list allowing more detailed information concerning prospects to be maintained. Thank you letters are then generated and mailed to the actual prospects by the insurer but on the letterhead of the appointed broker (step 52). The thank you letters inform the actual prospects that they will be contacted by the appointed broker a fixed number of days prior to the expiry date (ex-date) of their current insurance policy. An exemplary thank you letter mailer is shown in FIG. 5.

Once the telemarketing has been completed and with the actual prospects from the cleaned prospect list known, the appointed broker is provided with the list of actual prospects (i.e. targeted leads) so that the appointed broker may contact the actual prospects at the appropriate times to set up appointments (step 54). In this manner, producers employed by the appointed broker may meet with the actual prospects in an attempt to sell the actual prospects the target group insurance. When an actual prospect agrees to purchase the target group insurance, the insurer is notified so that a policy may be written (step 56). If a policy for the prospect is written, the policy information is added to the data associated with the prospect. If the actual prospect declines to purchase the target group insurance, depending on the reason for declining the target group insurance, the actual prospect may be contacted in the future if the actual prospect is considered to be a cold lead (step 58). Prospects that are considered to be dead leads are not pursued further.

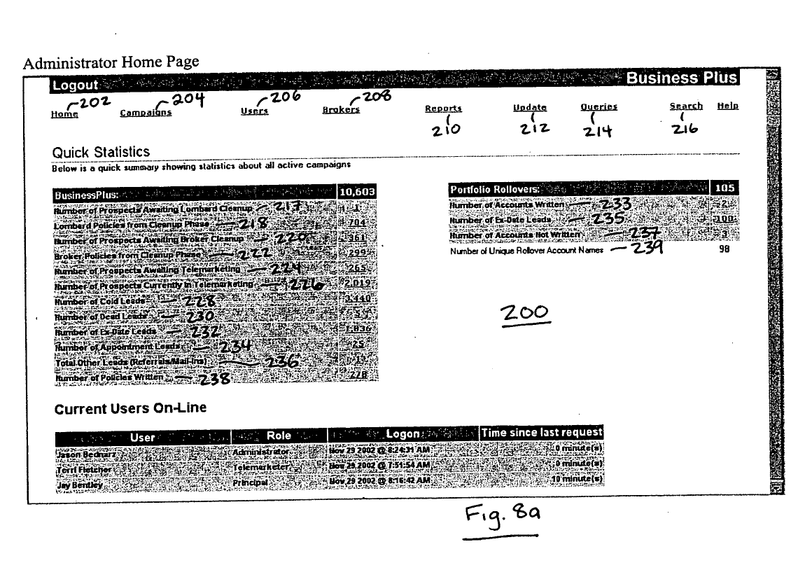

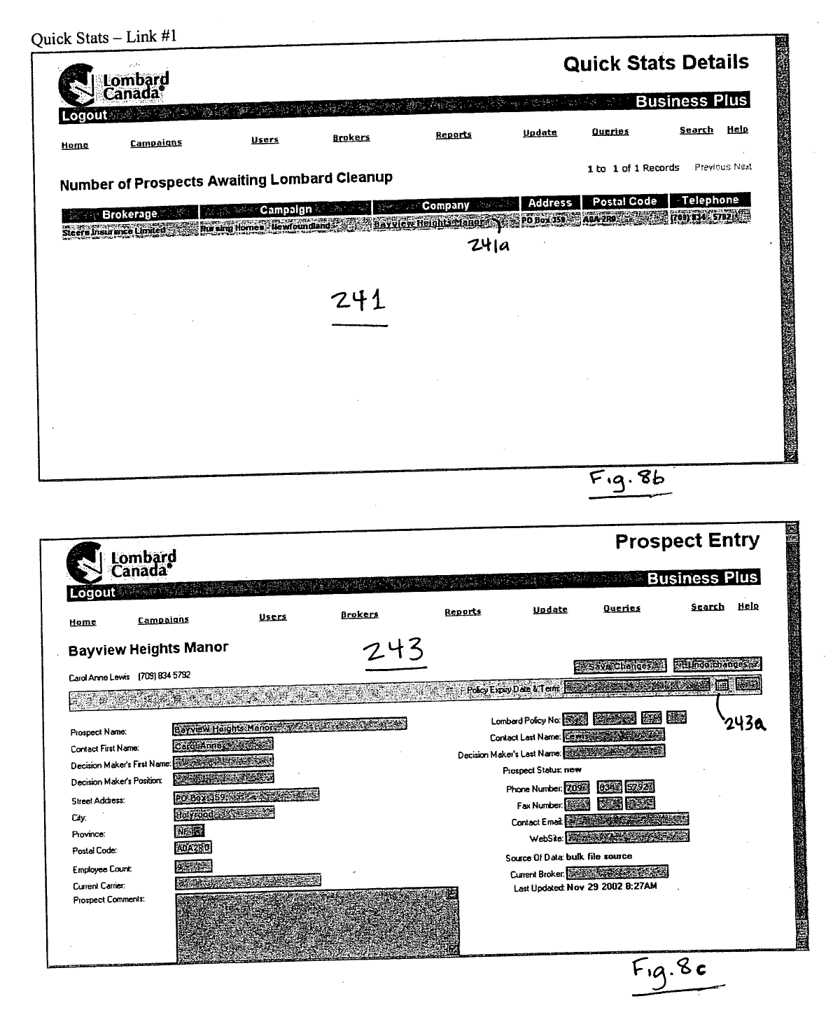

To facilitate performing the above method, an Internet-based marketing and sales application is maintained by the insurer and is accessible to telemarketers and appointed brokers over the Internet. The marketing and sales application data is maintained in a database 80 (see FIG. 6) and includes data relating to all campaigns 82 being pursued by the insurer, the broker 84 appointed to each campaign 80, the telemarketer 86 appointed to each campaign 80 and the prospects 88 (both cleaned and actual) associated with each campaign 80.

Specifically, the database stores a profile for each campaign being pursued by the insurer, a profile for each broker appointed to a campaign and a profile for each prospect associated with each campaign. Each campaign profile identifies the campaign by target group, target area identifying the specified geographical region, campaign description, the broker appointed to the campaign, the campaign start date, the campaign end date and general commentary.

Each broker profile identifies the broker name, the broker agency number, and contact information.

Each prospect profile identifies the prospect by name, contact information, ex-date if the prospect has not been sold insurance and policy number if the prospect has been sold insurance.

Turning now to FIG. 7, a distributed computer architecture supporting the marketing and sales application is shown and is generally identified by reference numeral 100. Computer architecture 100 includes an IIS web server 102, a SQL database server 104 and a policy administration system 105 in communication over a local area network located at the insurer's business location. The web server 102 runs the Internet-based marketing and sales application, which includes active server page (ASP) files containing code written in Visual Basic (VB) script, Java script and Hypertext Markup Language (HTML). The SQL database server 104 supports the SQL database 80 that acts as the backend repository for the marketing and sales application data. The policy administration system 105 stores policy data and permits management thereof. A telemarketer client computer system 106 and broker client computer systems 108 communicate with the web server 102 over the Internet 110 via web browsers running on the client computer systems 106 and 108. As is well known, the Internet 110 provides a backbone of high-speed data communication lines between host computers that route data and messages using the Transmission Control Protocol/Internet Protocol (TCP/IP) suite of protocols. The telemarketer client computer system 106 and the broker client computer systems 108 may be stand-alone personal computers, local area networks or Intranets.

During communications between the web server 102 and the client computer systems 106 and 108, the web server 102 sends ASP files to the client computer systems 106 and 108 in response to requests generated by the web browsers. The ASP files received by the client computer systems 106 and 108 cause the web browsers to display formatted web pages to the users of the client computer systems 106 and 108. This enables users to access and interact with the marketing and sales application through a web-based graphical user interface (GUI). Although only one telemarketer client computer system 106 and two broker client computer systems 108 are shown, those of skill in the art will appreciate that this is for ease of illustration only. The web server 102 may of course communicate with virtually any number of telemarketer client computer systems 106 and broker client computer systems 108.

As mentioned above, the marketing and sales application supports and is used extensively during performance of the above-described method for targeted marketing of an item. Data in the database 80 that is relevant to the telemarketers and appointed brokers is made accessible to them via web browsers over secure Internet connections. Data in the database 80 that is relevant to the insurer is similarly accessible via web browsers over secure Intranet connections. As is common, the marketing and sales application provides for staged access to data in the database 80 based on assigned user security level. At the administrator level, unrestricted access to data in the database 80 is permitted. Various other security levels ranging from significant data access to read only access are also provided for; however, since this type of staged security data access is well known and unrelated to the present invention, further specifics will not be described herein.

During performance of the method of FIGS. 1a to 1c, once it is verified that the target group and appointed broker for a campaign are profitable, the campaign is entered into the marketing and sales application by completing a formatted web page. Once saved, the campaign profile is stored in the database 80. The prospects on the expanded prospect list associated with the campaign are also entered into the marketing and sales application by completing formatted web pages. Once saved, the prospect profiles are stored in the database 80.

Once the expanded prospect list has been cleaned to remove existing clients of the insurer and the broker at steps 34 and 38, the marketing and sales application is conditioned to generate automatically a marketing material mailer similar to that shown in FIGS. 2a to 2c, for each of the prospects on the cleaned prospect list.

The marketing and sales application is also used to select the telemarketer to be used during the campaign via a formatted web page. Once the telemarketer has been selected, the marketing and sales application permits the selected telemarketer to access relevant prospect data thereby to enable the telemarketer to contact and question the prospects on the cleaned prospect list.

The marketing and sales application permits the telemarketer to input data to the marketing and sales application based on the questionnaire results so that the marketing and sales application can identify the actual prospects in real time and automatically generate the thank you letter mailers shown in FIG. 5.

Once the actual prospects are known and identified by the marketing and sales application, the marketing and sales application permits the appointed broker to access relevant prospect data thereby to enable producers of the appointed broker to contact the actual prospects in an attempt to sell the target group insurance.

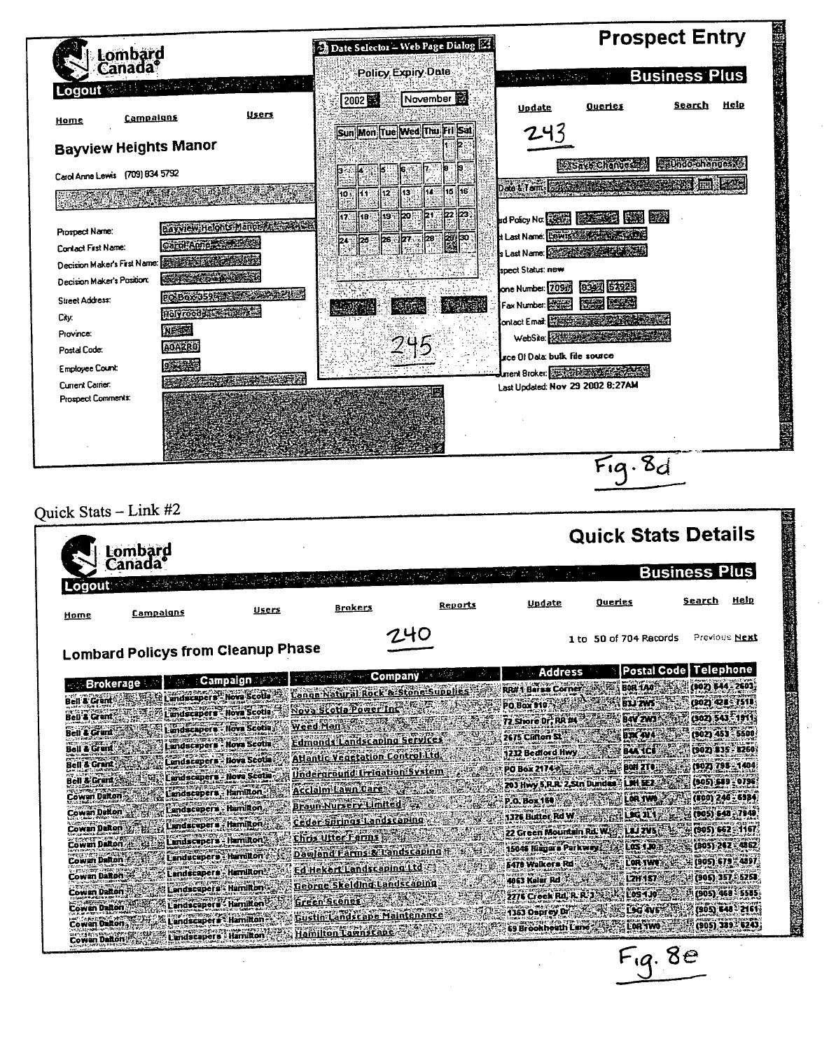

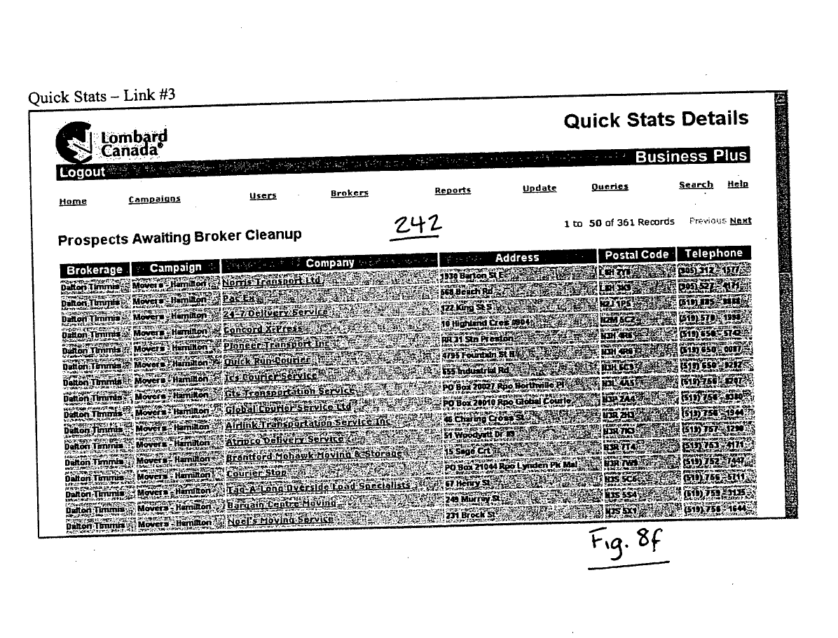

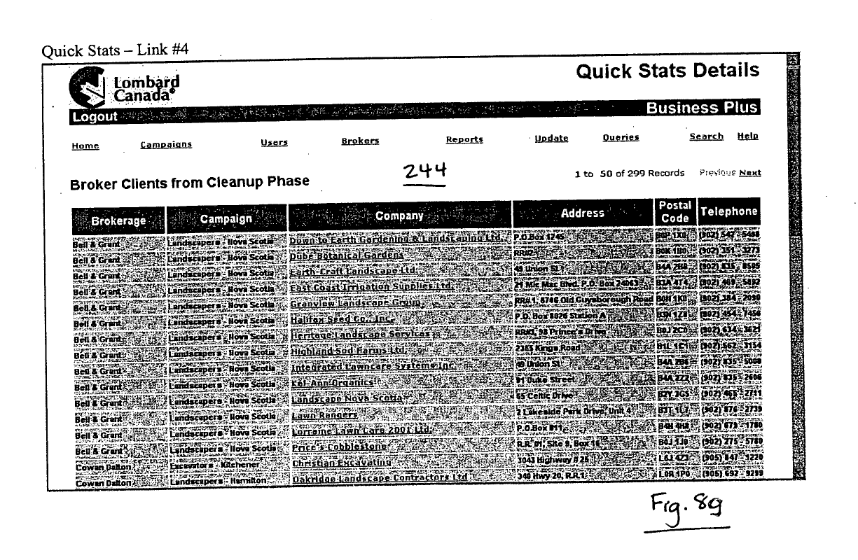

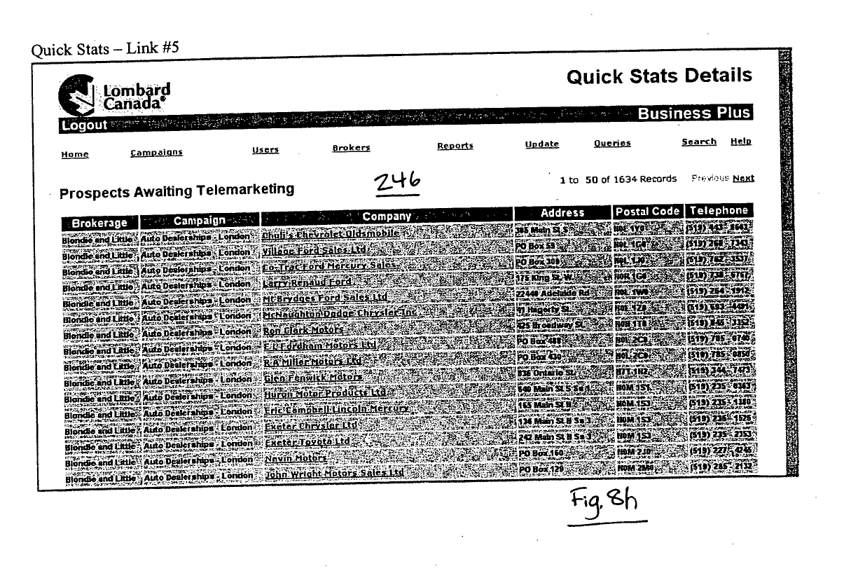

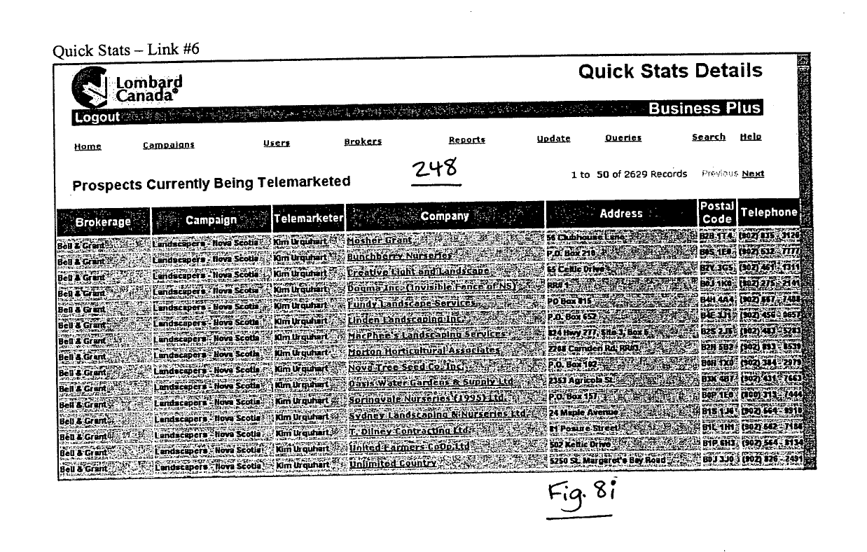

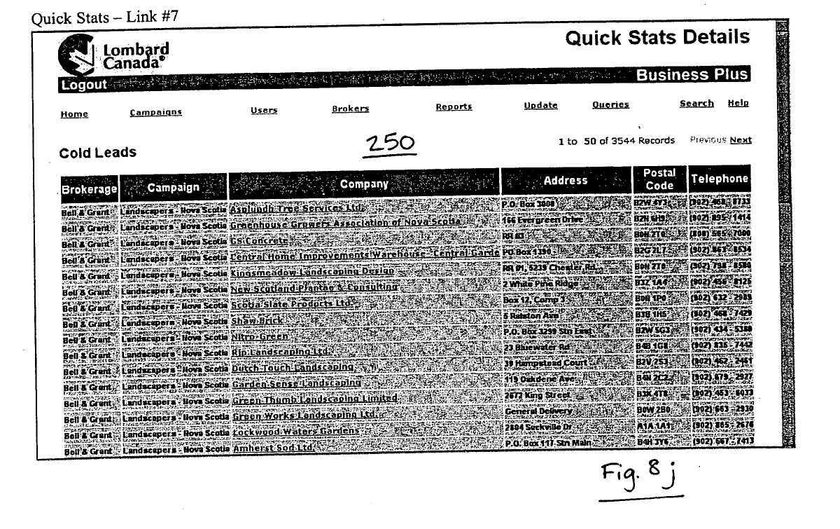

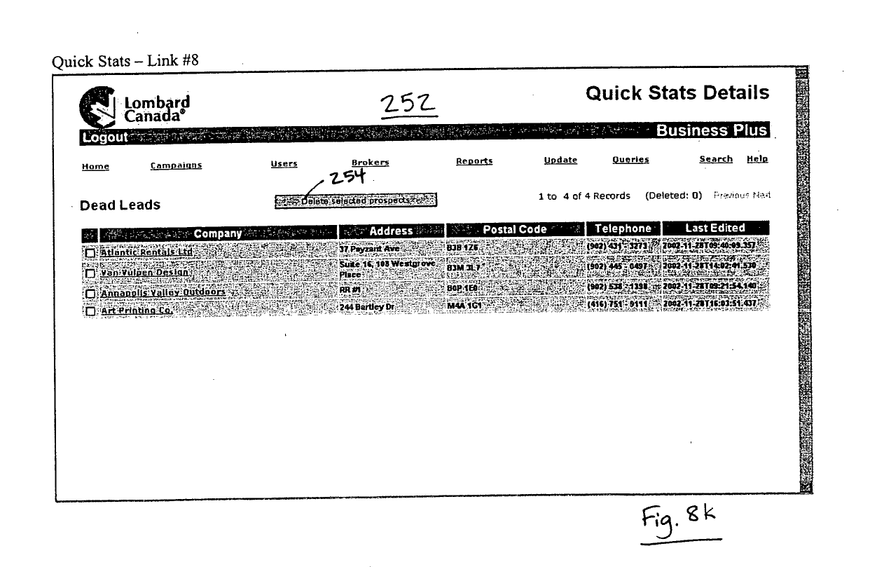

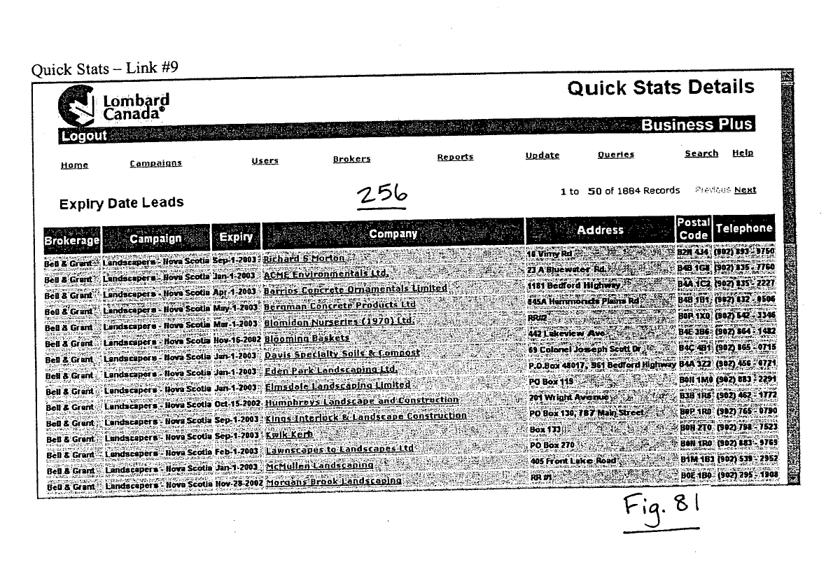

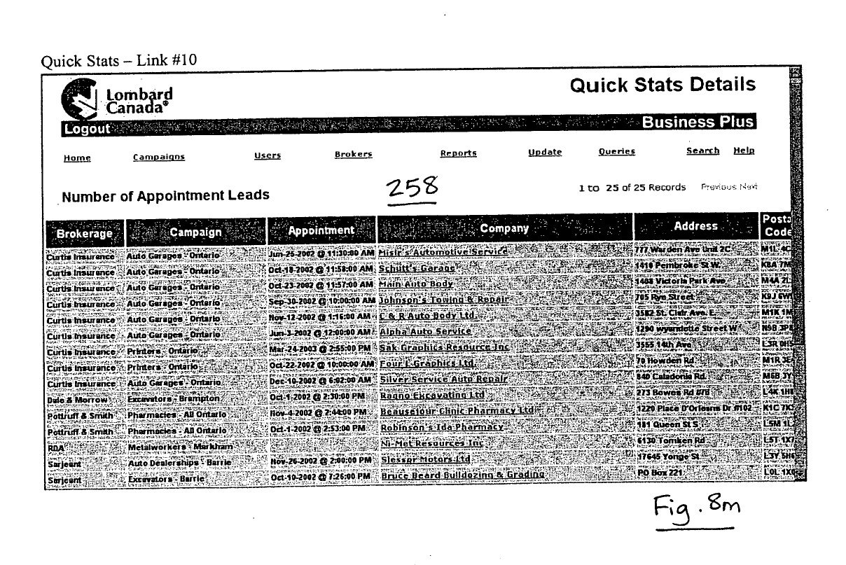

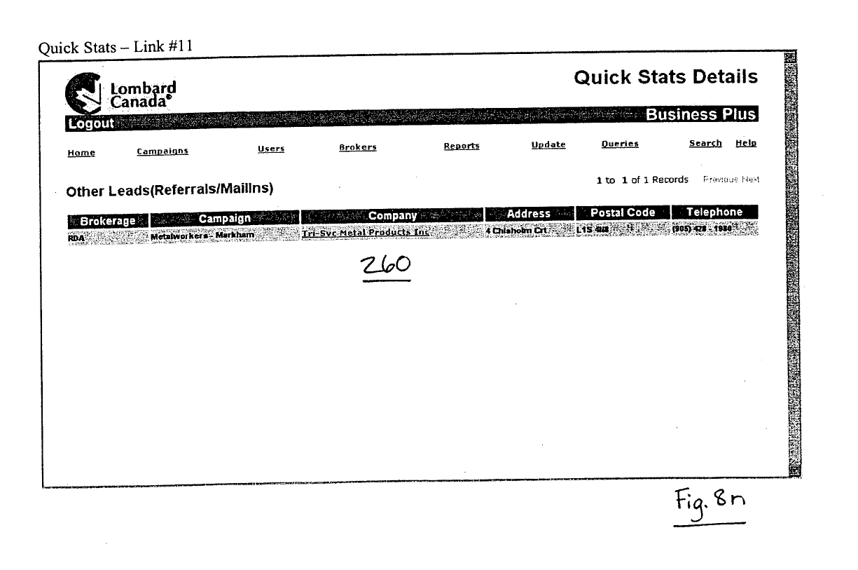

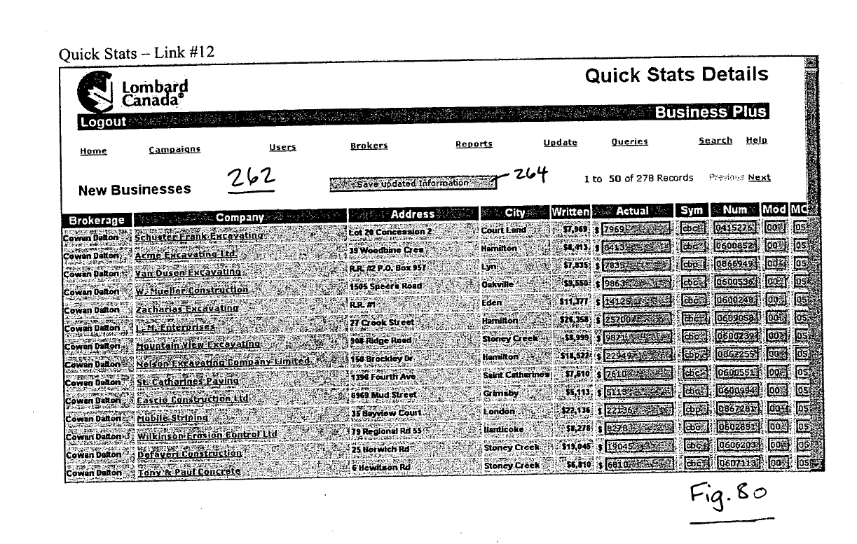

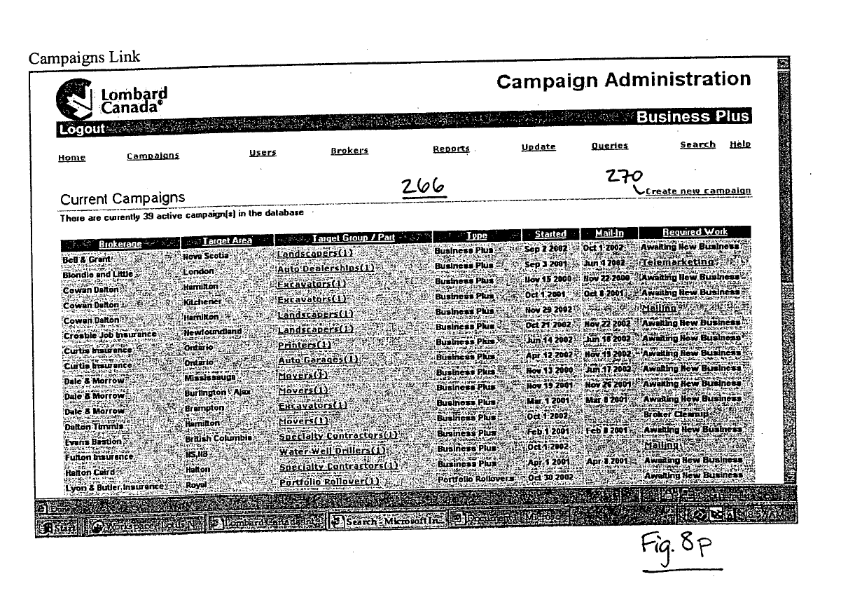

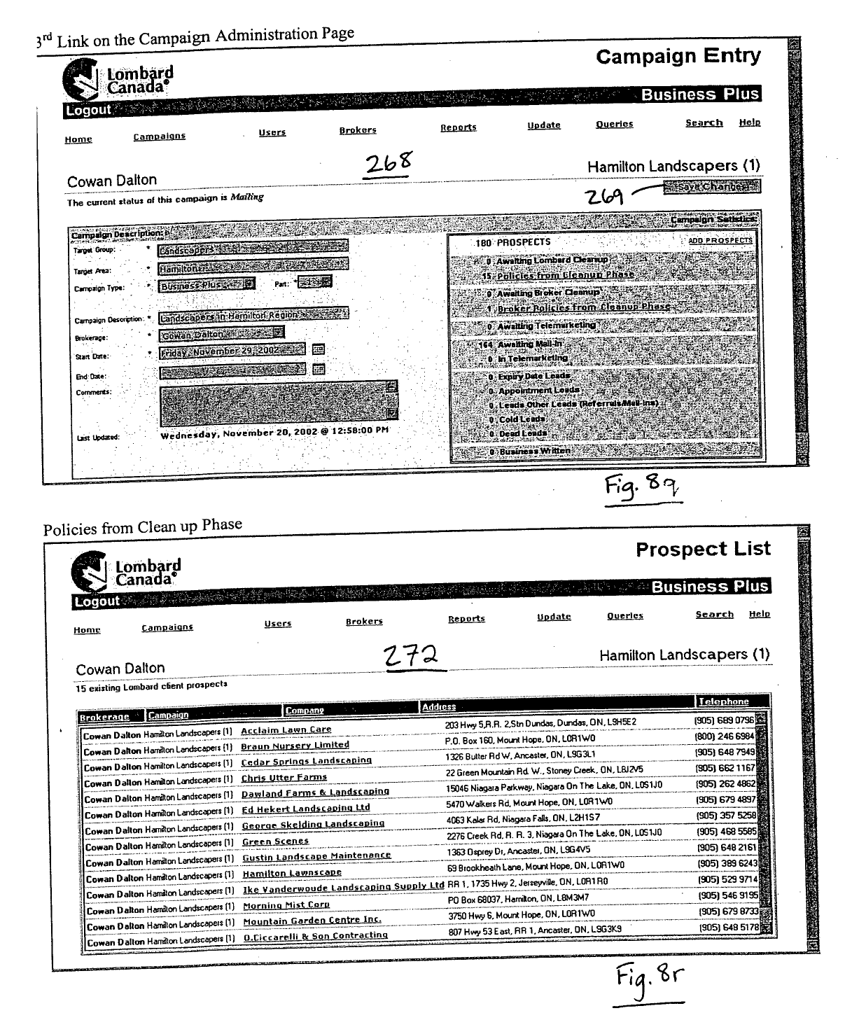

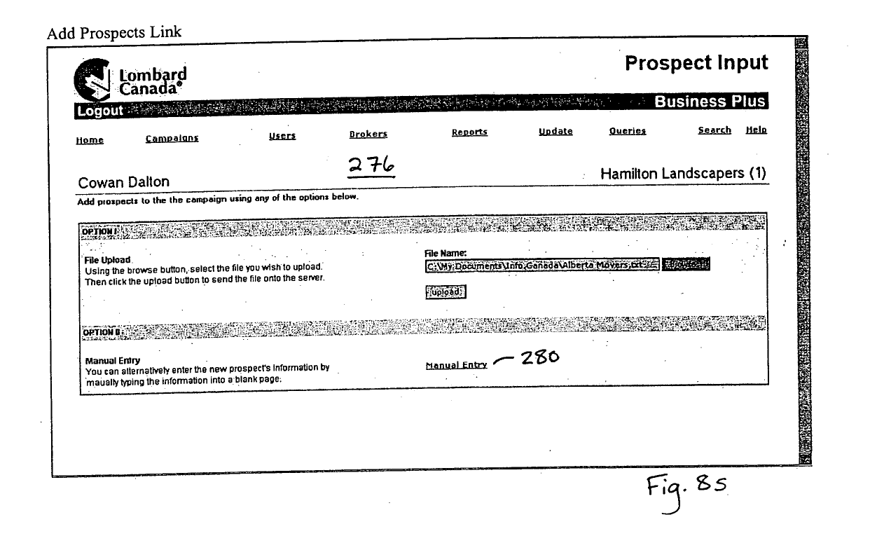

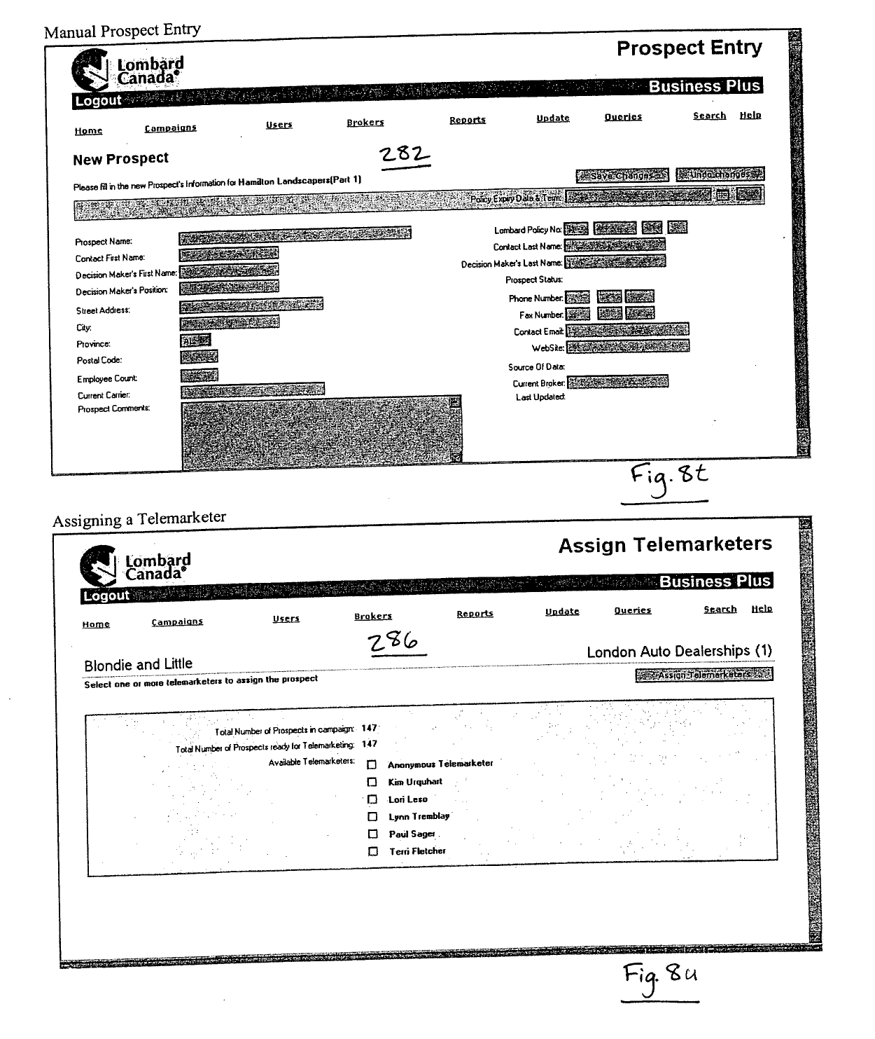

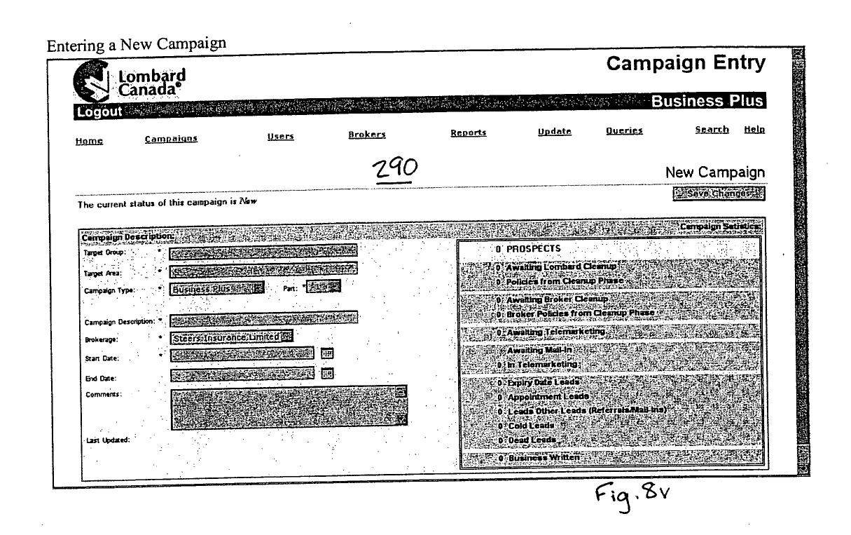

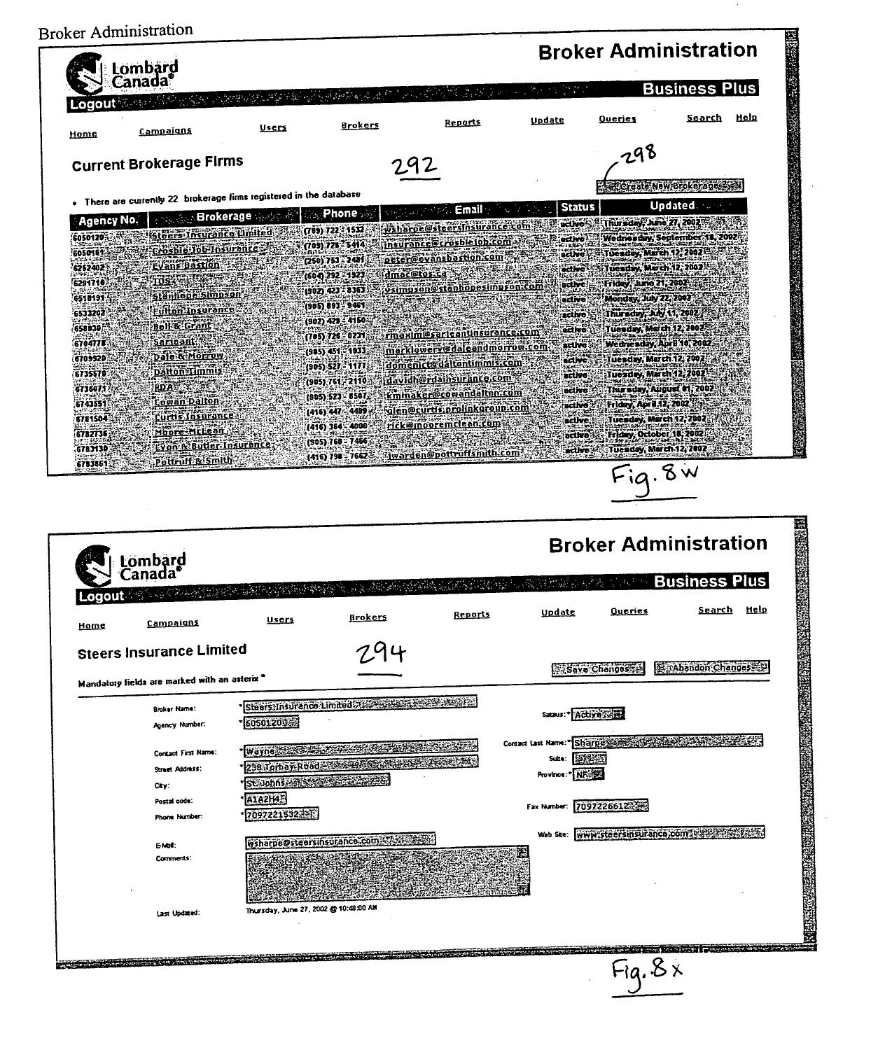

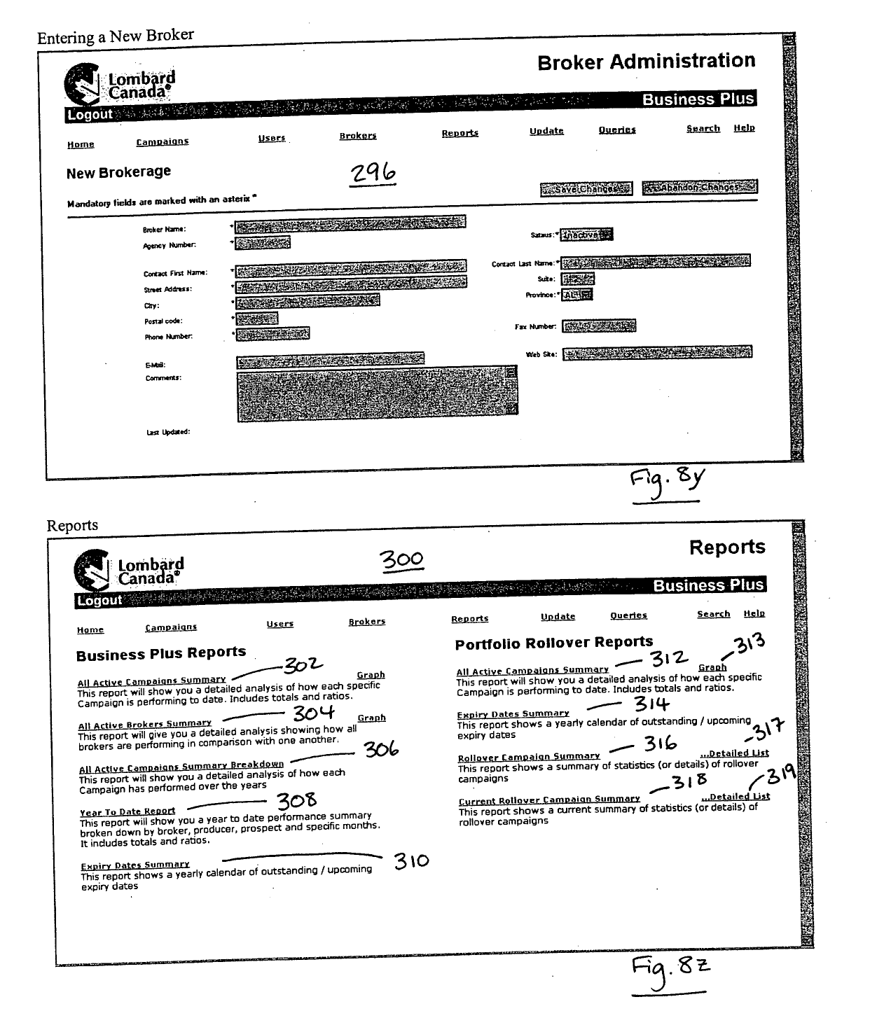

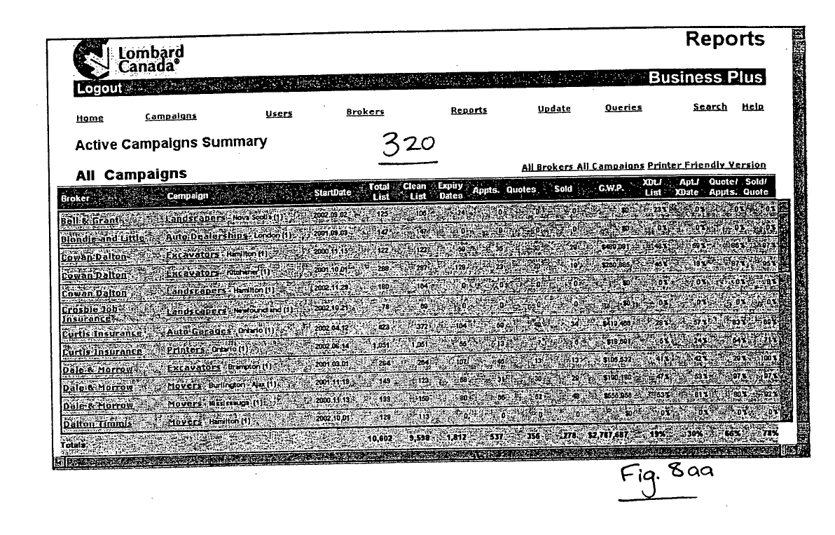

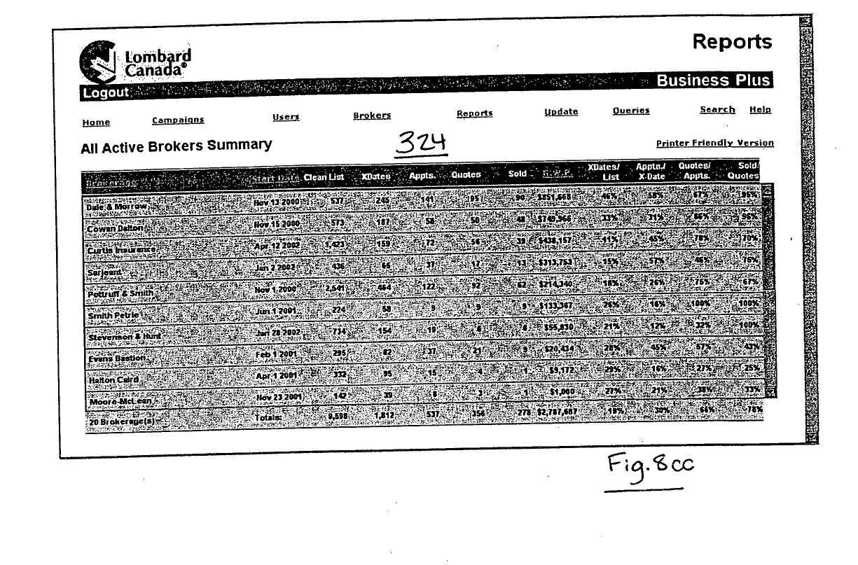

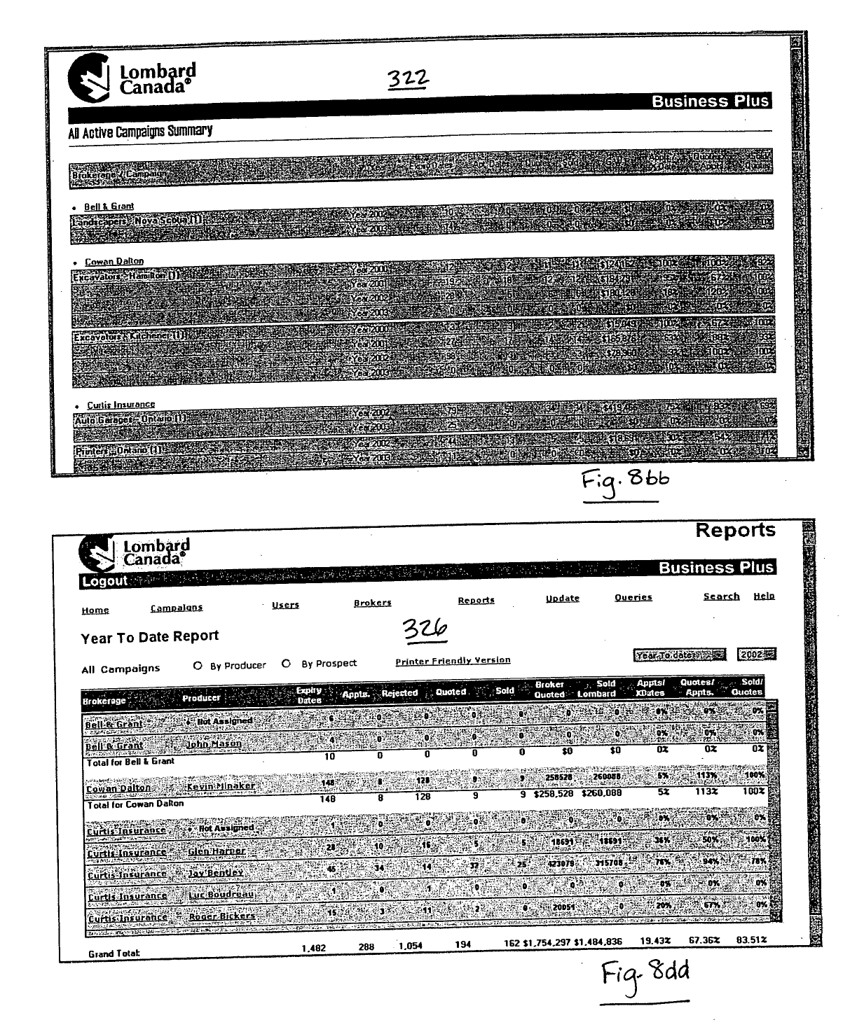

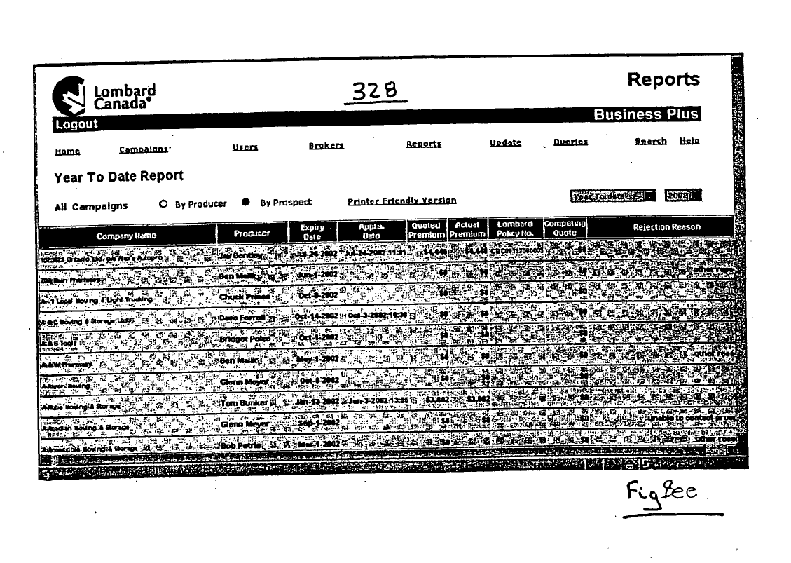

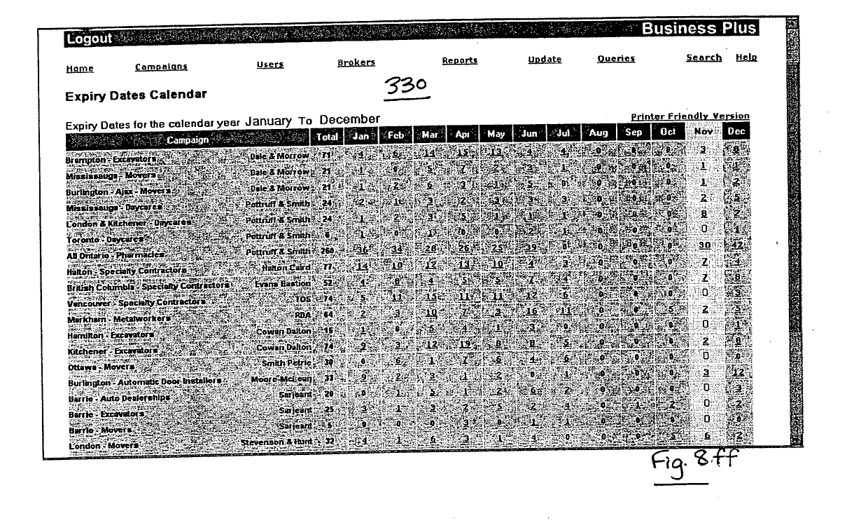

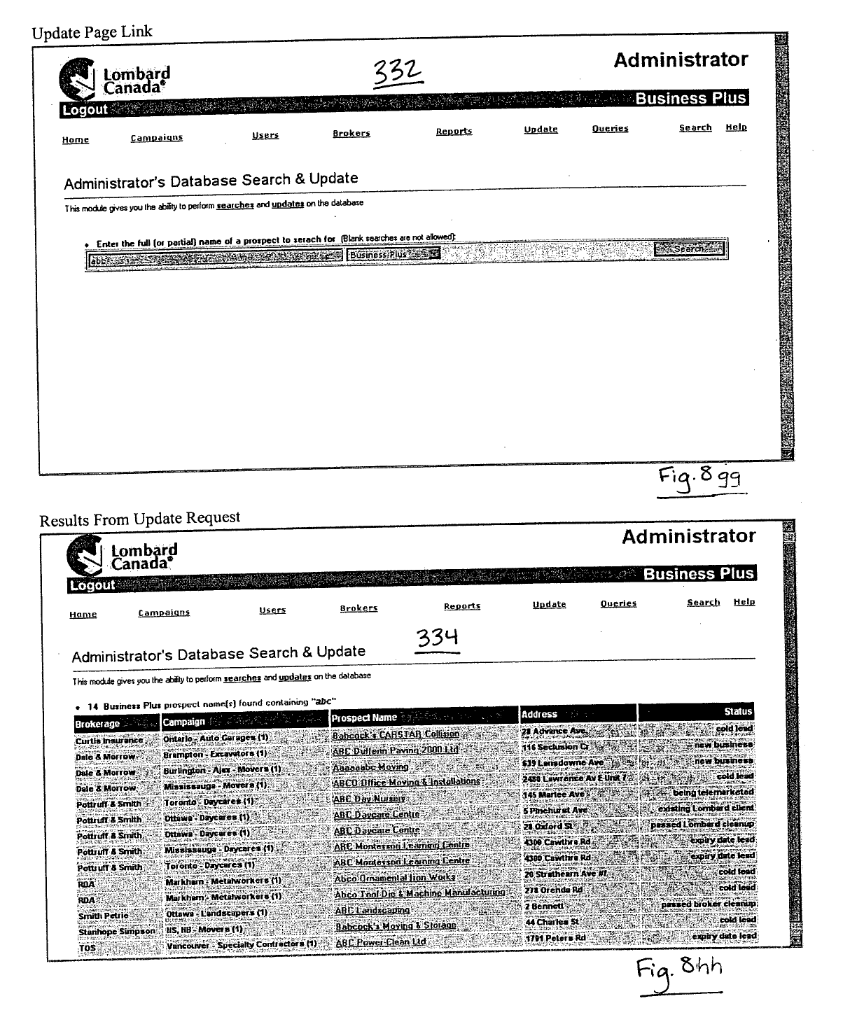

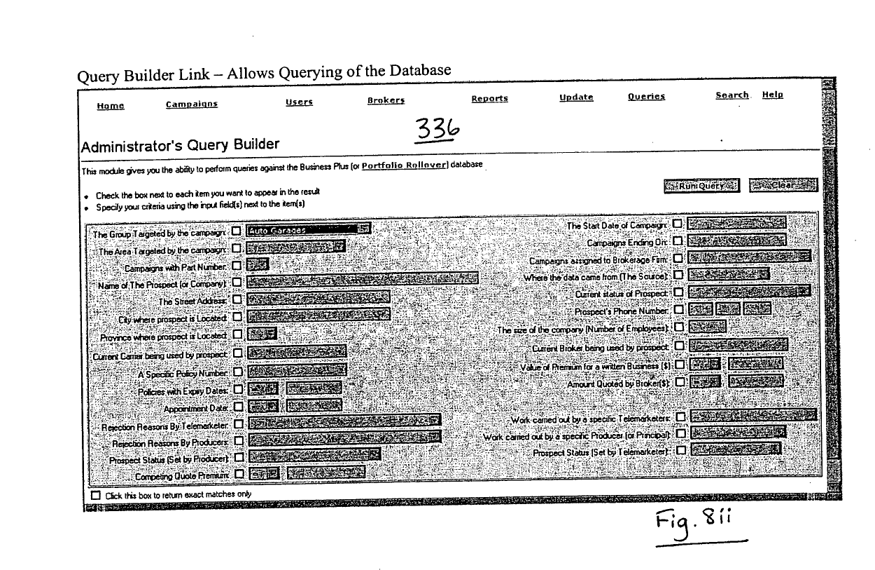

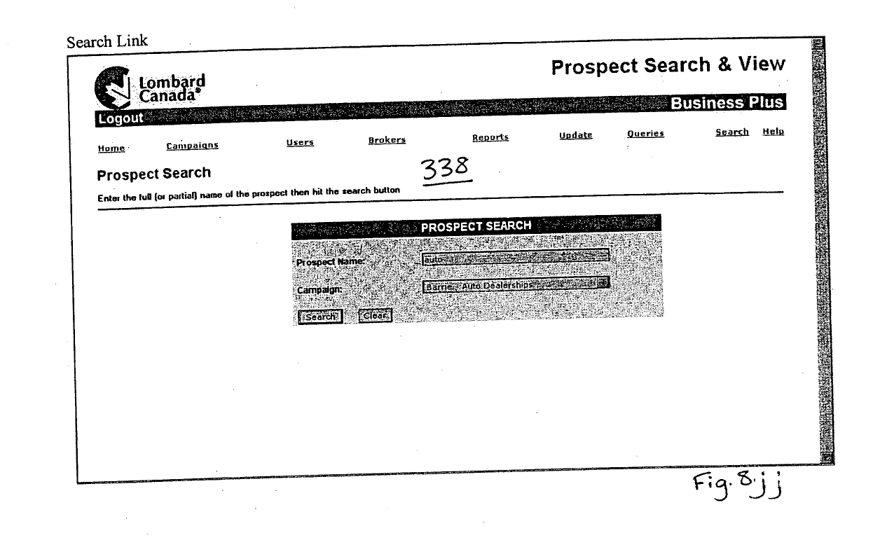

The graphical user interface of the marketing and sales application that exposes data in the database 80 to the insurer (administration level), the appointed broker and the appointed telemarketer and provides for the above-described functionality will now be described with particular reference to FIGS. 8a to 10o.

Insurer Web Pages Excluding Rollovers

FIG. 8a shows the administrator home web page 200 that is presented to an administrator user when the administrator user logs into the marketing and sales application. As can be seen, a series of hyperlinks are provided across the top of the web page 200, namely a home hyperlink 202, a campaigns hyperlink 204, a users hyperlink 206, a brokers hyperlink 208, a reports hyperlink 210, an updates hyperlink 212, a queries hyperlink 214 and a search hyperlink 216. The home hyperlink 202 is linked to the administrator home web page 200. The remaining hyperlinks 204 to 216 are linked to other web pages as will be described. The hyperlinks 202 to 216 appear across the top of each of the insurer web pages to facilitate navigation. In addition to the above described hyperlinks, the administrator home web page 200 lists the total number of prospects, the online users accessing the marketing and sales application and the total number of portfolio rollovers. The total number of prospects for all campaigns being pursued by the insurer is broken down into a variety of categories. These categories include the number of prospects awaiting insurer cleanup 217, the number of prospects identified as clients of the insurer during cleanup 218, the number of prospects awaiting broker cleanup 220, the number of prospects identified as clients of brokers during cleanup 222, the number of prospects awaiting telemarketing 224, the number of prospects currently in telemarketing 226, the number of prospects considered to be cold leads 228, the number of prospects considered to be dead leads 230, the number of ex-date leads 232, the number of appointment leads 234, the total number of other leads 236 and the number of policies written 238. The total number of portfolio rollovers is also broken down into a variety of categories. These categories include the number of accounts written 233, the number of ex-date leads 235, the number of accounts not written 237 and the number of unique rollover account names 239. The prospect and rollover categories 217 to 239 are presented as hyperlinks linked to quick statistics detail web pages.

FIG. 8b shows the quick statistics detail web page 241 that is linked to hyperlink 217. As can be seen, web page 241 lists the prospect 241a that is identified as awaiting cleanup by the insurer. This data requires scrubbing to prepare it for insurer and broker analysis. Each identified prospect is presented as a hyperlink linked to an associated prospect entry web page that exposes the prospect's profile.

FIG. 8c shows the prospect entry web page 243 that is opened in response to selection of the prospect 241a on web page 241. The web page 243 allows viewing and editing of the prospect's data. The prospect's data includes an expiry date for the prospect's current policy, if any. The expiry date can be selected by means of a date selection applet that is triggered by the selection of a date button 243a.

FIG. 8d shows a popup browser window 245 arising from the selection of the date button 243a of web page 243. The popup window 245 allows a user to select the expiry date for the prospect.

FIG. 8e shows the quick statistics detail web page 240 that is linked to hyperlink 218. As can be seen, web page 240 lists the prospects that are identified as being existing clients of the insurer during the first cleaning stage (step 34). Each identified prospect is presented as a hyperlink linked to an associated prospect web page similar to that shown in FIG. 8p that exposes the prospect's profile.

FIG. 8f shows the quick statistics detail web page 242 that is linked to hyperlink 220. Web page 242 presents a list of prospects awaiting cleanup by brokers. Each identified prospect is presented as a hyperlink linked to an associated prospect web page.

FIG. 8g shows the quick statistics detail web page 244 that is linked to hyperlink 222. As can be seen, web page 244 lists the prospects that are identified as being existing clients of the brokers during the second cleaning stage (step 38). Each identified prospect is presented as a hyperlink linked to an associated prospect web page.

FIG. 8h shows the quick statistics detail web page 246 that is linked to the hyperlink 224. Web page 246 presents a list of the prospects awaiting telemarketing. The prospects are listed together with their assigned brokers and associated campaigns. Each identified prospect is presented as a hyperlink linked to an associated prospect web page.

FIG. 8i shows the quick statistics detail web page 248 that is linked to the hyperlink 226. Web page 248 presents a list of the prospects currently in telemarketing. Similar to web page 246, the prospects are listed together with their assigned brokers and associated campaigns. Each identified prospect is presented as a hyperlink linked to an associated prospect web page.

FIG. 8j shows the quick statistics detail web page 250 that is linked to hyperlink 228. Web page 250 lists prospects considered to be cold leads. Similar to web pages 246 and 248, the prospects are listed together with their assigned brokers and associated campaigns. Each identified prospect is presented as a hyperlink linked to an associated prospect web page.

FIG. 8k shows the quick statistics detail web page 252 that is linked to hyperlink 230. Web page 252 lists prospects considered to be dead leads together with contact information. A select box is associated with each prospect allowing the prospect to be selected and removed from the list by clicking on the delete bar 254. Each identified prospect is presented as a hyperlink linked to an associated prospect web page.

FIG. 8l shows the quick statistics detail web page 256 that is linked to hyperlink 232. Web page 256 lists the prospects from whom ex-date information has been acquired. The prospects are listed together with their assigned brokers, campaigns and ex-dates. Each identified prospect is presented as a hyperlink linked to an associated prospect web page.

FIG. 8m shows the quick statistics detail web page 258 that is linked to hyperlink 234. Web page 258 lists the prospects with whom appointments have been set up. The prospects are listed together with their assigned brokers, campaigns and appointment times and dates. Each identified prospect is presented as a hyperlink linked to an associated prospect web page.

FIG. 8n shows the quick statistics detail web page 260 that is linked to hyperlink 236. Web page 260 lists prospects derived from other leads such as referrals and mail-ins. The prospects are listed together with their assigned brokers and associated campaigns. Each prospect is presented as a hyperlink linked to an associated prospect web page.

FIG. 8o shows the quick statistics detail web page 262 that is linked to hyperlink 238. Web page 262 lists the prospects for whom insurance policies have been written. Each prospect is listed together with the assigned broker and policy information. The policy information includes the written policy amount, the actual policy amount, the assigned policy symbol, the assigned policy number and the assigned policy model. The policy information can be updated by the user and saved by selecting the save bar 264. Each broker is presented as a hyperlink linked to an associated broker web page that exposes the broker's profile. Each prospect is presented as a hyperlink linked to an associated prospect web page.

FIG. 8p shows the current campaign home web page 266 that is accessed by selecting the campaigns hyperlink 204. The web page 266 identifies each campaign being pursued by the insurer, by broker, target group, target area, start date, mail-in date and required work. The required work identifies which marketing stage the campaign is at. The campaigns in the list are presented as hyperlinks linked to associated campaign web pages similar to that shown in FIG. 8n that expose the campaign profiles. Depending on the marketing stage, the listed marketing stage may be presented as text or as a hyperlink linked to an associated web page. Selection of the hyperlink 270 allows the user to create and save a new campaign.

FIG. 8q shows the campaign web page 268 linked to the eighth campaign listed on the current campaign home web page 266. As can be seen, the campaign web page 268 identifies the campaign target group, the specified geographical region and appointed broker. Web page 268 also identifies the total number of prospects associated with the campaign. The prospects are broken down into the same categories as on the administrator home web page 200. Some of the prospect categories are presented as hyperlinks linked to web pages similar to those shown in FIGS. 8e, 8f, 8j, 8l and 8o. The campaign data can be updated and saved by the user by selecting the save changes bar 269. A blank campaign web page 290 (see FIG. 8v) can be opened by selecting the create new campaign bar 270 on web page 266 allowing the user to create and save new campaigns.

FIG. 8r shows a prospects search web page 272 that is opened in response to selection of the view prospects bar 274 on web page 268. The prospects search web page 272 lists all of the prospects in the campaign. Each prospect is presented as a hyperlink linked to an associated prospect web page.

FIG. 8s shows a new prospect input/upload web page 276 that is opened in response to selection of the add prospect bar 278 on web page 268. The web page 276 allows prospects to be browsed and uploaded or allows a blank prospect web page to be opened by selecting the manual entry hyperlink 280. FIG. 8t shows a blank new prospect web page 282 that allows the user to create and save new prospects for the campaign.

FIG. 8u shows an assign telemarketer web page 286 that allows the user to assign a specific telemarketer to a campaign by selecting a check box associated with the desired telemarketer (step 46).

FIG. 8v shows a campaign entry web page 290 that allows a user to enter in the specific details for a new campaign.

FIG. 8w shows a brokers web page 292 that is opened in response to selection of the brokers hyperlink 208. The web page 292 identifies each broker by agency number, broker name, telephone number, email address and latest update. The agency numbers are presented as hyperlinks linked to associated brokers web pages. FIG. 8x shows the broker web page 294 associated with the ninth broker listed on web page 292. A new broker web page 296 is shown in FIG. 8y and is opened in response to selection of a create new broker bar 298 on web page 292 allowing the user to create and save a new broker.

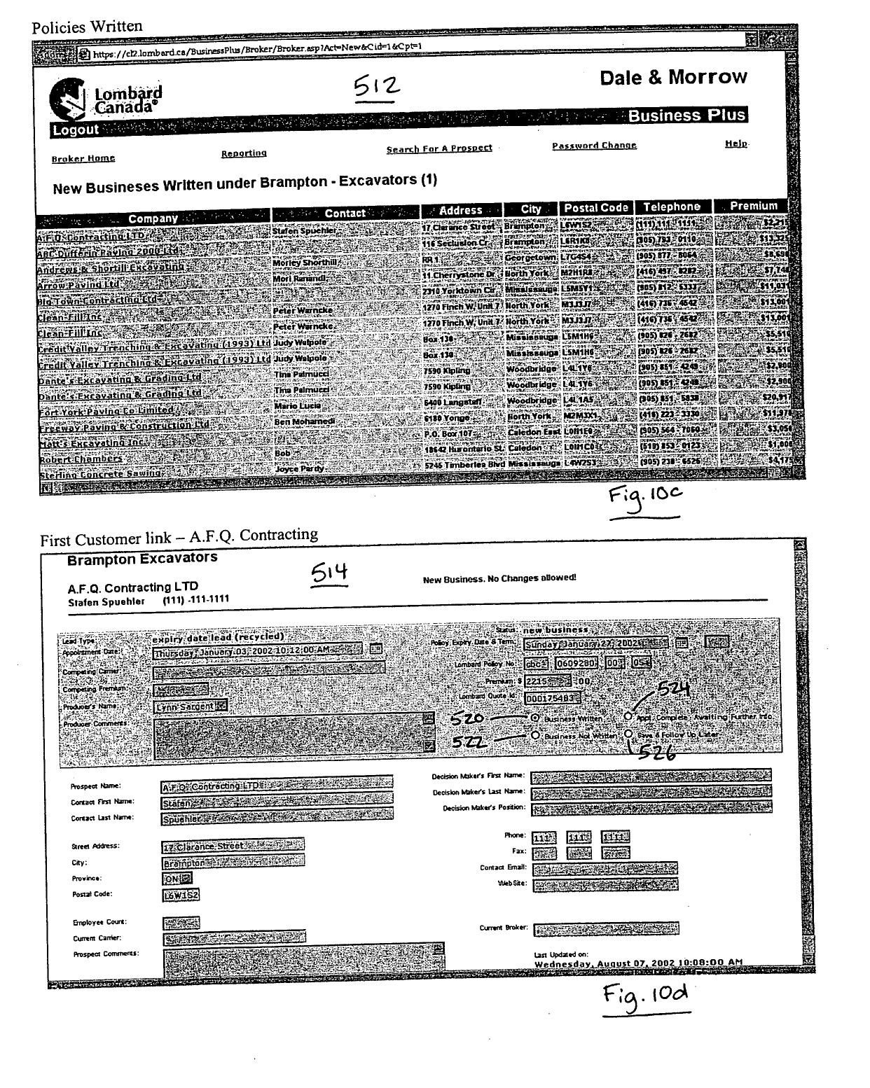

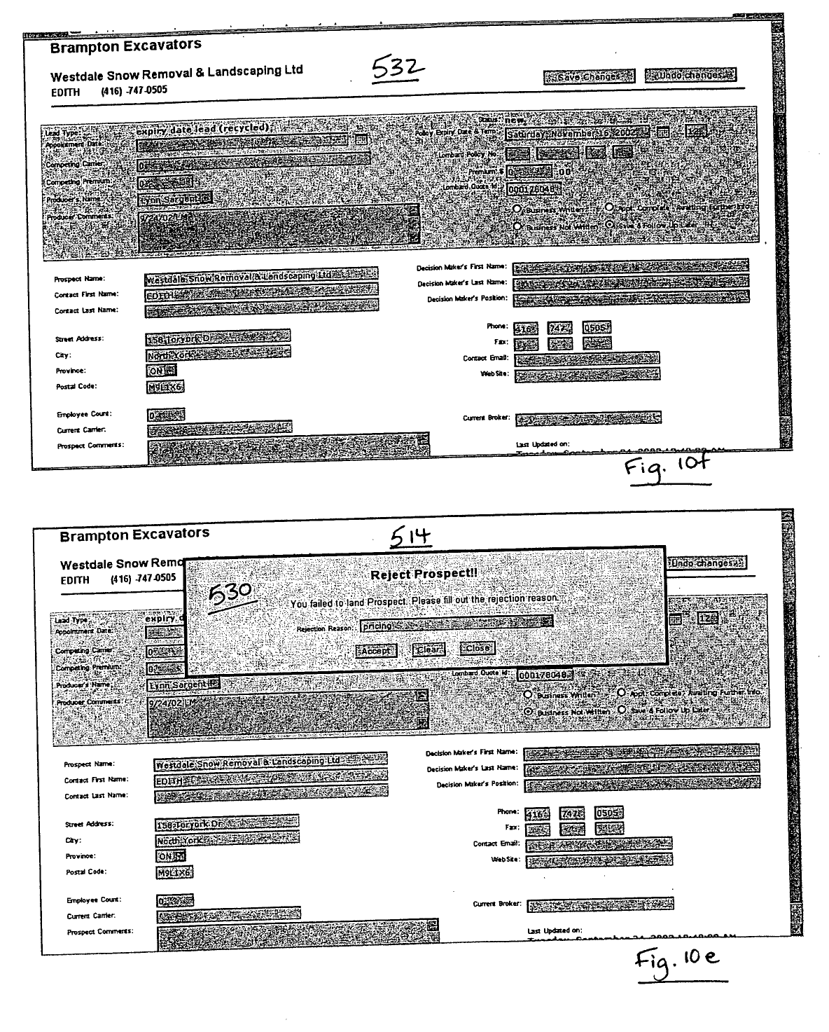

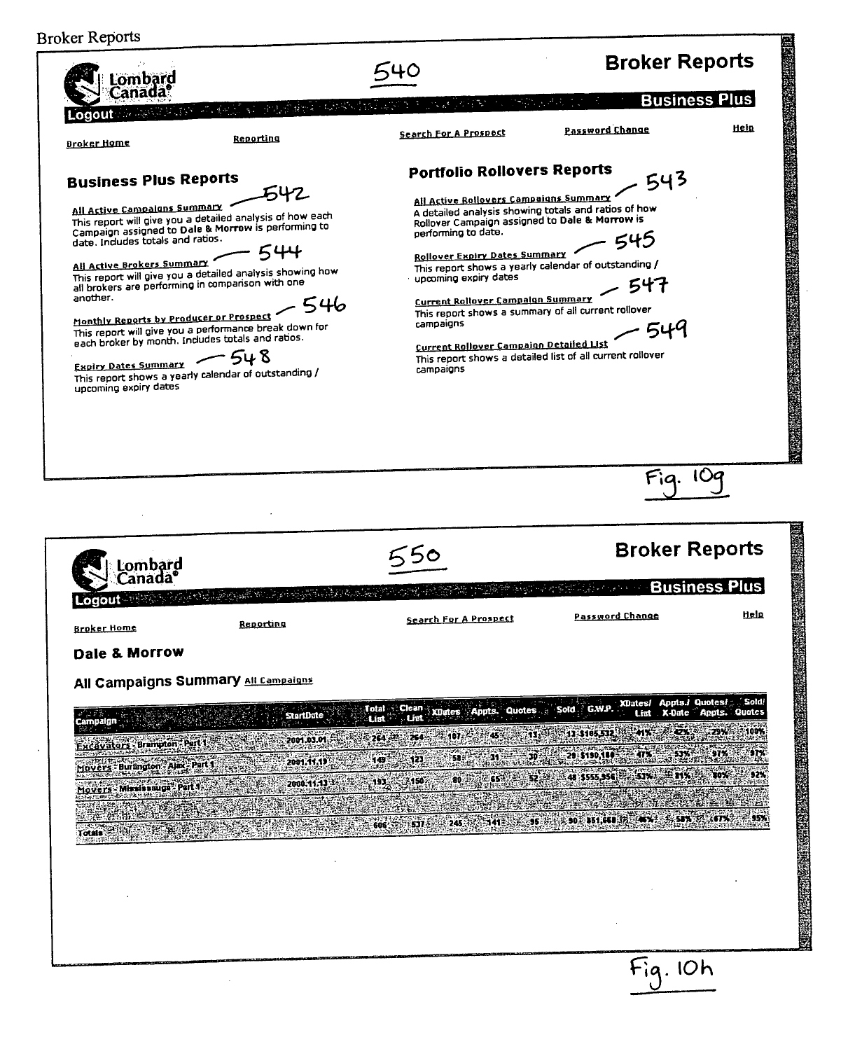

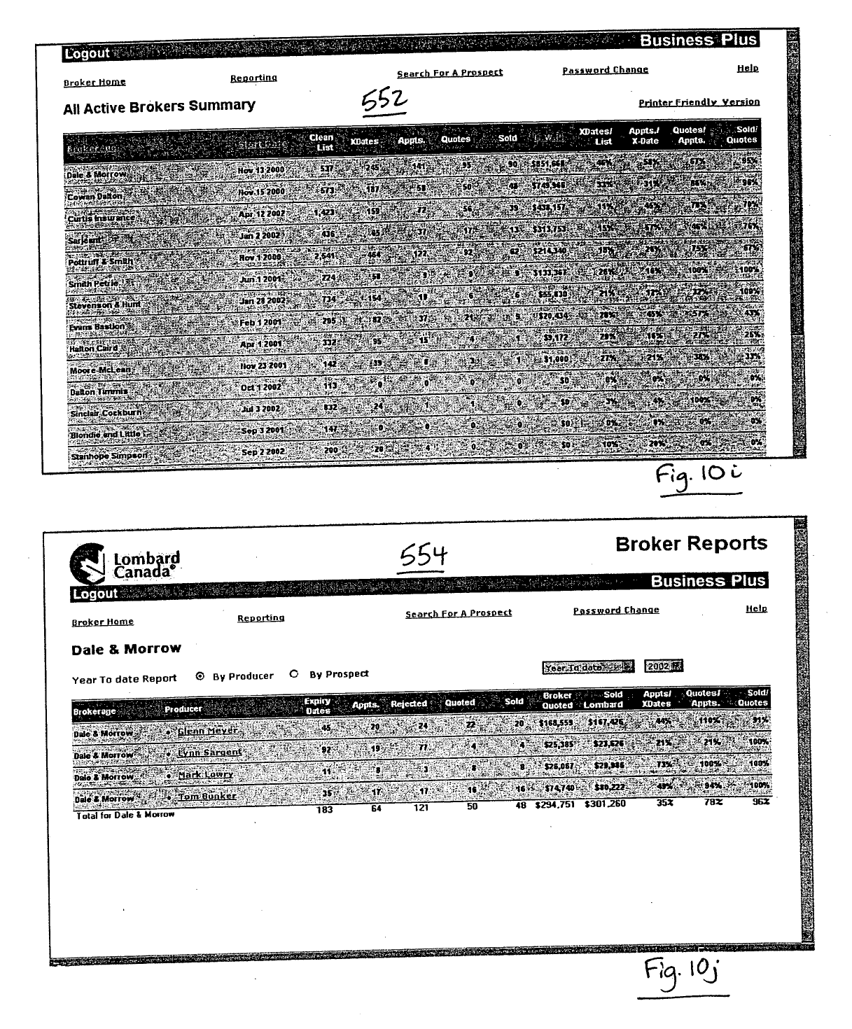

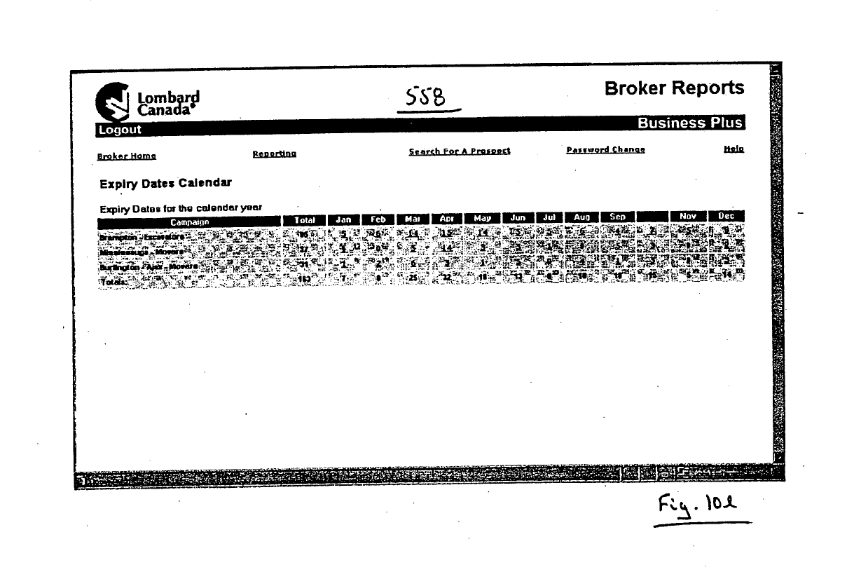

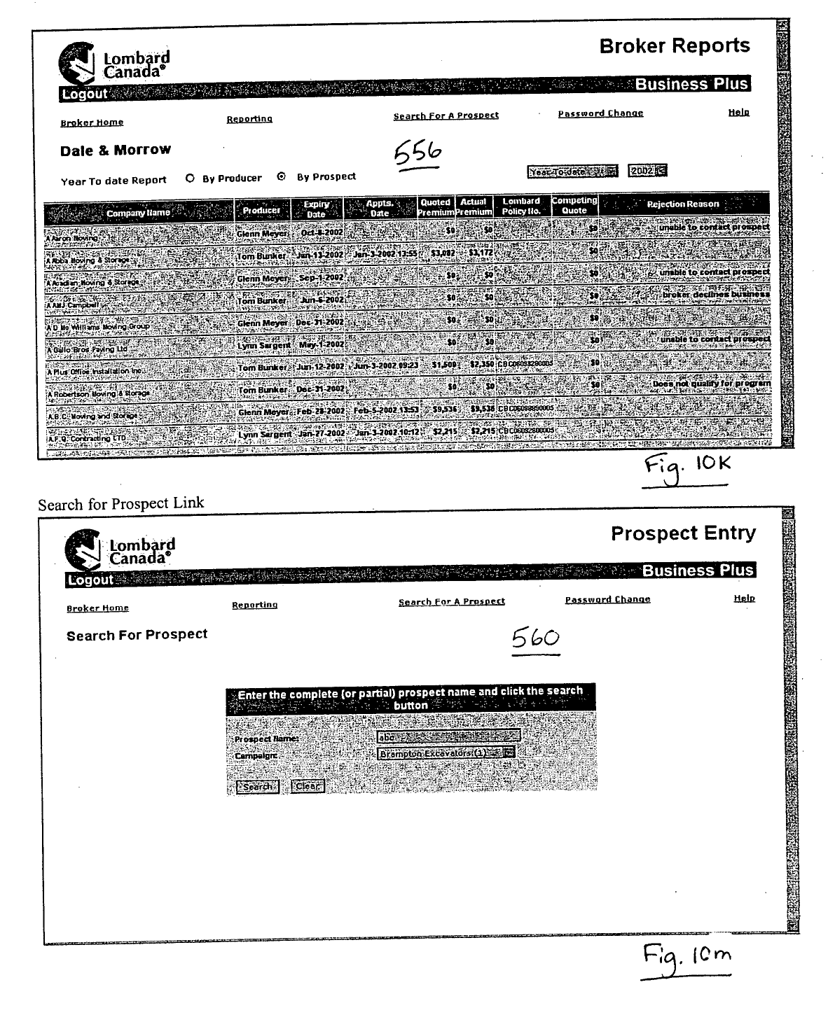

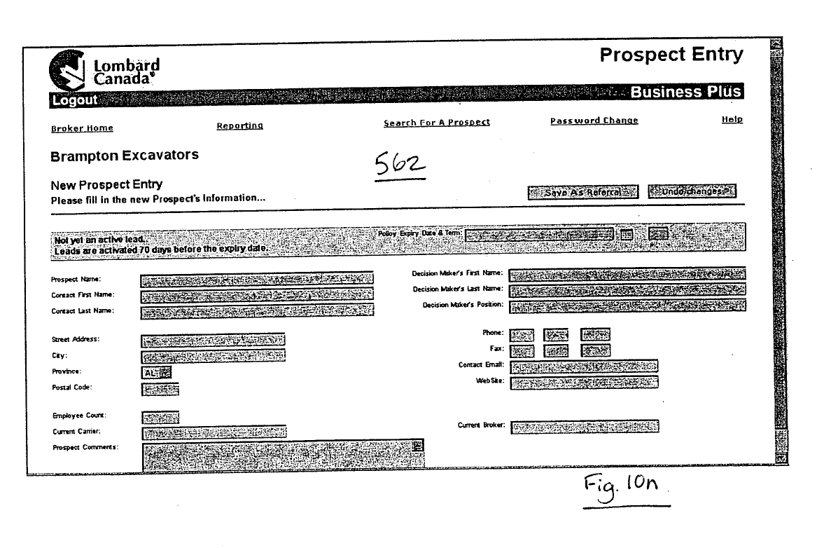

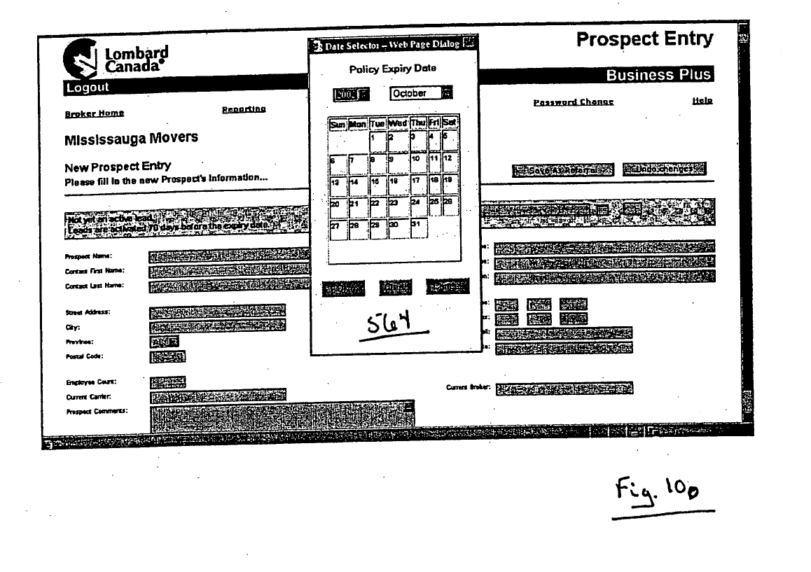

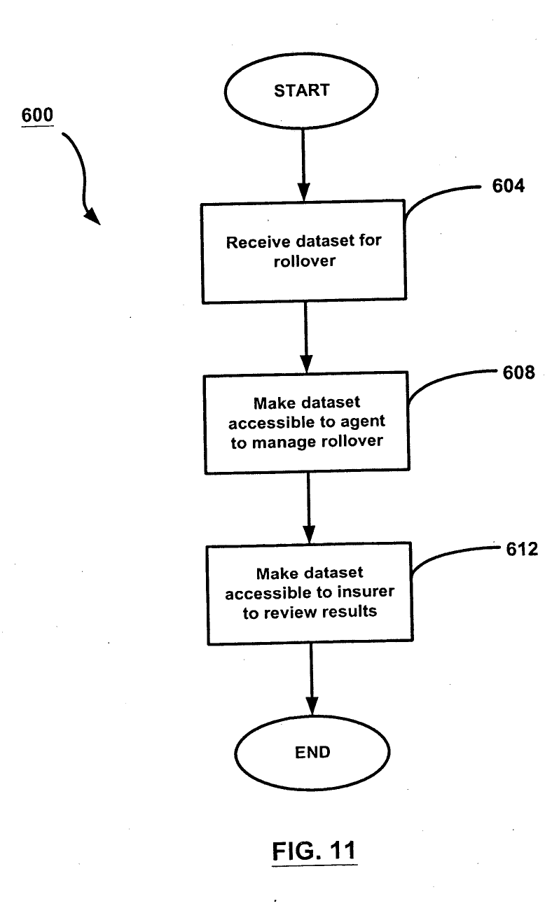

FIG. 8z shows a reports home web page 300 that is opened in response to selection of the reports hyperlink 210. The web page 300 includes five hyperlinks linked to reports web pages, namely an all active campaigns summary hyperlink 302, an all active campaigns summary breakdown hyperlink 304, an all active brokers summary hyperlink 306, a year to date report hyperlink 308 and an expiry dates summary hyperlink 310. Also shown on web page 300 are seven hyperlinks 312 to 319 linked to portfolio rollover content that will be discussed further with reference to FIGS. 11 to 13l.

Selection of hyperlink 302 opens an all active campaigns summary web page 320 as shown in FIG. 8aa. The web page 320 lists each campaign pursued by the insurer, the broker appointed to handle each campaign and statistical information relating to each campaign. The brokers are presented as hyperlinks linked to associated broker web pages. The campaigns are also presented as hyperlinks linked to associated campaign web pages.

Selection of hyperlink 304 opens an all active campaigns summary web page 322 as shown in FIG. 8bb. The web page 322 lists all active campaigns pursued by the insurer broken down by appointed broker together with statistical information relating to the campaigns. The brokers are presented as hyperlinks linked to associated broker web pages.

Selection of hyperlink 306 opens an all active brokers summary web page 324 as shown in FIG. 8 cc. The web page 324 lists each active broker appointed by the insurer and presents statistical information relating to each active broker's performance over all campaigns handled by that broker.

Selection of hyperlink 308 opens a year to date report by producer web page 326 as shown in FIG. 8dd. The web page 326 lists each producer handling campaigns and presents statistical information relating to each producer's performance over all campaigns handled by that producer. The brokers are presented as hyperlinks linked to associated broker web pages. The producers are also presented as hyperlinks linked to associated producer web pages (not shown). Selecting a radio button on the web page 326 allows a similar year to date web page 328 to be opened that is based on prospect as shown in FIG. 8ee.

Selection of hyperlink 310 opens an expiry dates calendar web page 330 as shown in FIG. 8ff. The web page 330 lists each campaign pursued by the insurer, the broker appointed to each campaign and the number of expiry dates acquired from actual prospects for the campaign on a month by month basis.

FIG. 8gg shows a search web page 332 that is opened in response to selection of the update hyperlink 212. The search web page 332 allows the user to perform a search of the database 80 based on prospect name. FIG. 8hh shows a search result web page 334 presenting the results of such a search.

The marketing and sales application also includes query and search features that can be accessed by selecting the query and search hyperlinks 214 and 216 respectively. Selecting the query hyperlink 214 opens a query web page 336 that allows the database 80 to be searched based on a variety of qualifiers as shown in FIG. 8ii. Selecting the search hyperlink 216 opens a prospect search web page 338 that allows the database 80 to be searched based on prospect as shown in FIG. 8jj.

As will be appreciated, the marketing and sales application GUI allows the insurer to review, update and maintain all relevant data associated with all of the campaigns pursued by the insurer. Since the marketing and sales application generates campaign statistical information, the marketing and sales application allows telemarketer and broker performance to be effectively monitored by the insurer.

Telemarketer Web Pages

FIG. 9a shows the telemarketer home web page 400 that is presented to the telemarketer user when the telemarketer user logs into the marketing and sales application. As can be seen, a pair of hyperlinks are provided across the top of the web page 400, namely a telemarketer home hyperlink 402 and an appointments made hyperlink 404. The home hyperlink 402 is linked to the telemarketer home web page 400. The hyperlink 404 is linked to another web page as will be described. The hyperlinks 400 and 402 appear across the top of each of the telemarketer web pages to facilitate navigation. In addition to above described hyperlinks, the telemarketer home web page 400 presents a list of the campaigns the insurer has appointed to the telemarketer (step 46). The appointed broker for each campaign as well as the campaign prospect list and status are also listed. The campaign status identifies the status of each campaign as either complete or in progress. The campaign prospect list is presented as a hyperlink either to a statistics web page if the campaign has been completed or a view prospects list web page if the campaign has not been completed.

The campaign web page 406 associated with the first campaign listed on web page 400 is shown in FIG. 9b. The completed campaign web page 406 identifies the total number of prospects for the associated campaign that were called broken down into a variety of categories. These categories include the number of prospects awaiting a first call, the number of prospects awaiting a follow-up call, the number of appointments made, the number of ex-dates received, the number of cold leads and the number of dead leads.

The campaign web page 408 associated with the thirteenth campaign listed on web page 400 is shown in FIG. 9c. Similar to the campaign web page 406, the campaign web page 408 identifies the total number of prospects for the associated campaign to be called broken down into the same variety of categories. In addition, the campaign web page 408 lists each of the prospects as either awaiting a first call or awaiting a follow-up call. The prospects are presented as hyperlinks linked to associated prospect web pages.

FIG. 9d shows the prospect web page 410 for the second prospect listed on the campaign web page 408. As can be seen, the prospect web page in addition to information data fields includes three prospect status radio buttons 412 to 416 that are used to set the status of the prospect. Specifically, the prospect status radio buttons include a generate lead radio button 412, a reject prospect radio button 414 and a save & follow up later radio button 416. When the save & follow up later radio button is selected 416, the prospect remains in the awaiting a follow-up call category.

The generate lead radio button 412 is selected when the telemarketer sets up an appointment with the prospect and/or receives an ex-date from the prospect (i.e. the prospect is identified as an actual prospect). When the generate lead radio button 412 is selected, the telemarketer is prompted to enter the appointment time and date and/or ex-date into a dialog box 418 as shown in FIG. 9e. The reject prospect radio button 414 is selected when the telemarketer fails to set up an appointment with the prospect and/or fails to receive an ex-date from the prospect. When the reject prospect radio button 414 is selected, the telemarketer is prompted to enter a rejection reason via a dialog box 420 as shown in FIG. 9f.

FIG. 9g shows an appointment list web page 422 that is opened in response to selection of the appointments made hyperlink 404. As can be seen, the appointment list web page 422 identifies all of the appointments made by the telemarketer by date, prospect name, province, telephone number, campaign and assigned broker.

As will be appreciated, the marketing and sales application GUI allows the telemarketer to manage efficiently each campaign the telemarketer handles. The GUI also permits the telemarketer to input relevant appointment and/or ex-date information into the marketing and sales application allowing actual prospects to be determined by the marketing and sales application in real time. This of course permits faster lead turnaround time.

Broker Web Pages

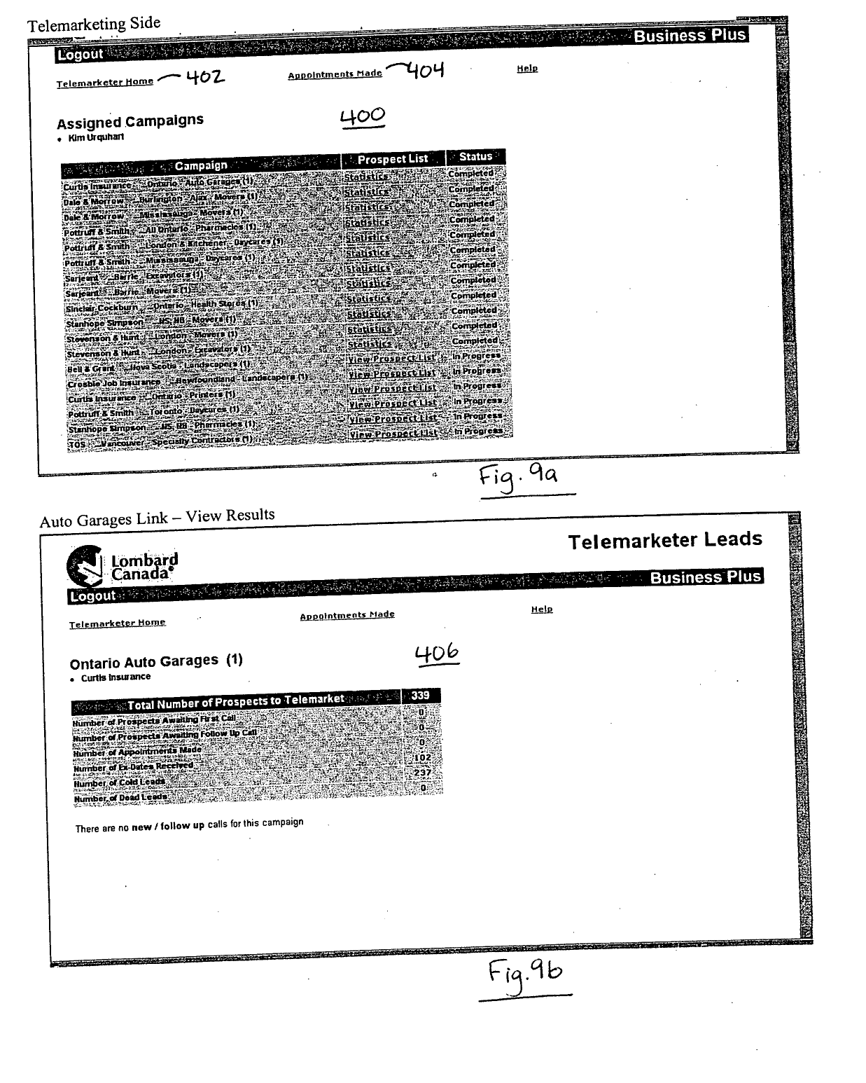

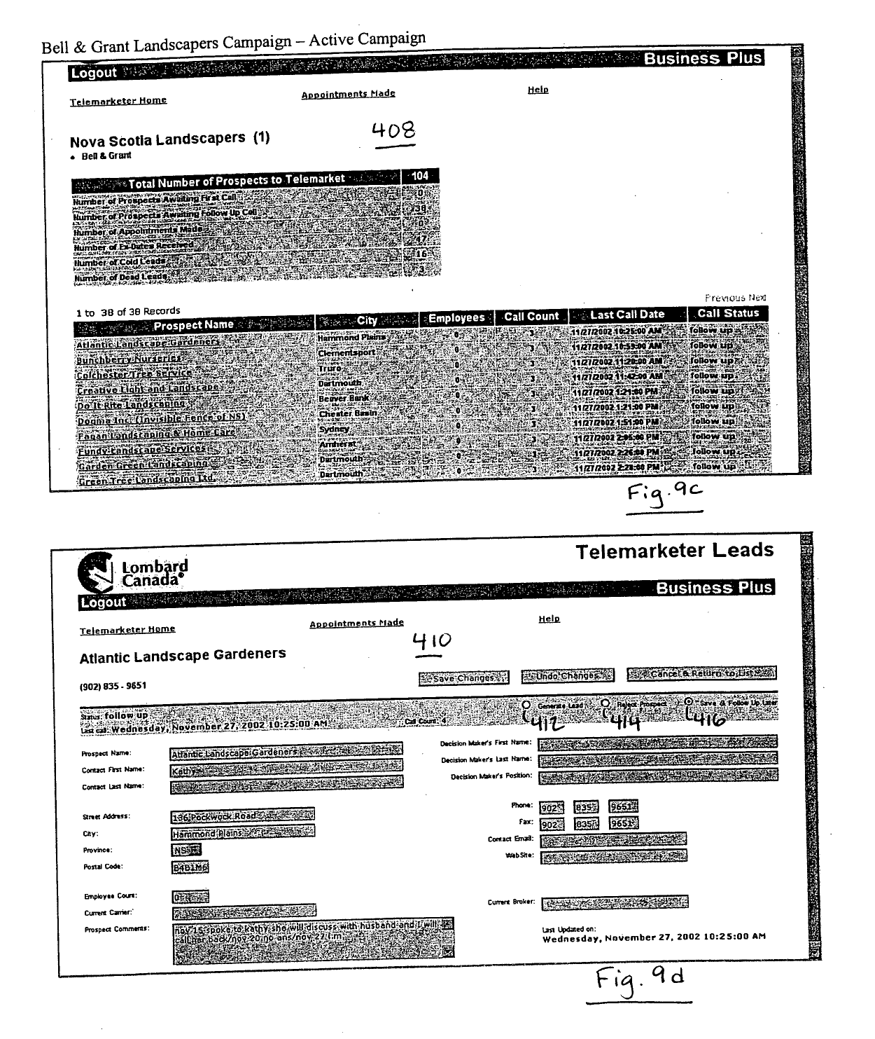

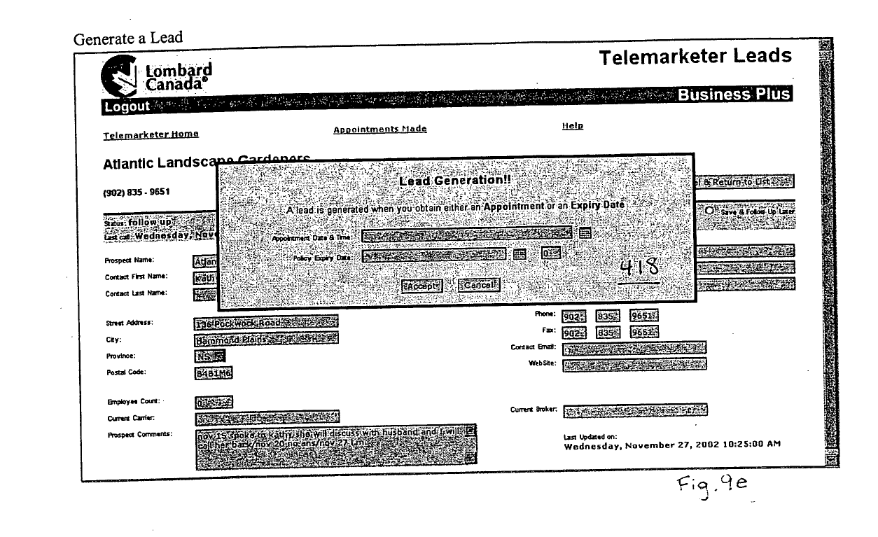

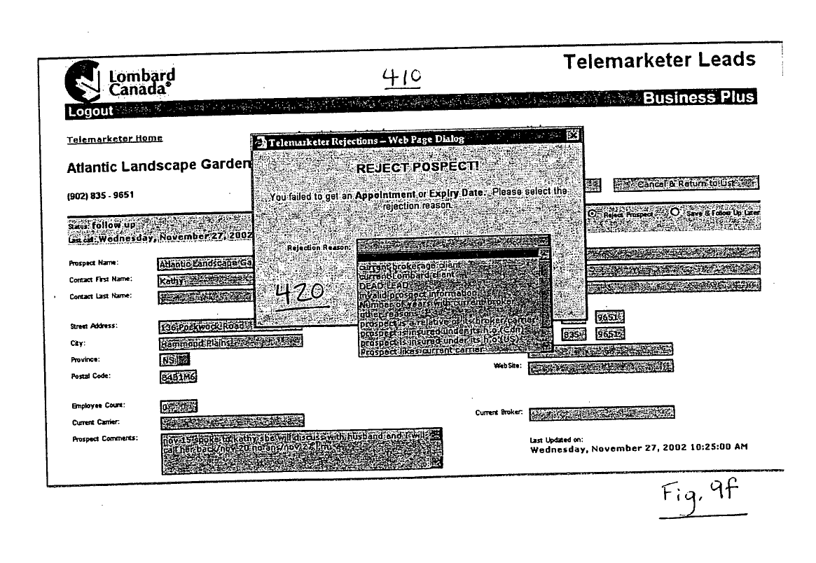

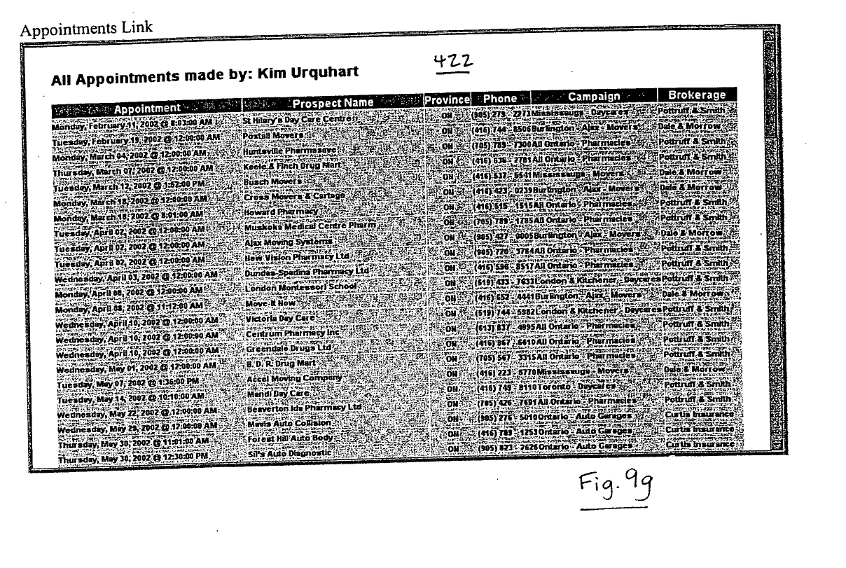

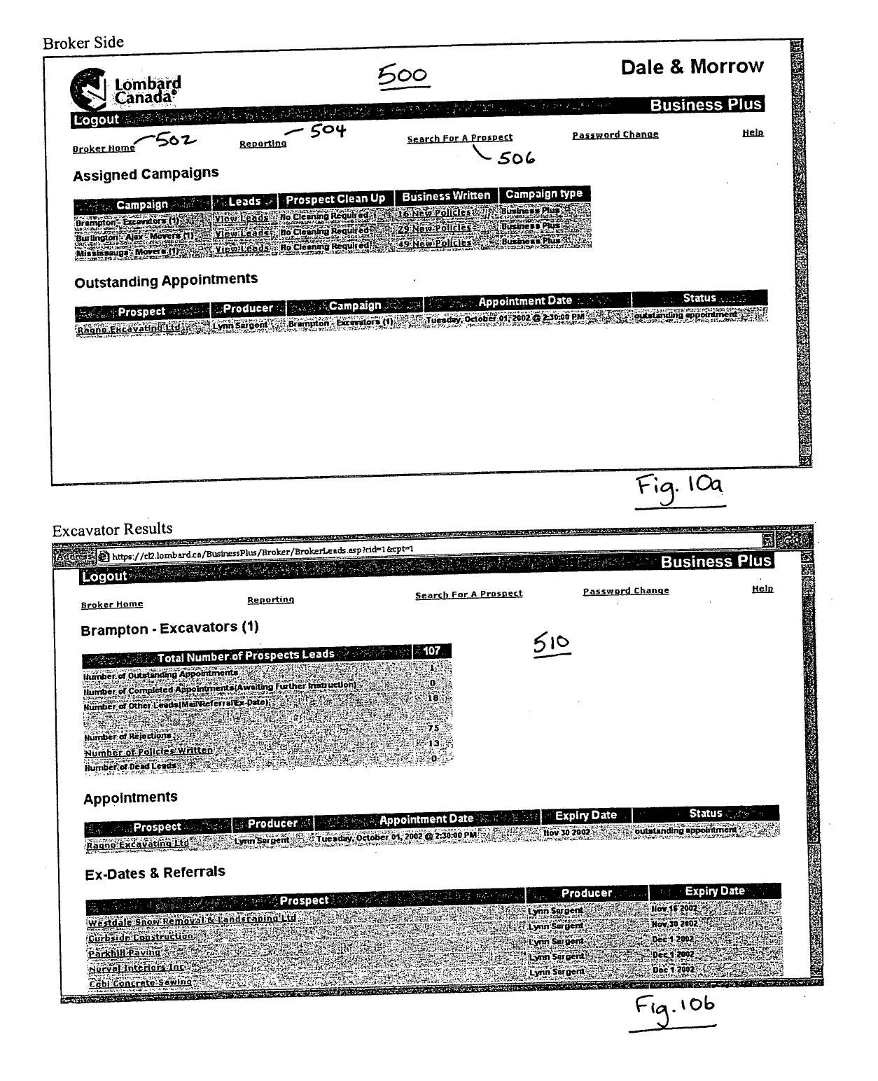

FIG. 10a shows the brokers home web page 500 that is presented to the broker user when the broker user logs into the marketing and sales application. As can be seen, a series of hyperlinks are provided across the top of the web page 500, namely a broker home hyperlink 502, a reporting hyperlink 504, and a search for prospect hyperlink 506. The broker home hyperlink 502 is linked to the brokers home web page 500. The other hyperlinks 504 and 506 are linked to other web pages as will be described. The hyperlinks 502 to 506 appear across the top of each of the broker web pages to facilitate navigation. In addition to the above described hyperlinks, the brokers home web page 400 lists the campaigns that have been assigned to the broker as well as outstanding appointments. Each campaign in the list is identified by name, leads, prospect clean up and policies written. The leads are presented as hyperlinks linked to associated lead web pages. The policies written are also presented as hyperlinks linked to associated policy web pages. Each outstanding appointment in the list is identified by prospect, producer, campaign, appointment date and status. The prospects are presented as hyperlinks linked to associated prospect web pages.

The lead web page 510 associated with the first campaign in the list presented on web page 500 is shown in FIG. 10b. As can be seen, the lead web page 510 identifies the total number of prospect leads for the associated campaign broken down into a variety of categories. These categories include the number of outstanding appointments, the number of completed appointments that are awaiting further instruction, the number of other leads, the number of rejections, the number of policies written and the number of dead leads. The number of policies written is presented as a hyperlink linked to an associated policies web page. The lead web page 510 also lists the outstanding appointments shown on the broker home web page 500 as well as a list of ex-dates and referrals. The ex-dates and referrals in the list are identified by prospect, producer and ex-date. The prospects are presented as hyperlinks linked to associated prospect web pages.

The policies written web page 512 associated with the first campaign in the list presented on web page 500 is shown in FIG. 10c. The policies written web page 512 lists prospects for whom new policies have been written as well as premium information concerning the written policies. The prospects are presented as hyperlinks linked to associated prospect web pages.

Turning now to FIG. 10d, the prospect web page 514 associated with the third prospect in the policies written list presented on web page 512 is shown. As can be seen, the prospect web page 514 includes identification and policy data fields as well as four selectable radio buttons 520 to 526. The radio buttons include a business written radio button 520, a business not written radio button 522, an appointment complete awaiting further information radio button 524 and a save & follow up later radio button 526. When the save & follow up later radio button 526 is selected, the prospect remains in the outstanding appointments category. When the appointment complete awaiting further information radio button 524 is selected, the prospect is placed in the completed appointments that are awaiting further instruction category.

The business not written radio button 522 is used when the broker fails to land the prospect. When the business not written radio button is selected 522, the broker is prompted to enter a rejection reason via a dialog box 530 as shown in FIG. 10e. The prospect is then placed in the rejections category.

FIG. 10f shows the prospect web page 532 associated with a prospect in the appointment list presented on web page 500. As can be seen, the prospect web page 532 is similar to web page 514 and identifies the date of the outstanding appointment. Since a policy has not been written for this prospect, the policy data fields are incomplete.

FIG. 10g shows the reporting home page 540 that is accessed by selecting the reporting hyperlink 504. As can be seen the reporting home page 540 includes an all active campaigns summary web page hyperlink 542, an all active brokers summary web page hyperlink 544, a monthly reports by producer or prospect hyperlink 546 and an expiry dates summary hyperlink 548.

Selecting hyperlink 542 opens the all active campaigns summary web page 550 as shown in FIG. 10h. The web page 550 lists all of the campaigns handled by the broker together with statistical information for each campaign. The statistical information includes the total number of prospects in the campaign, the number of prospects in the campaign after cleaning, the number of ex-dates acquired, the number of appointments made, the number of quotes provided to prospects, the number of policies written, the value of the policies, the number of ex-dates acquired vs. the number of prospects after cleaning, the number of appointments vs. the number of acquired ex-dates, the number of quotes vs. the number of appointments and the number of written policies vs. the number of quotes. The campaigns are presented as hyperlinks linked to associated campaign web pages.

Selecting hyperlink 544 opens the all active brokers summary web page 552 as shown in FIG. 10i. The web page 552 lists each of the brokers used by the insurer and presents statistical information for the brokers across all of the campaigns handled by the brokers.

Selecting hyperlink 546 opens the monthly reports by producer web page 554 as shown in FIG. 10j. The web page 554 lists each producer associated with the broker. Statistical information associated with each producer is also listed. The statistical information includes the number of ex-dates acquired by the producer, the number of appointments set up by the producer, the number of rejections, the number quotes made by the producer, the number of policies sold by the producer, the amount quoted by the broker for that producer, the amount of business sold to the insurer for the producer as well as the appointment vs. ex-date, quote vs. appointments and sold vs. quote ratios. The monthly report by prospect web page 556 is opened by selecting the radio button 558 on web page 554 as shown in FIG. 10k. The web page 556 lists each prospect, the producer associated with the prospect and the ex-date associated with the prospect. The monthly report by prospect web page 556 also lists for each prospect, the appointment date, quoted premium, actual premium, underwriter policy number, competing quote and rejection reason.

Selecting hyperlink 548 opens the expiry dates calendar web page 558 as shown in FIG. 10l. The web page 558 lists the number of ex-dates on a month by month basis for each of the campaigns handled by the broker.

FIG. 10m shows the search home web page 560 that is accessed by selecting the hyperlink 506. The search home web page 560 allows searches to be performed based on prospect name or campaign.

FIG. 10n shows a new prospect entry web page 562 that is completed by the broker when a new prospect for a campaign is acquired through a referral or other lead. In addition to contact information data fields, the new prospect entry web page 562 includes an ex-date policy data field. The ex-date information is entered into this data field using the date selector dialog box 564 shown in FIG. 10o. When a new prospect is created by a broker, the new prospect becomes active 70 days in advance of the ex-date.

Rollovers

As mentioned previously, a rollover refers to a transfer of a block of business from one insurer to another insurer. Often rollovers occur as a result of an insurer discontinuing an insurance product. The expiry dates of the policies usually govern when rollovers must take place and as a result, it is useful and beneficial to track this information. Accordingly, when a rollover occurs, i.e., the broker determines that a new insurer should be found for a block of business consisting of an insurance product purchased by a group of policyholders, the broker contacts a new insurer, establishes that it is desirable to direct the policyholders to purchase the insurance product from the new insurer and then remits a dataset to the web server 102 of FIG. 7 (see step 604 in FIG. 11) consisting of a number of details of the policyholders, including, for example, name, address and annual premium. Upon receipt of the dataset from the broker, the web server 102 performs data integrity analysis to determine if the data contained in the dataset appears to be valid. Alternatively, the broker can remit the dataset to the insurer via portable storage such as an optical media disk. In turn, the insurer can register the dataset with the web server 102. Once the dataset is deemed valid, the dataset is registered with the SQL database server 104.

Upon registration of the dataset with the SQL database server 104, the dataset is made accessible to the broker via the web server 102 at step 608. The broker then is able to view and modify the data in the dataset to manage the rollover. This can include updating the data, tracking the expiry dates of the existing policies for each prospect, booking appointments to meet or follow up with the prospect, etc. If the insurer deems that it does not want to issue a policy to a prospect, this information can be entered into the computer system. If the prospect obtains insurance from another insurer, this information can be entered into the computer system, along with the reason for the prospect's decision, if one is provided. Accordingly, if the prospect purchases insurance from the insurer, this can be noted in the computer system.

Also, when the dataset is entered into the database, the insurer is able to access the dataset to confirm that the data provided matches any external accounts of the block of business at step 612. Further, the insurer is then able to track the progress of the rollover by being presented with the status of each prospect, the overall statistics, etc.

In such a manner, the computer system allows the broker to manage the rollover, allows the insurer to track the progress and success of the rollover and provides a central database evidencing the performance of the rollover to both the broker and the insurer.

Insurer Web Pages for Rollovers

As mentioned above, the prospect categories related to rollovers are presented as hyperlinks 233, 235, 237 and 239 linked to quick statistics detail web pages.

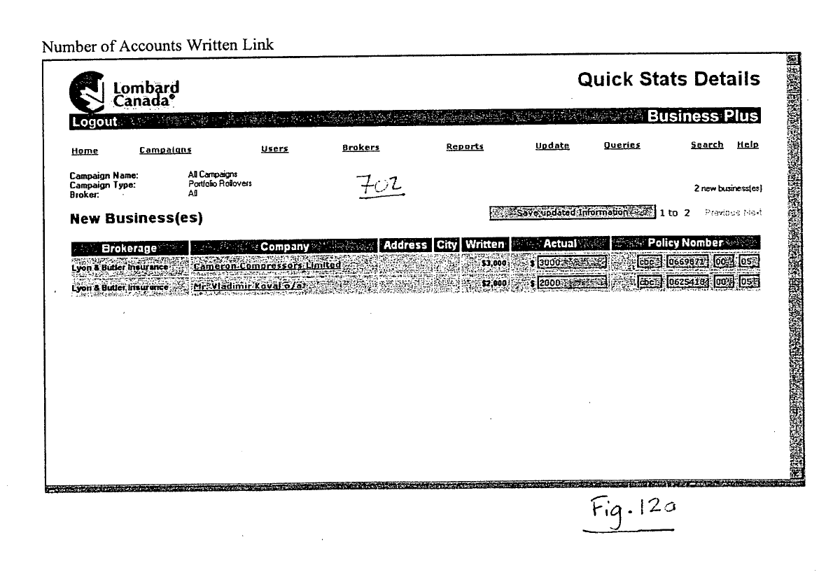

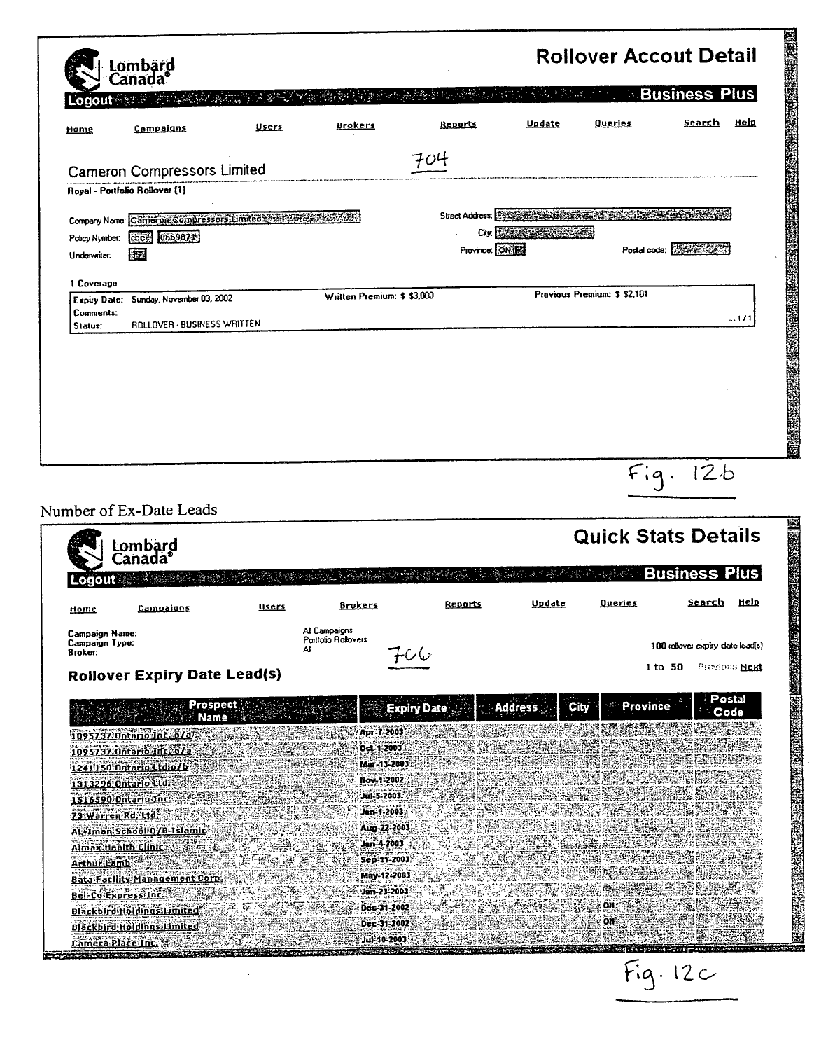

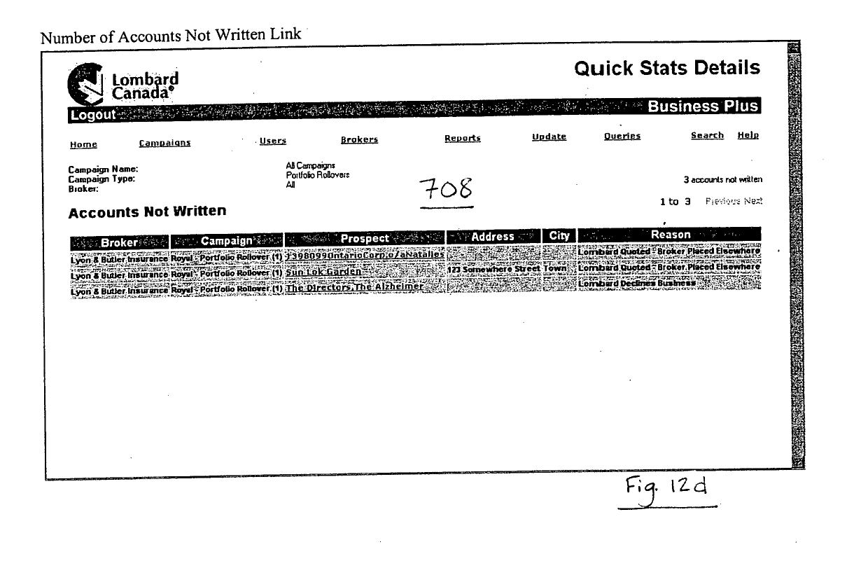

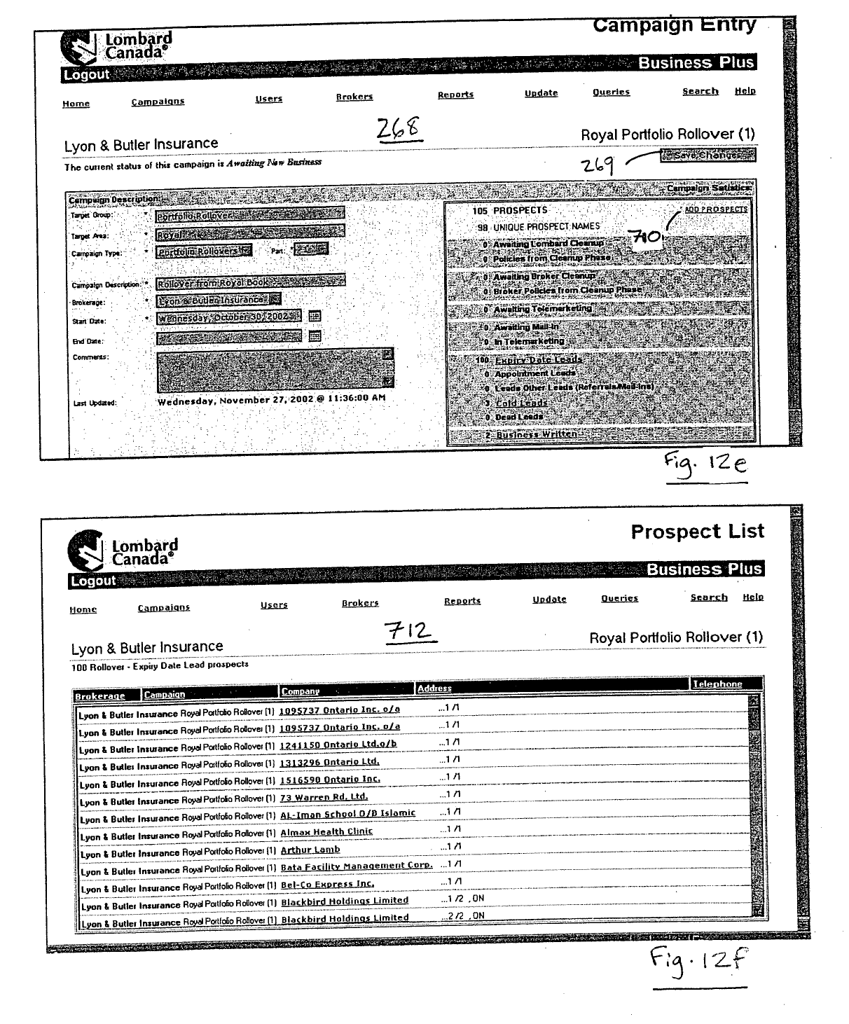

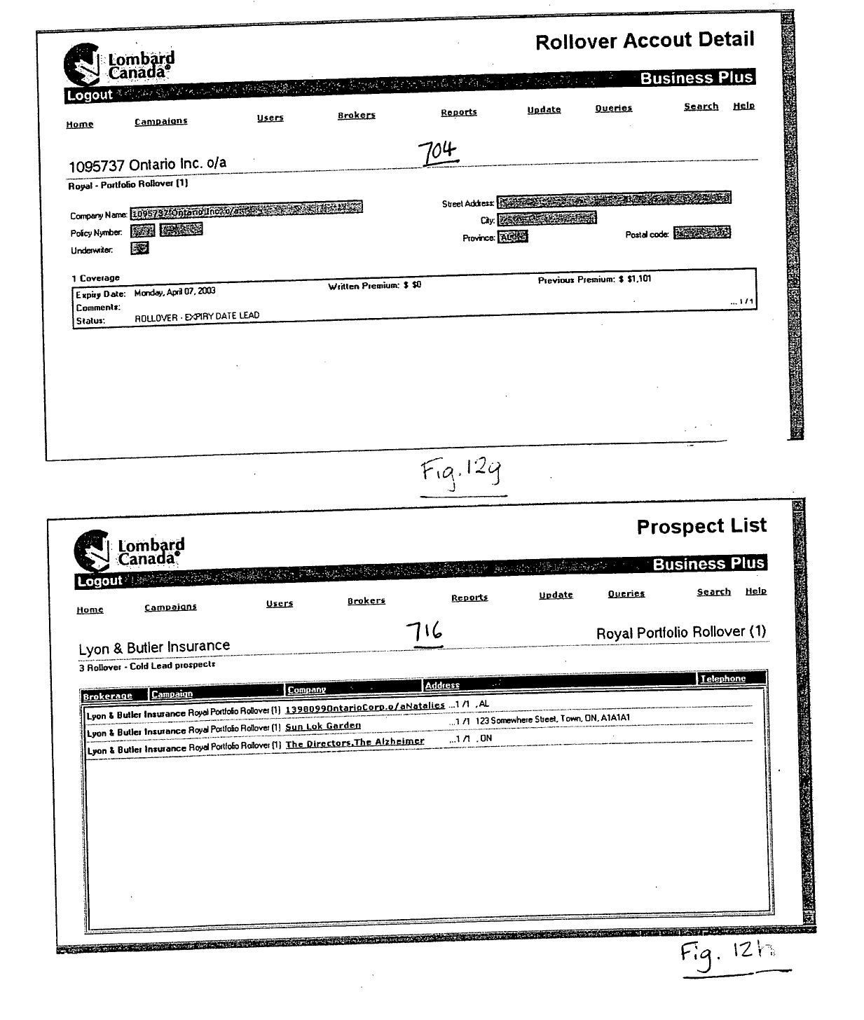

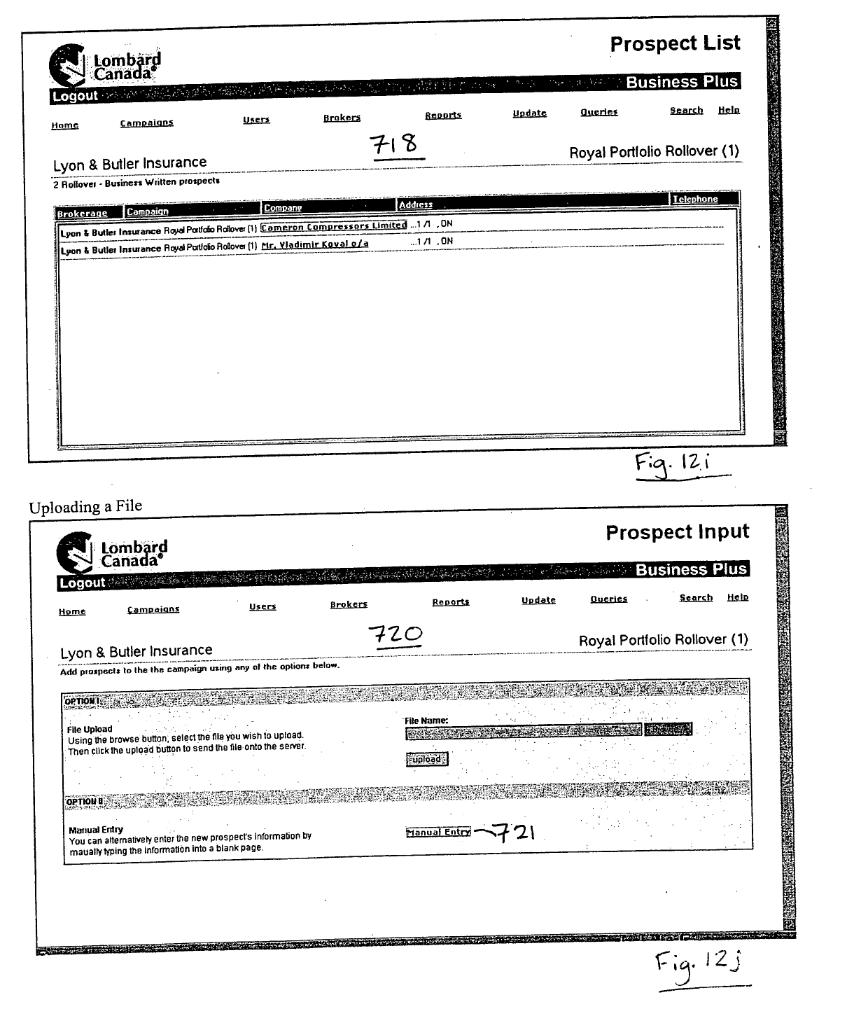

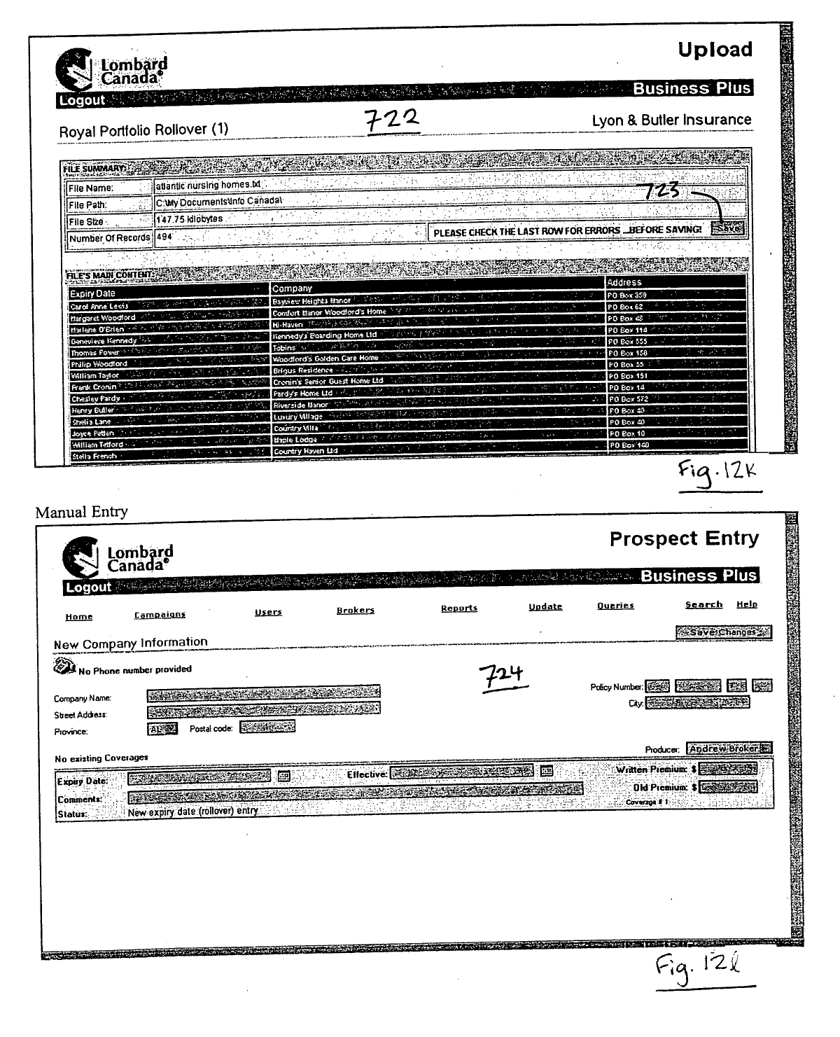

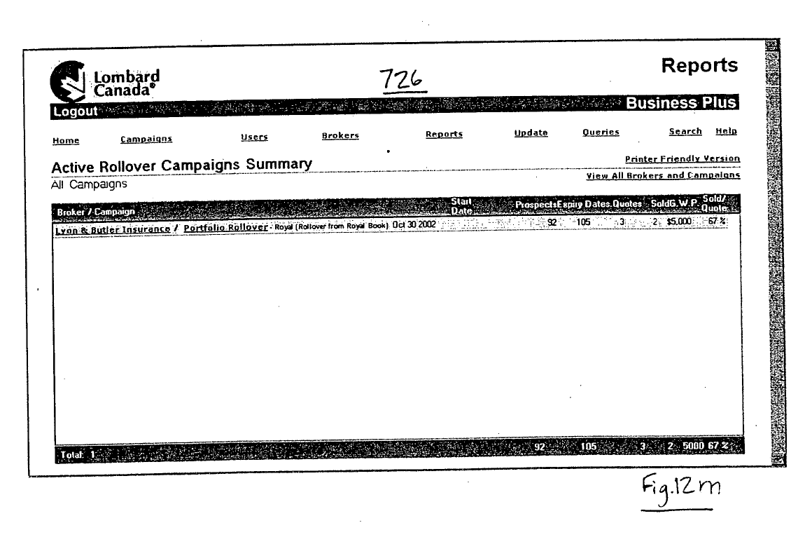

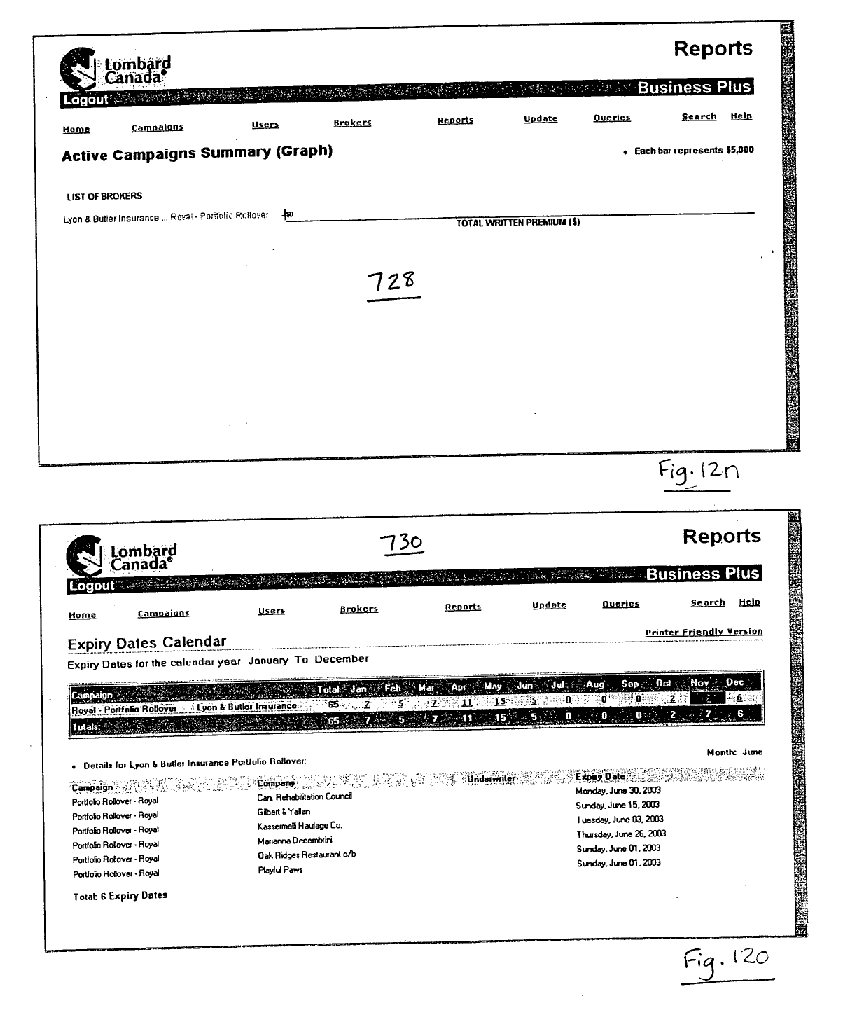

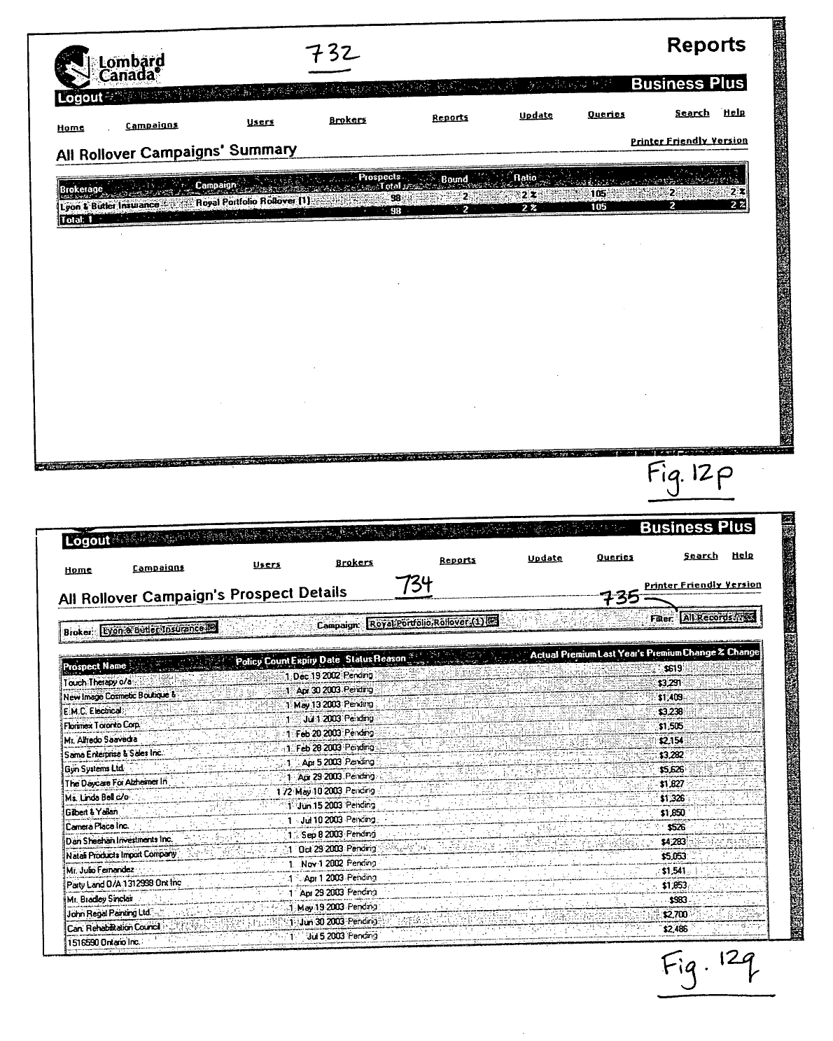

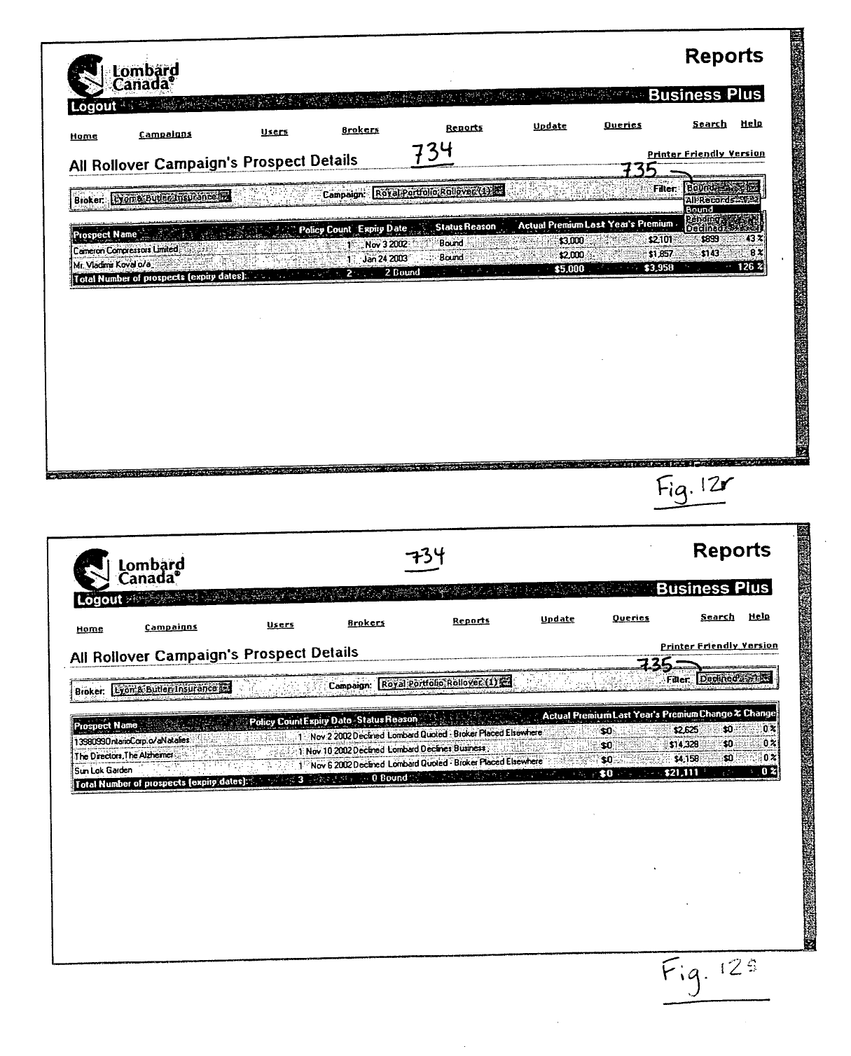

FIG. 12a shows the quick statistics detail web page 702 that is linked to hyperlink 233. As can be seen, web page 702 lists the prospects that have purchased insurance from the insurer. Each identified prospect is presented as a hyperlink linked to an associated prospect web page similar to that shown in FIG. 12b that exposes the prospect's profile.

FIG. 12b shows the prospect detail web page 704 that is opened in response to selection of a prospect on web page 702. The web page 704 allows viewing and editing of the prospect's data and shows the rollover status of the prospect. In the illustrated example, the prospect's record has previously been updated to reflect that the prospect has purchased insurance from the insurer. The prospect's data includes an expiry date for the prospect's current policy.

FIG. 12c shows the quick statistics detail web page 706 that is linked to hyperlink 235. As can be seen, web page 706 lists the prospects from whom ex-date information has been acquired. Each identified prospect is presented as a hyperlink linked to an associated prospect web page.

FIG. 12d shows the quick statistics detail web page 708 that is linked to hyperlink 237. As can be seen, web page 708 lists the prospects who either have rejected an offer of insurance from the insurer or whom the insurer has rejected for insurance. Again, each identified prospect is presented as a hyperlink linked to an associated prospect web page.

FIG. 12e shows the rollover entry web page 268 linked to the sixteenth item listed on the current campaign home web page 266. As can be seen, the rollover web page 268 identifies the rollover target group and the broker. Web page 268 also identifies the total number of prospects associated with the campaign. The prospects are broken down into the same categories as on the administrator home web page 200, but as the data has been provided by the broker and represents prospects insured through another insurer, the prospect list does not have to be cleaned in same manner as the data for a campaign as discussed previously. The rollover data can be updated and saved by the user by selecting the save changes bar 269. The add prospects hyperlink 710 can be used to enter new prospects into the rollover.

FIG. 12f shows the ex-date lead prospect web page 712 for the rollover illustrated in FIG. 12e. As can be seen, web page 712 lists the prospects from whom ex-date information has been acquired. Each identified prospect is presented as a hyperlink linked to an associated prospect web page.

FIG. 12g shows the prospect detail web page 704 that is opened in response to selection of a prospect on web page 712. The web page 704 allows viewing and editing of the prospect's data and shows the rollover status of the prospect. In the illustrated example, the prospect's record indicates the expiry date for the prospect's current policy and that the prospect is an expiry date lead.

FIG. 12h shows the cold lead prospect web page 716 for the rollover illustrated in FIG. 12e. As can be seen, web page 716 lists the prospects from whom ex-date information has not been acquired. These prospects may be entities who have not purchased the type of insurance in question from the broker, but who are believed to be interested in the type of insurance. Again, each identified prospect is presented as a hyperlink linked to an associated prospect web page.

FIG. 12i shows the cold lead prospect web page 718 for the rollover illustrated in FIG. 12e. As can be seen, web page 718 lists the prospects that have purchased insurance from the insurer. Again, each identified prospect is presented as a hyperlink linked to an associated prospect web page.

FIG. 12j shows the prospect input web page 720 that is linked to hyperlink 710. Input page 720 allows a user to upload a file containing new prospect data or to manually enter in the new prospect data by selecting the manual entry hyperlink 721.

FIG. 12k shows a data verification web page 722 showing uploaded data entered through page 720. A user can visually inspect the data uploaded to verify its integrity before incorporating the data into the rollover using the save button 723.

FIG. 12l shows a prospect entry web page 724 that is linked to hyperlink 721 on page 720. Page 724 presents fields allowing a user to manually enter the data for a prospect into the rollover.

Referring again to FIG. 8z, a number of hyperlinks are presented to allow a user to view various pages presenting reports with respect to the rollovers.

Selection of hyperlink 312 on page 300 in FIG. 8z opens an all active rollovers summary web page 726 as shown in FIG. 12m. The web page 726 lists each rollover pursued by the insurer, the broker managing each rollover and statistical information relating to each rollover. In this case, illustrated web page 726 only shows one active rollover. The brokers are presented as hyperlinks linked to associated broker web pages. The rollovers are also presented as hyperlinks linked to associated campaign web pages.

Selection of hyperlink 313 on page 300 opens an active rollovers summary graph web page 728 as shown on FIG. 12n that presents a graphical representation of the success of each rollover registered in the database. While web page 728 shows only one rollover with no success thus far, this is for ease of illustration. Web page 728 in fact presents each rollover in the database and its success to date.

Selection of hyperlink 314 opens an expiry dates calendar web page 730 as shown in FIG. 12o. The web page 730 lists each rollover pursued by the insurer, the broker responsible for each rollover and the number of expiry dates for the campaigns on a month by month basis.

Selection of hyperlink 316 on page 300 opens an all active rollovers summary web page 732 as shown in FIG. 12p. The web page 732 lists all active rollovers pursued by the insurer broken down by managing broker together with statistical information relating to the campaigns. The brokers are presented as hyperlinks linked to associated broker web pages.

Selection of hyperlink 317 opens an all active rollovers details web page 734 as shown in FIG. 12q. The web page 734 lists each active campaign's active prospects and presents detailed information relating to each prospect. Web page 734 has a dropdown menu 735 allowing a user to filter the prospects shown. In this case, all records have been selected to be shown.

FIG. 12r shows web page 734 with a selection being made via dropdown menu 735 to show all prospects that purchased insurance from the insurer. Similarly, FIG. 12s shows web page 734 with a selection being made via dropdown menu 735 to show all prospects that were declined insurance by the insurer.

Selection of hyperlink 318 opens an all active rollovers summary web page 736 as shown in FIG. 12t. The web page 736 lists all active rollovers pursued by the insurer broken down by managing broker together with statistical information relating to the rollovers. The brokers are presented as hyperlinks linked to associated broker web pages.

Selection of hyperlink 319 opens an all active rollover campaigns prospect details web page 738 as shown in FIG. 12u. Similar to web page 734, web page 738 includes a dropdown menu to allow a user to filter the prospects shown for each active rollover.

Selecting the update hyperlink 212 or search hyperlink 216 from any page opens a prospect search web page 740 as shown in FIG. 12v that is equal to web page 332 and operable to search the rollover data when the appropriate dropdown menu 741 item is selected. A user enters a string to search for in the prospect data via search box 742.

The results of the search illustrated in FIG. 12v are presented in search results web page 744 as shown in FIG. 12w. The prospects returned as a result of the search are presented via hyperlinks, allowing a user to edit the data for the returned prospects.

Upon selection of the first hyperlinked prospect of FIG. 12w, database update web page 746 as shown in FIG. 12x is presented, allowing a user to view and/or modify the prospect's data.

Selection of hyperlink 214 from any rollover-directed page opens a rollover query builder web page 748 as shown in FIG. 12y. The web page 748 allows a user to build a query of the rollovers in the database by selecting filters for one or more fields. An exemplary query is shown specifying that all prospects of a specific rollover are to be returned. FIG. 12z shows a query results web page 750 presenting the results of the query of FIG. 12y.

Broker Web Pages for Rollovers

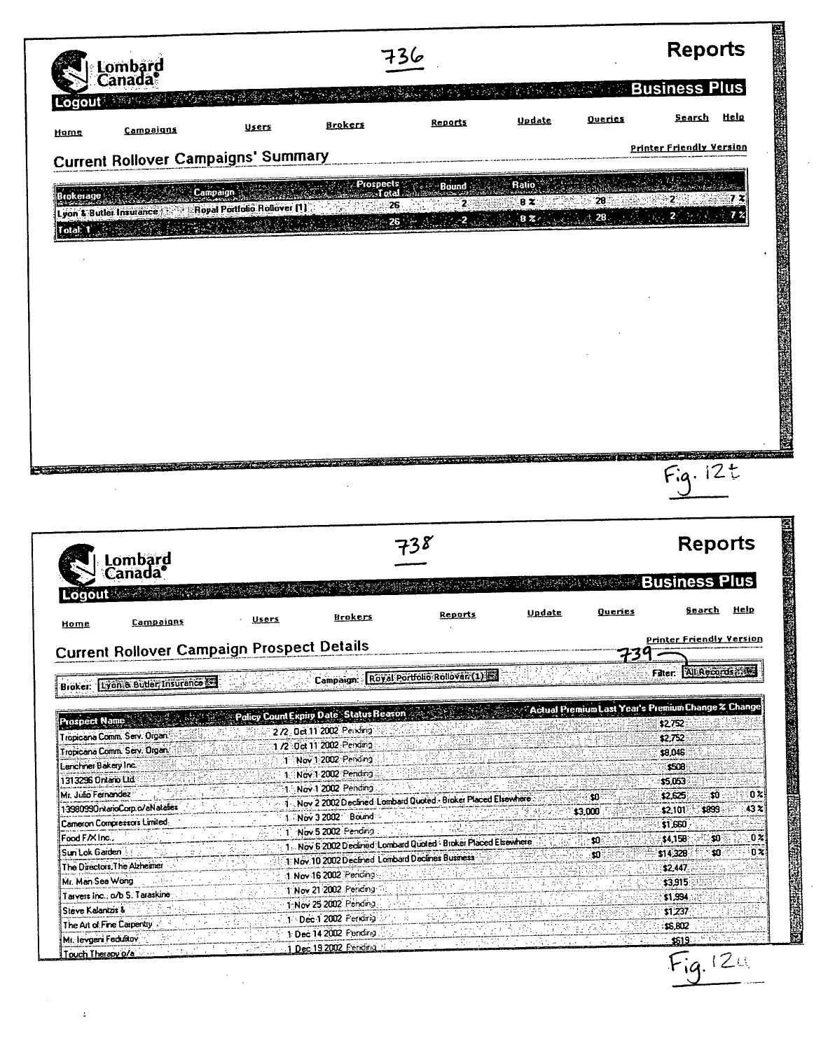

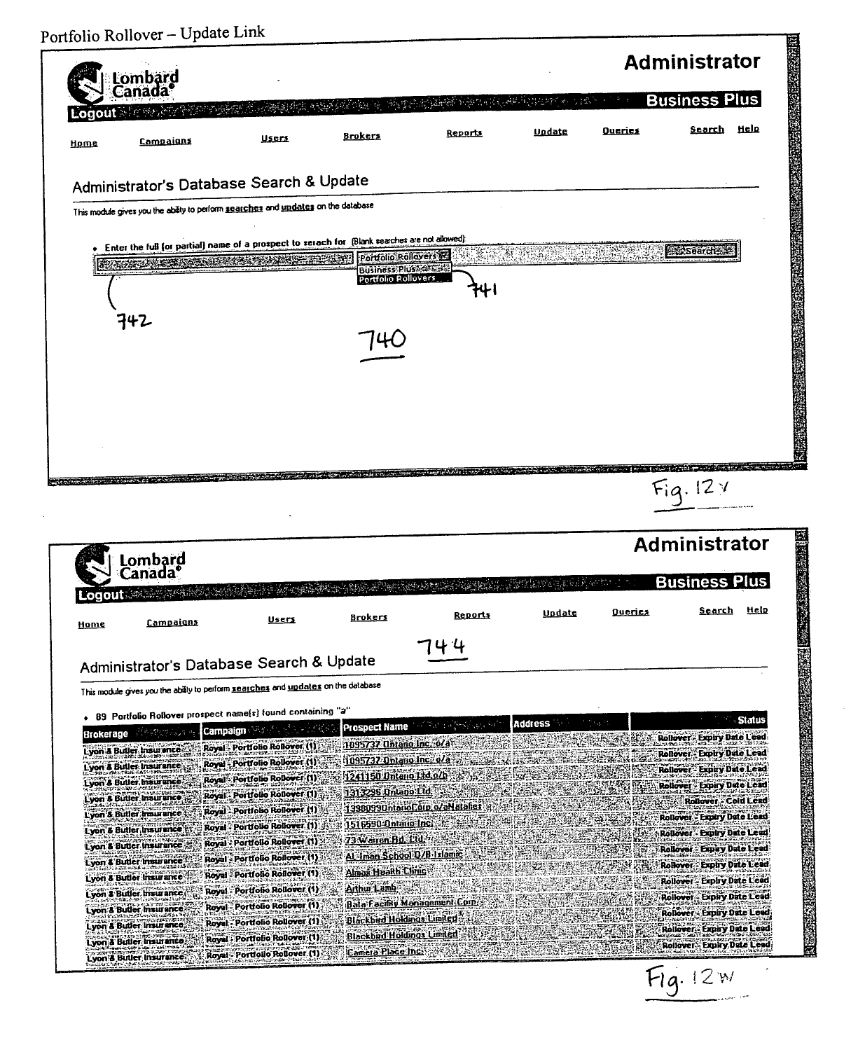

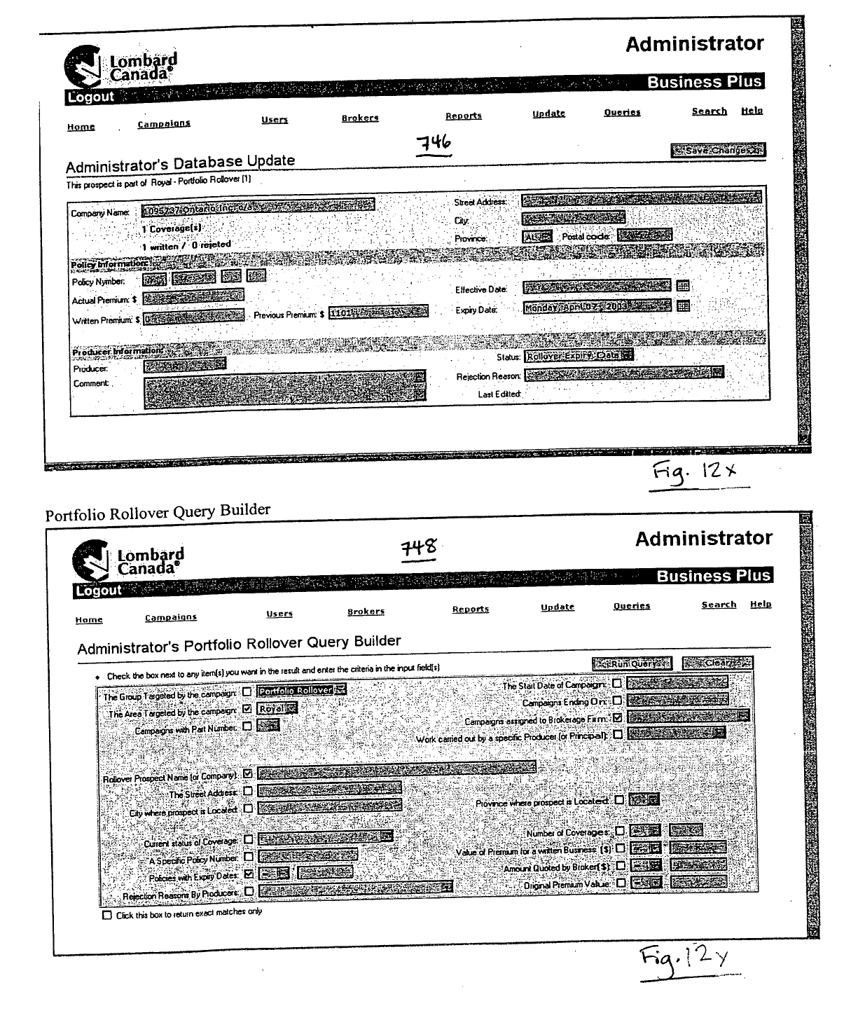

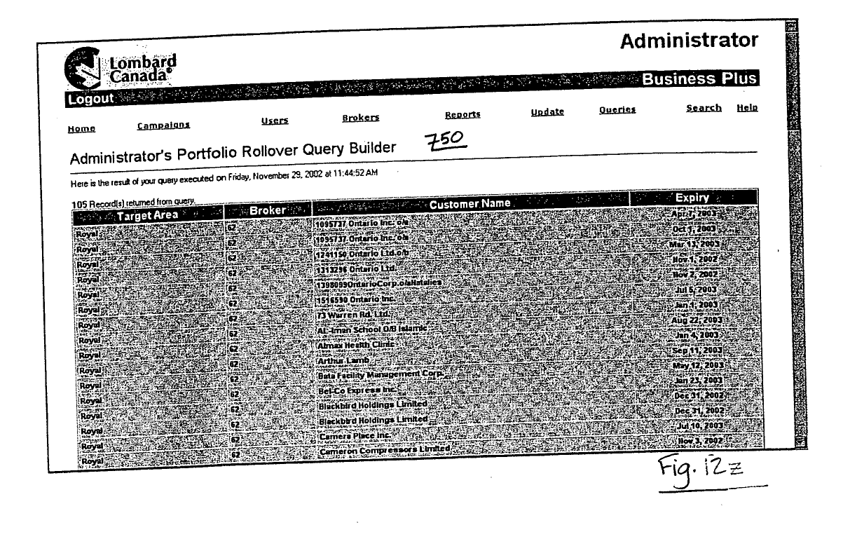

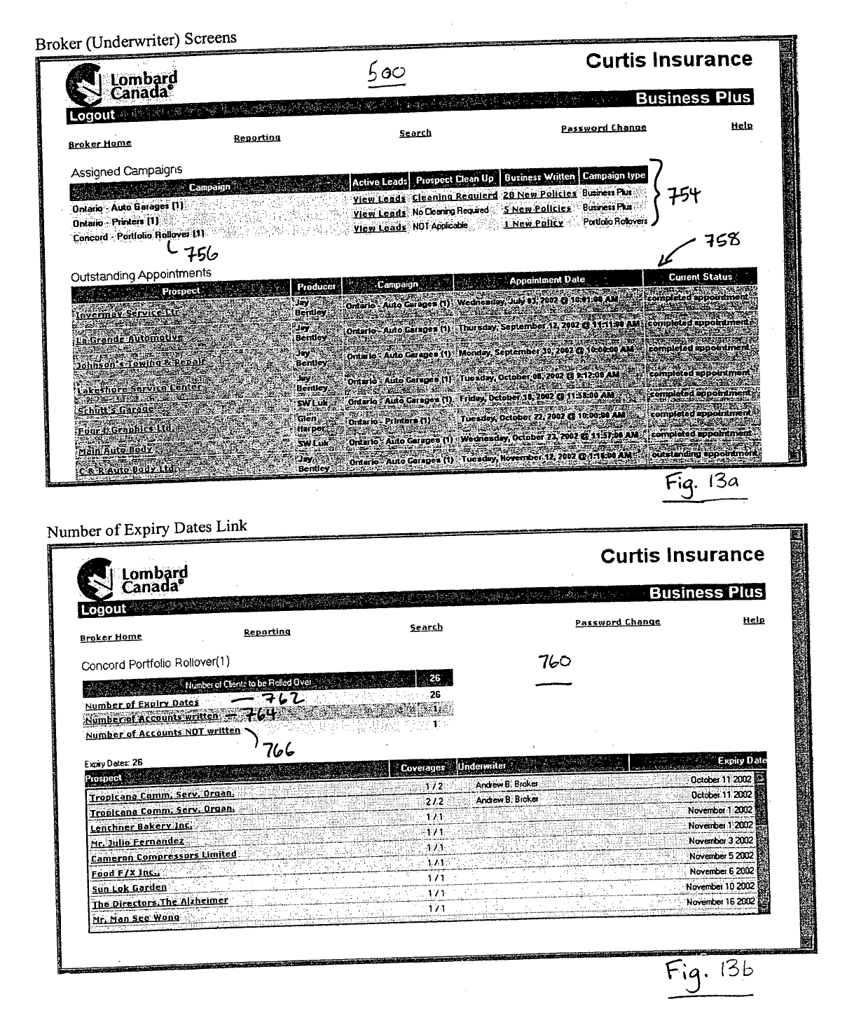

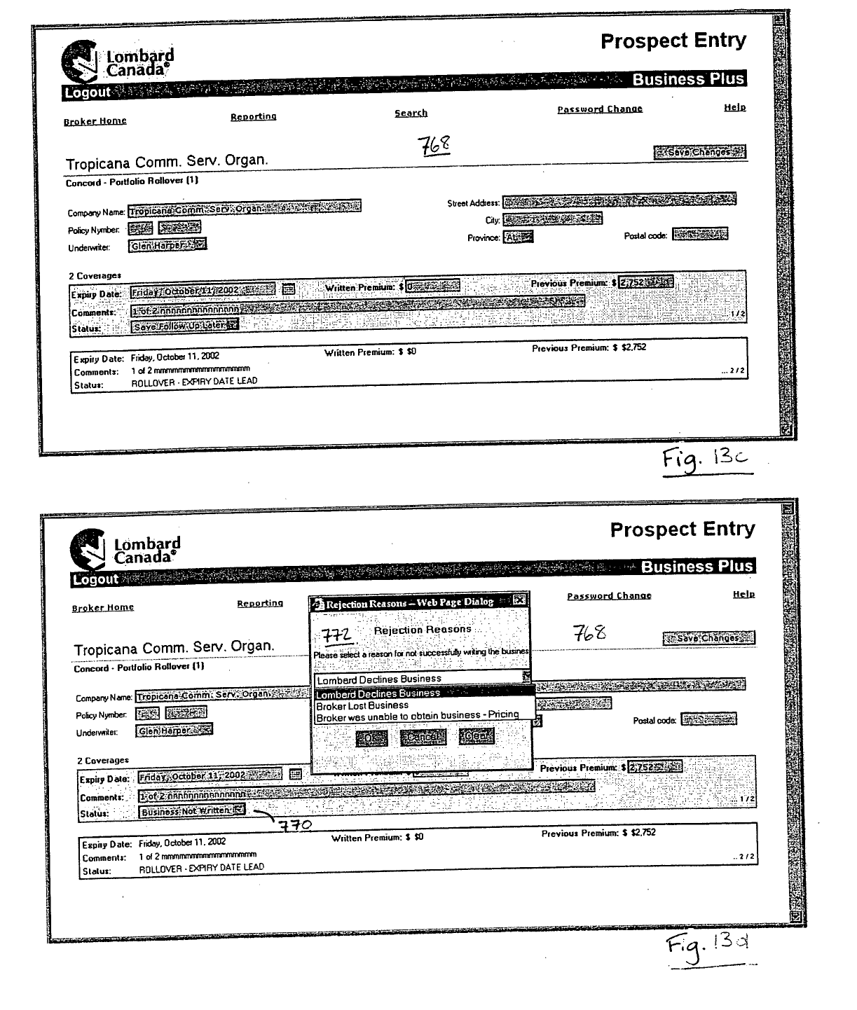

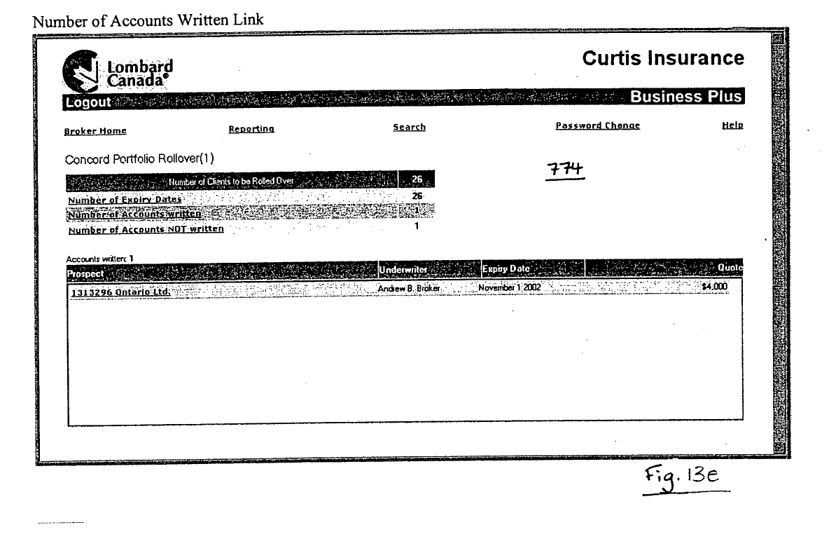

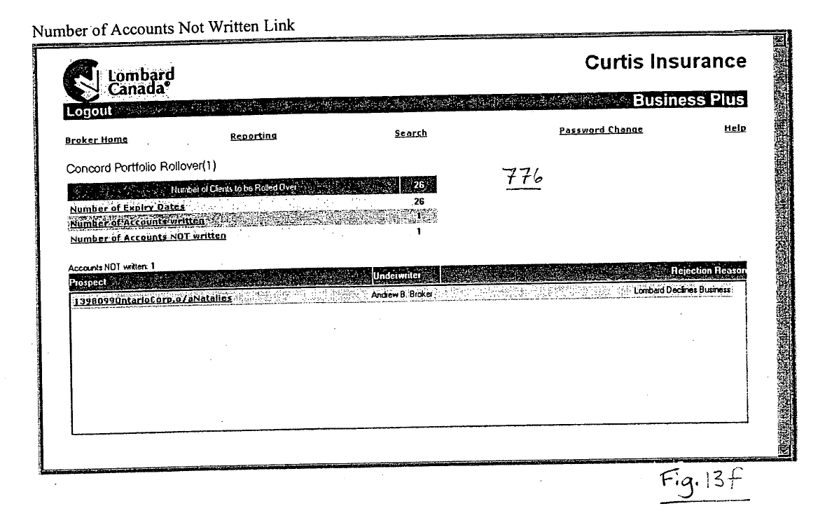

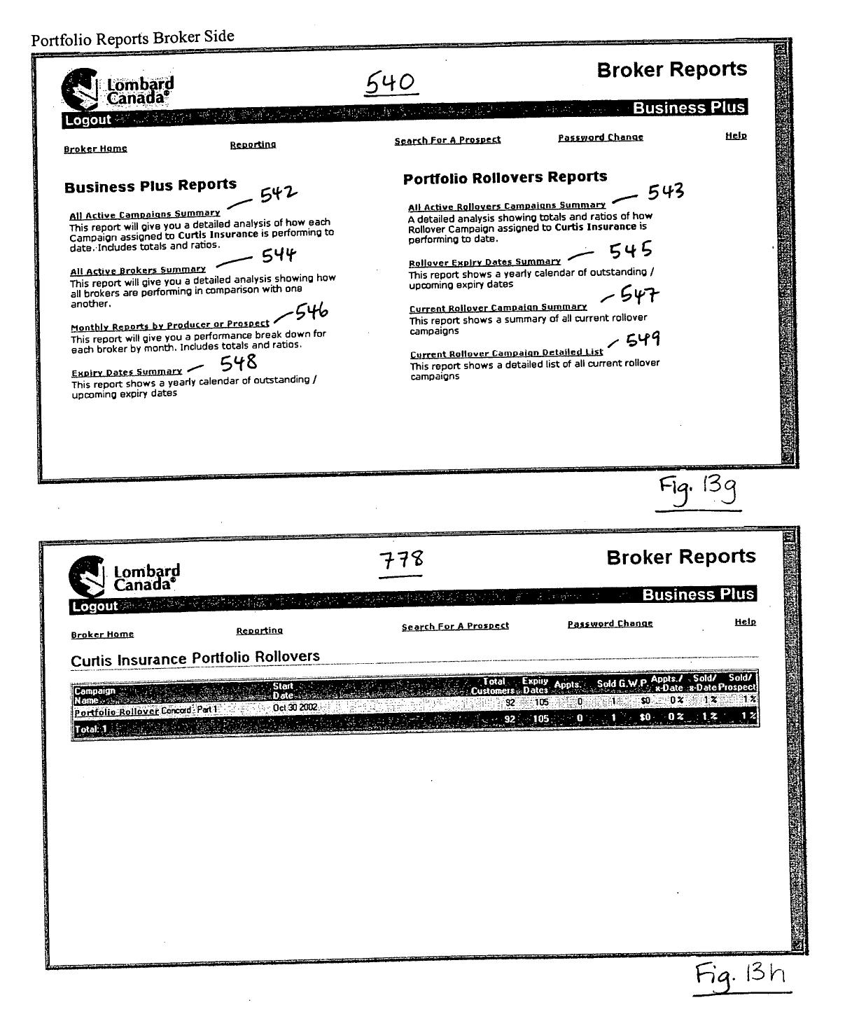

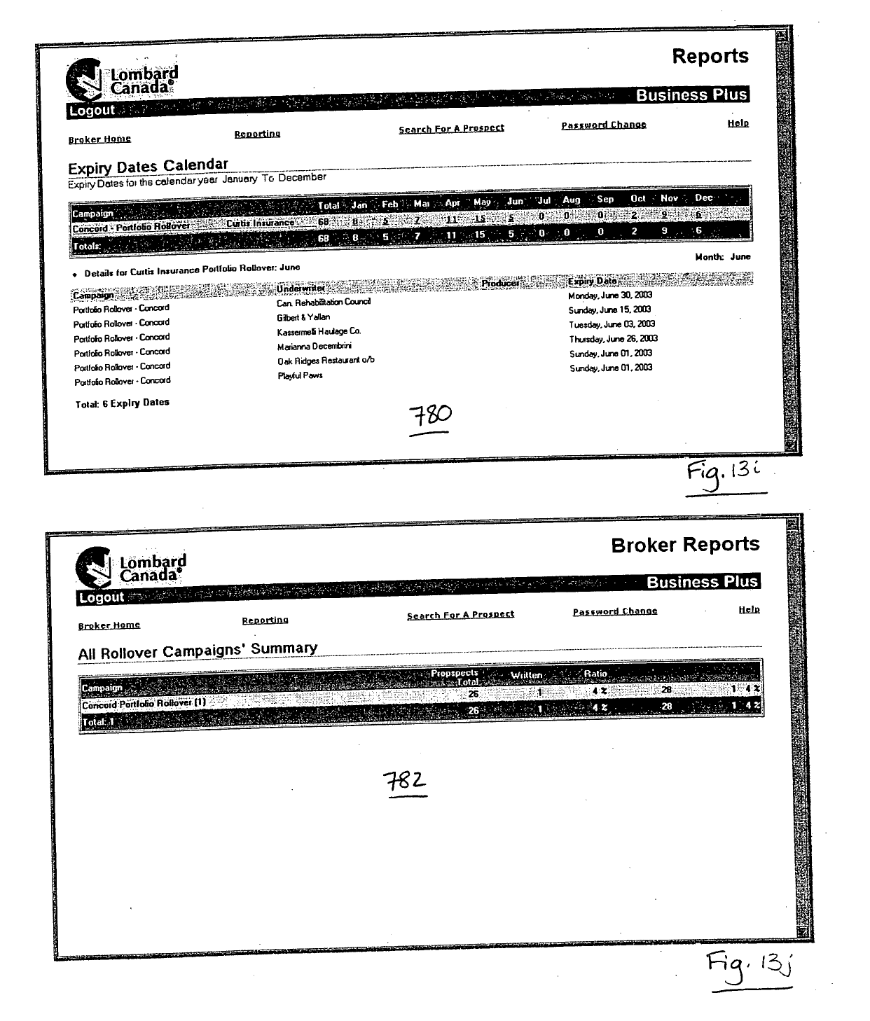

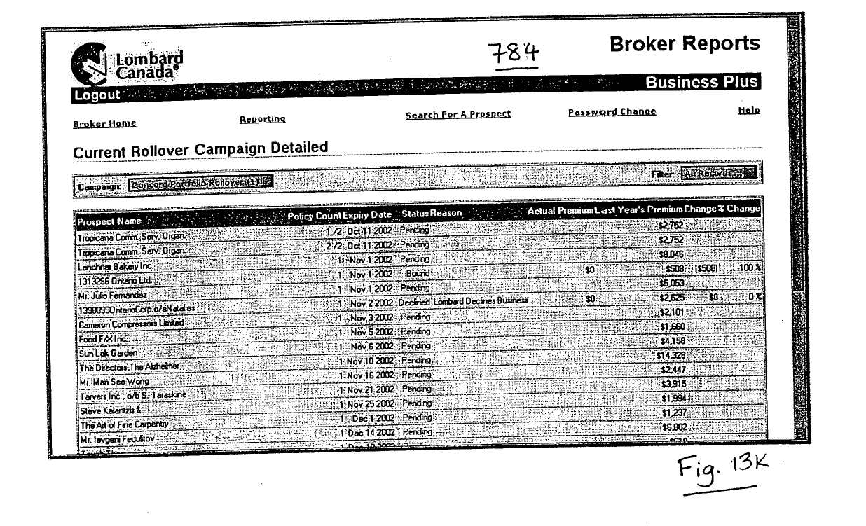

FIG. 13a shows a brokers home web page 500 assembled for broker managing of both campaigns and a rollover. The brokers home web page 500 shows a list of campaigns 754, including a rollover 756. The campaigns in the list as well as the rollover are presented as hyperlinks. Additionally, a list of outstanding appointments 758 is shown, comprising both campaign and rollover appointments. Thus, by viewing home web page 500, a broker is able to monitor all campaign and rollover activities.

By selecting the rollover 756, a user is presented with a rollover summary web page 760 as shown in FIG. 13b showing the number of prospects that are unsettled (i.e., with expiry dates), that have purchased insurance from the insurer and that will not be purchasing insurance from the insurer, presented as hyperlinks 762, 764 and 766. Further, a list of prospects with expiry dates is immediately presented. Each prospect's name is a hyperlink, allowing a user to select the prospect to view and edit the prospect's data.

Upon selection of the prospect's name, the prospect entry web page 768 shown in FIG. 13c, similar to the web pages illustrated in FIGS. 12b, 12g and 12l, is presented to the user. A user may then view and edit the prospect's data.

FIG. 13d shows the web page 768 that is presented when the “Business Not Written” option has been selected from the status dropdown list 770. Upon this selection, a rejection reasons popup window 772 appears, enabling the user to enter the reason why insurance will not be provided to the prospect. As noted previously, the reasons can include rejection by either the prospect or the insurer.

Upon selection of the hyperlink 764 on web page 760, the user is presented with the rollover accounts written web page 774 shown in FIG. 13e. Web page 774 lists the prospects of the rollover in question that have purchased insurance from the insurer as a result of the rollover.

Similarly, upon selection of the hyperlink 766 on web page 760, the user is presented with the rollover accounts not written web page 776 as shown in FIG. 13f. Web page 776 lists the prospects that will not purchase insurance from the insurer as a result of the rollover.

FIG. 13g presents the same broker reports web page 540 as shown in FIG. 10g, but for a different broker. Upon selection of hyperlink 543, the user is presented with the rollover campaigns summary web page 778 as shown in FIG. 13h. Web page 778 presents a list of all rollovers being managed by the broker in question, along with various rollover statistics.

Upon selection of hyperlink 545, the user is presented with the rollover expiry dates calendar web page 780 as shown in FIG. 13i, similar to web page 730 of FIG. 12o. The web page 780 lists each rollover pursued by the broker and the number of expiry dates for the campaigns on a month by month basis. Also shown is a list of prospects with upcoming expiry dates.

Upon selection of hyperlink 547, the user is presented with the all rollover campaigns web page 782 as shown in FIG. 13j, similar to web page 732 of FIG. 12p. The web page 780 lists all rollovers pursued by the broker and various statistics for each rollover.

Upon selection of hyperlink 549, the user is presented with the all rollover campaigns details web page 784 as shown in FIG. 13k. The web page 784 lists all prospects of all rollovers pursued by the broker and various details for each prospect.

As will be appreciated, the marketing and sales application GUI allows the broker to manage appointments for the various handled campaigns and rollovers and monitor performance overall and by producer. The GUI also allows the broker to compare their performance with other brokers appointed by the insurer.

Policy Performance Analysis

In order to monitor the effectiveness of targeted marketing, it is desirable to analyze the performance or profitability of the policies generated using the marketing and sales application. The profitability can be characterized by policy retention, attrition, claims, etc. Policy data required to determine such characteristics is stored in the policy administration system 105 that is separate from the marketing and sales application executed on the web server 102. The policy data includes, but is not limited to, policy renewal data, policy premium data, claim data and policy termination data. By combining the policy data with the marketing and sales data, the performance of the policies generated as a result of such campaigns can be measured. The policy performance can be summarized by broker, by campaign, by year, etc.

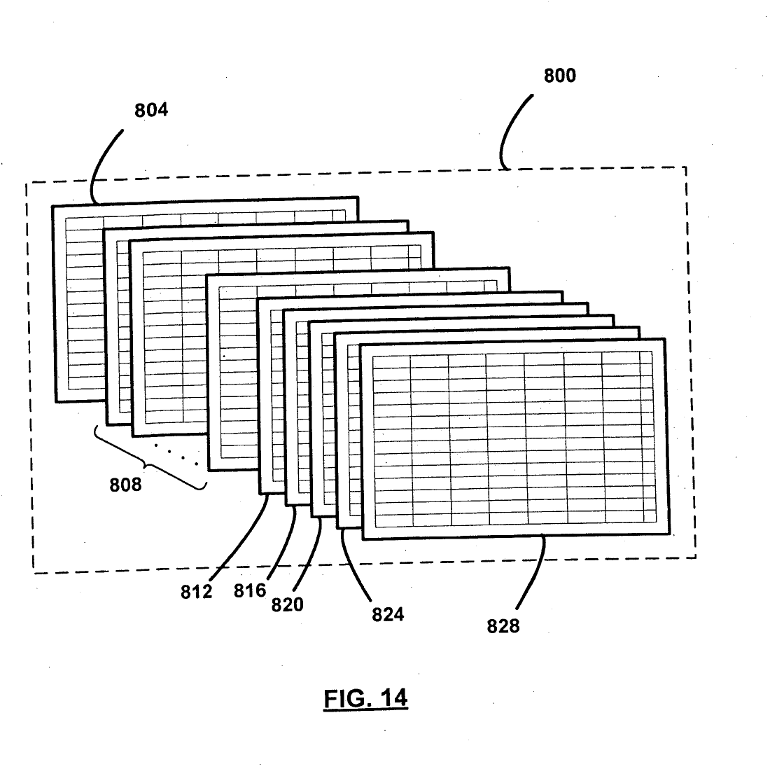

FIG. 14 shows a Microsoft Excel workbook 800 into which the policy data and marketing and sales data are imported for analysis. The workbook 800 has a plurality of worksheets, among which are a data import sheet 804, a set of annual summary sheets 808, a price increase summary sheet 812, a policy summary sheet 816, a campaign summary sheet 820, a broker summary sheet 824 and a new policies summary sheet 828. The data import sheet 804 receives policy data that is inputted for processing. Each of the annual summary sheets 808 looks up data for the appropriate years in the data import sheet 804, validates it and summarizes the projected and actual policy activity for each broker/campaign combination for a particular calendar year. Each of the price summary sheet 812, the policy summary sheet 816, the campaign summary sheet 820, the broker summary sheet 824 and the new policies summary sheet 828 references the data processed in the annual summary sheets 808. In turn, the price summary sheet 812 provides a summary of the price trends for policies issued as a result of a campaign. The policy summary sheet 816 provides an overall analysis of the performance of the policies generated as a result of all of the campaigns. The campaign summary sheet 820 summarizes the performance of the policies generated as a result of each campaign by calendar year of issuance. The broker summary sheet 824 summarizes the performance of the policies generated as a result of each broker by calendar year of issuance. The new policies summary sheet 828 summarizes the performance of the policies generated as a result of each campaign and by each broker that are newly issued in the current calendar year.

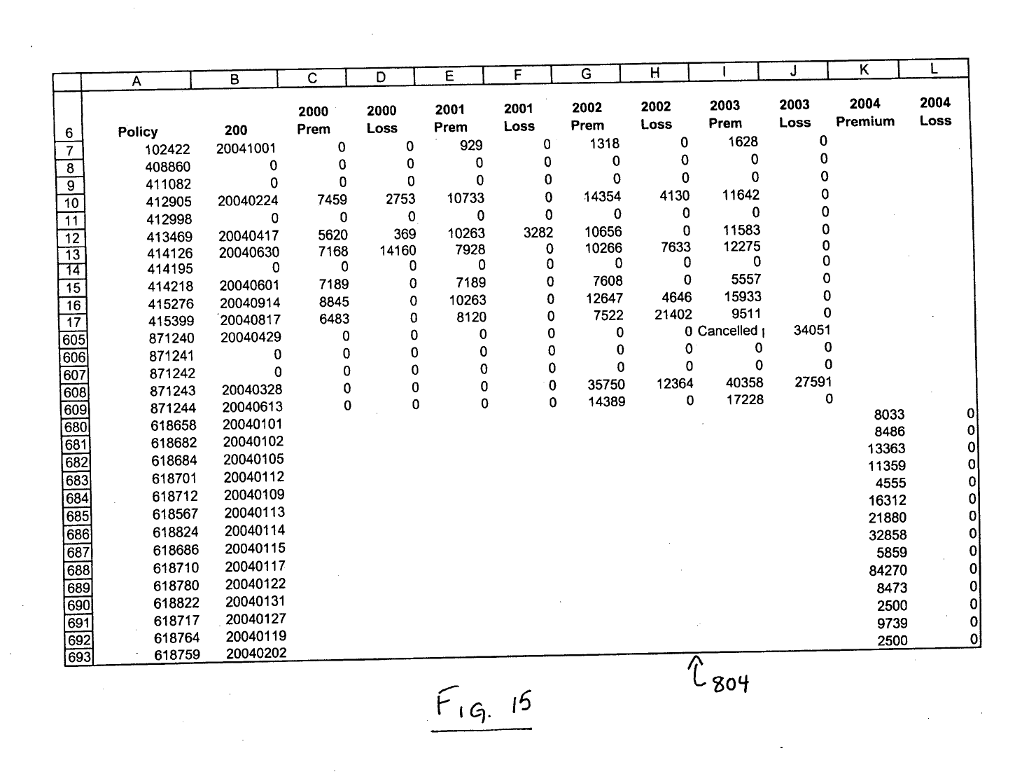

FIG. 15 illustrates a section of the data import sheet 804. The policy data is exported from the policy administration system into a Microsoft Excel workbook, which is, in turn, imported into a range of the data import sheet 804. The layout of the policy data is in a specified form and, as a result, each field of the policy data is placed into a pre-defined column of the data import sheet 804 when imported.

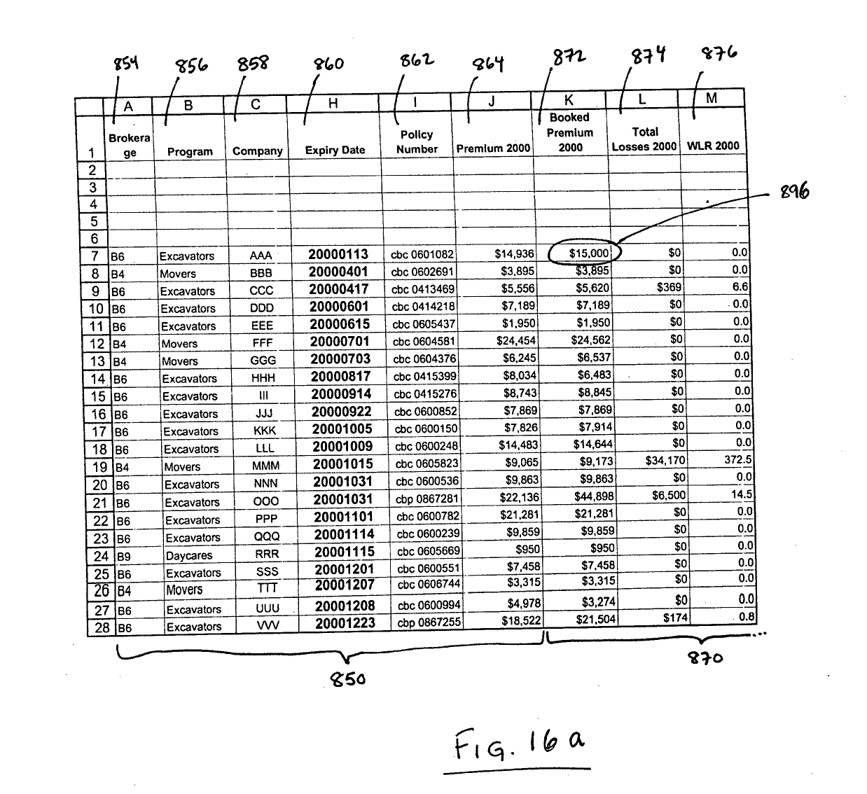

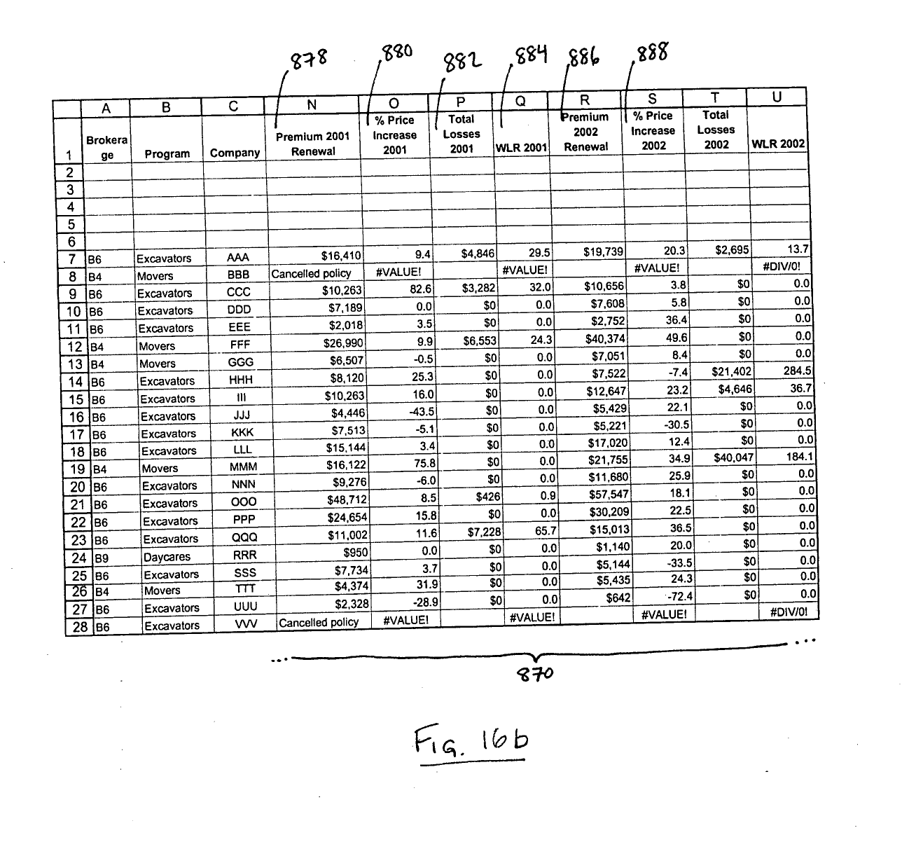

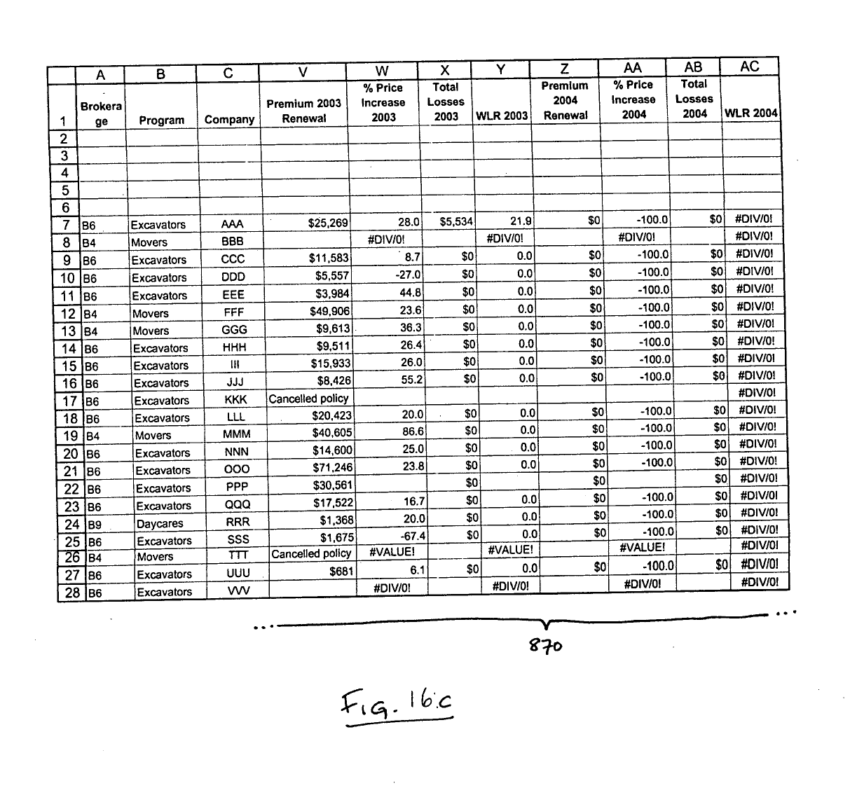

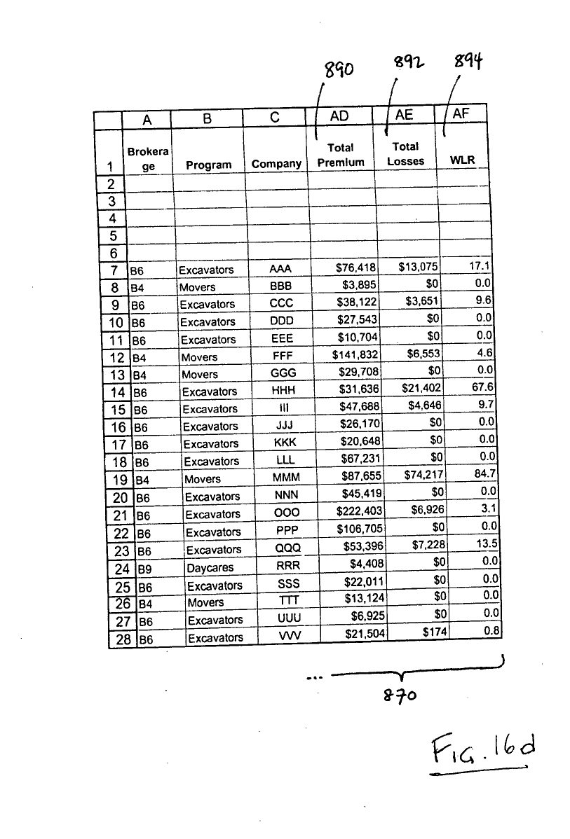

FIGS. 16a to 16d illustrate a section of one of the annual summary sheets 808; in particular, for policies generated as a result of campaigns during the 2000 calendar year. A first portion 850 of each of the annual summary sheets 808 is initially populated using the data from the marketing and sales application. The fields populated using the marketing and sales data include a broker field 854, a campaign field 856, a policyholder name and particulars field 858, a policy expiry date field 860, a policy number field 862 and an expected premium field 864.

A second portion 870 of each of the annual summary sheets 808 is populated using the policy data imported into the data import sheet 804. For the 2000 calendar year, the second portion 870 includes a booked premium field 872, a total losses field 874 and a written loss ratio field 876 for the 2000 calendar year. For the 2001 calendar year, the same annual summary sheet 808 contains a premium renewal field 878, a percent price increase field 880, a total losses field 882 and a written loss ratio field 884. For the 2002 calendar year, the same annual summary sheet 808 includes a premium renewal field 886, a percent price increase field 888, etc. Each annual summary sheet also contains a total premium field 890, a total losses field 892 and a written loss ratio field 894. A new annual summary sheet 808 is generated for each policy year.

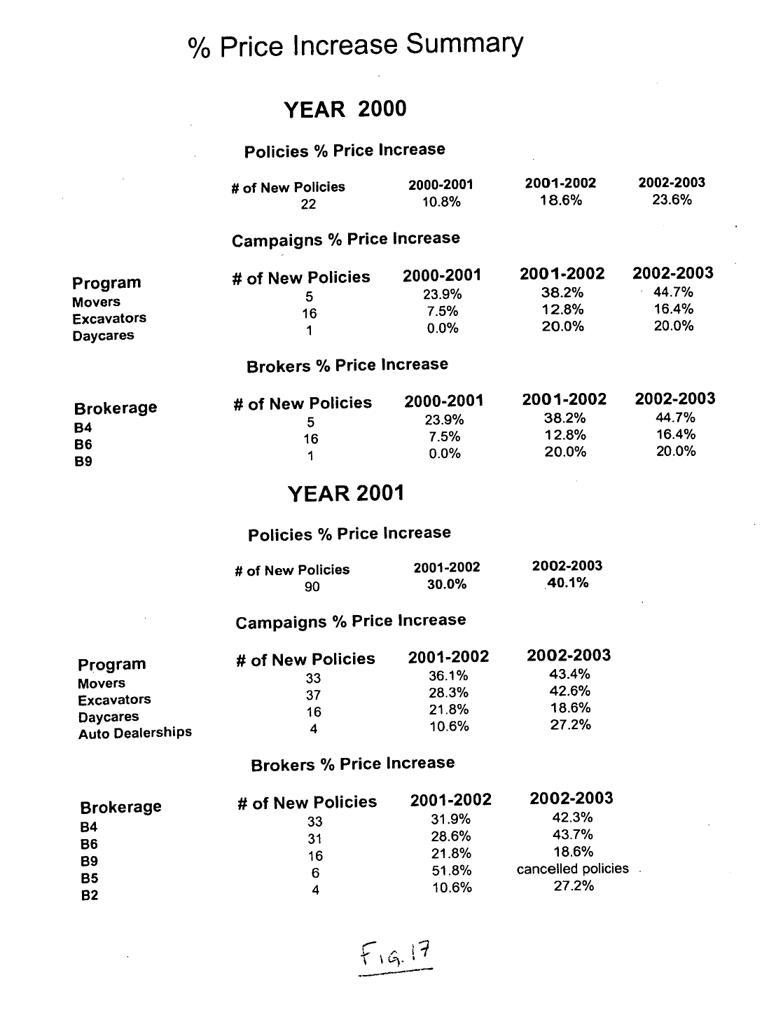

FIG. 17 illustrates a section of the price increase summary sheet 812. As shown, the price trends between consecutive calendar years for policies issued as a result of a campaign are summarized by campaign and by broker.

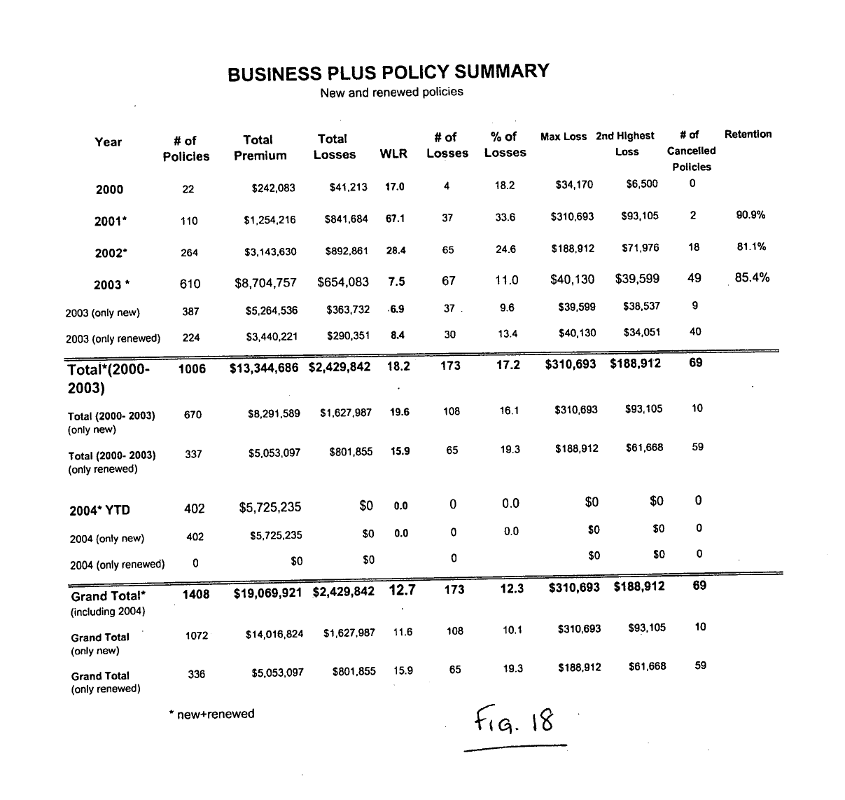

FIG. 18 illustrates a section of the policy summary sheet 816. The policy summary sheet 816 provides measures of the overall performance of the policies generated as a result of all of the campaigns and brokers. Breakdowns are provided for each calendar year, for new policies, and for renewed policies. The measures include the number of policies, the total premium, the total losses, the loss to premium ratio (as a percent), the number of losses, the losses to policies ratio (as a percent), the maximum loss, the second highest loss, the number of cancelled policies and the retention rate.

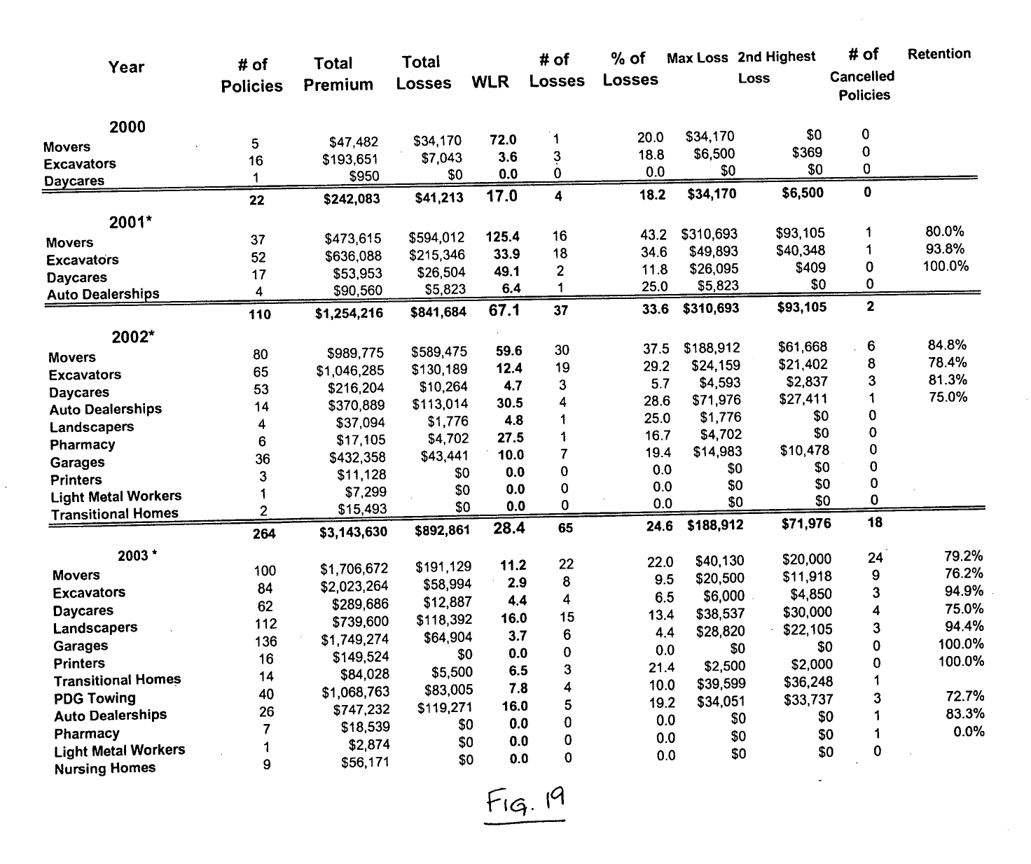

FIG. 19 illustrates a section of the campaign summary sheet 820. Like the policy summary sheet 816, the campaign summary sheet 820 provides measures of the performance of the policies generated as a result of each campaign during each calendar year. Breakdowns are provided for each calendar year, for new policies, and for renewed policies. The measures include the number of policies, the total premium, the total losses, the loss to premium ratio (as a percent), the number of losses, the losses to policies ratio, the maximum loss, the second highest loss, the number of cancelled policies and the retention rate.

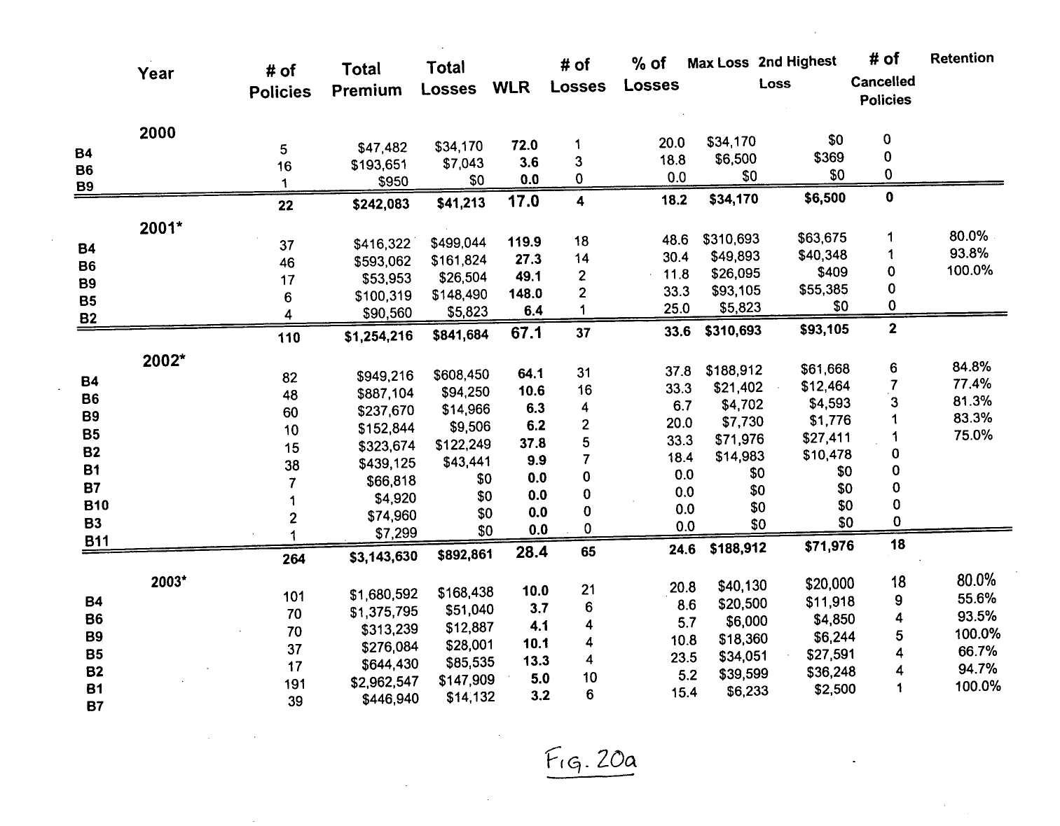

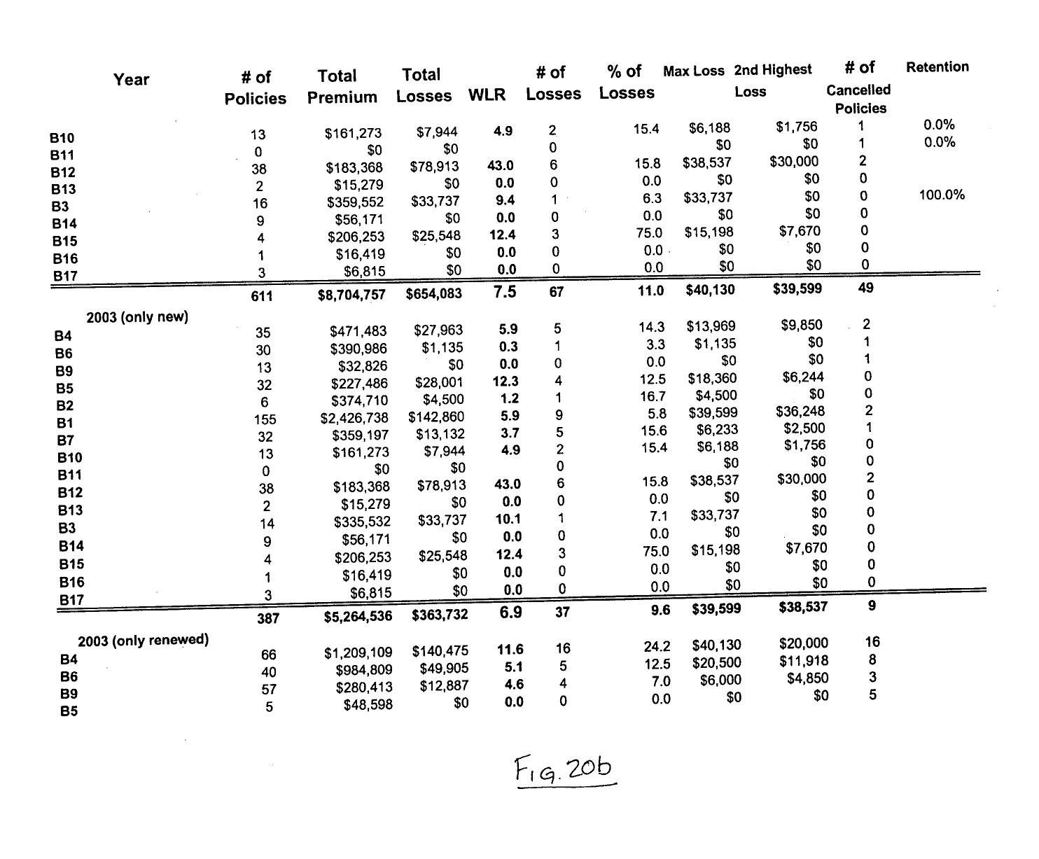

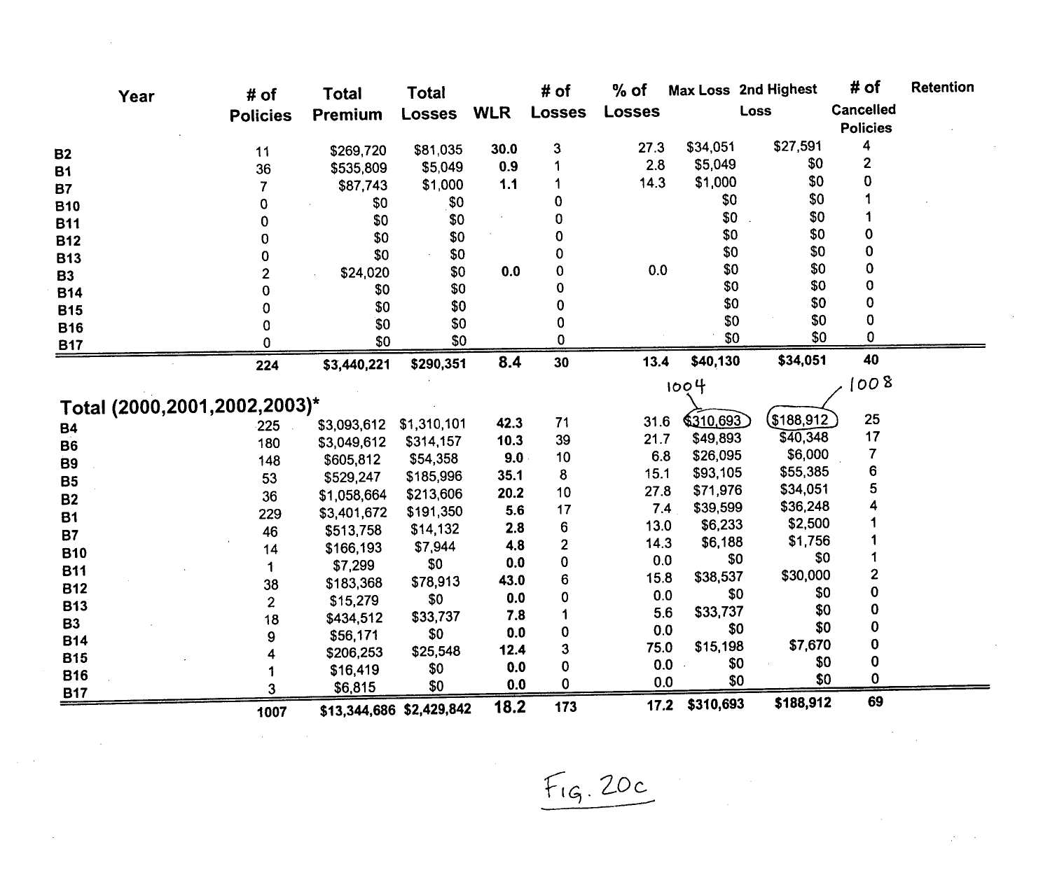

FIGS. 20a to 20c illustrate a portion of the broker summary sheet 824. Again, like the policy summary sheet 816, the broker summary sheet 824 provides measures of the performance of the policies generated by each broker during each calendar year as a result of the campaigns. Breakdowns are provided for each calendar year, for new policies, and for renewed policies. The measures include the number of policies, the total premium, the total losses, the loss to premium ratio, the number of losses, the losses to policies ratio, the maximum loss, the second highest loss, the number of cancelled policies and the retention rate.

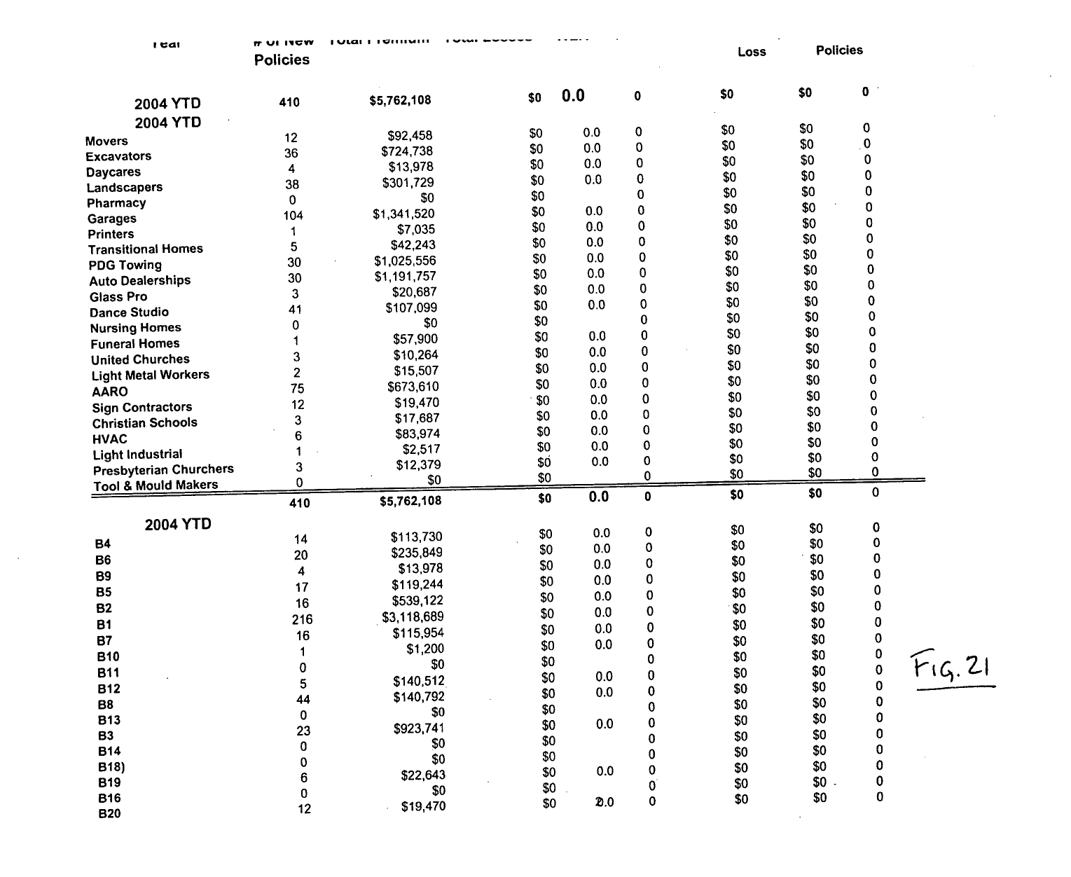

FIG. 21 illustrates a section of the new policies summary sheet 828. Like the policy summary sheet 816, the new policies summary sheet 828 provides measures of the performance of the new policies generated as a result of each campaign and each broker in the current calendar year. Breakdowns are provided for the current calendar year for new policies. The measures include the number of policies, the total premium, the total losses, the loss to premium ratio, the number of losses, the maximum loss, the second highest loss and the number of cancelled policies.

The workbook 800 performs data validity checks of the sales and marketing data imported from the sales and marketing application and the policy administration system. These checks are performed in the annual summary sheets 808.

Referring back to FIGS. 16a to 16d, sales and marketing data that is imported into the data import sheet 804 from the sales and marketing application is first verified and then presented in the second portion 870 of the annual summary sheets 808. Each of the fields of the second portion 870 is updated dynamically in response to the importation of the policy data into the data import sheet 804. If the policy data is inconsistent with the policy data from the sales and marketing application, notification text in the booked premium field 872, and also in the premium renewal and total losses fields, provides an indication of the inconsistency and the general cause of the inconsistency.

The workbook 800 employs data-validation formulas in the annual summary sheets 808 to validate the imported policy data and present results if the data is validated. The formulas employ a set of nested conditions that check the records entered into the data import sheet 804. The records entered into the data import sheet 804 determine whether the data entered into the data import sheet 804 corresponds to the entities for which data is required and vice-versa. In the annual summary sheets 808, the entities are individual policies.

A cell 896 shows data retrieved from the data import sheet 804 for the amount of booked premium for the 2000 calendar year. If, however, an error is detected in the data in the import data sheet 804 for the policy number with which the cell 896 is associated (i.e. cbc 0601082), a notification message is visually indicated instead of the amount of booked premium. In this manner, a user of the workbook 800 can quickly determine if there are errors in the data in the data import sheet 804.

Primary sources of inconsistency in the policy data and the sales and marketing data include missing or duplicate entries for a policy, incorrect policy numbers, incorrect policy anniversary dates and text strings other than “cancelled policy”, which is the only expected and allowable text string. Such inconsistencies are errors and should be rectified.

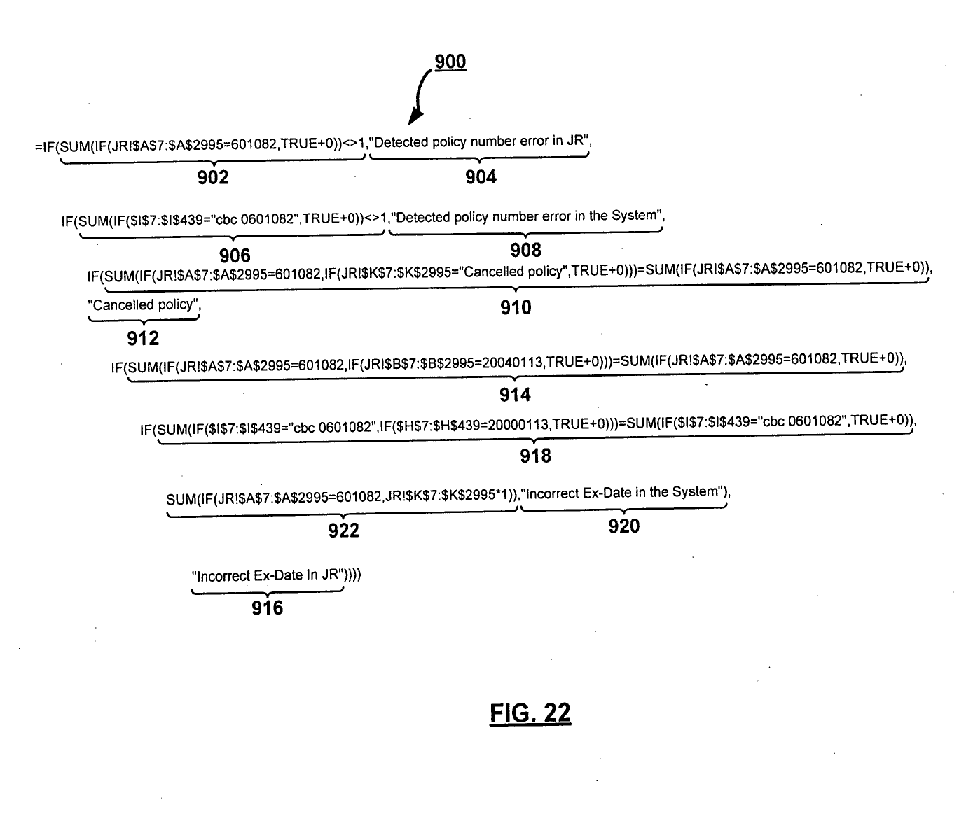

FIG. 22 illustrates an example of a formula 900 from the annual summary sheet 808 for the 2000 calendar year shown in FIGS. 16a to 16d. The formula forms part of a record for a policy number. The principal purpose of the formula is to retrieve the booked premium for the 2000 calendar year for the particular policy number from the policy data. Alternatively, if a record for a referenced policy is marked as cancelled, the formula will visually indicate a cancelled policy message. The policy numbers come from the marketing and sales application. The formula 900 checks if the data corresponding to the entity (i.e., policy number) is present in the data import sheet 804 and is valid, and checks whether the number of occurrences of the entity in the summary is correct. If there is more than one occurrence of the policy number in an annual summary sheet 808, the policy data for the policy number may be accidentally double-counted.

As can be seen, the formula 900 uses a set of nested IF(condition,then,else) functions to serially perform a number of checks on the data. In a first condition 902, it is determined whether the number of records in the data import sheet 804 that match the policy with which the formula 900 is associated is not equal to one. The first condition 902 checks all of the policy numbers in the data import sheet 804 using an array calculation. If no records in the data import sheet 804 match the policy number with which the formula 900 is associated, data for the specific policy number is deemed to be missing. Alternatively, if two or more records in the data import sheet 804 match the policy number with which the formula 900 is associated, the data in the data import sheet 804 for the specific policy is deemed to be suspect and unreliable. In both cases, any data that could be returned by a formula may not be accurate and it is desirable to correct the data instead of relying on potentially-inaccurate results reported by the workbook 800. As a result, if the first condition 902 is true, a first error message 904 is visually displayed in the cell 896.

If the first condition 902 is false, i.e., no error is returned, a second condition 906 is checked. The second condition 906 checks all of the policy numbers in the annual summary sheet 808 for the 2000 calendar year using an array calculation. If no records in the annual summary sheet 808 for the 2000 calendar year match the policy number with which the formula 900 is associated, data for the policy number present in the data import sheet 804 may not be properly reported through the annual summary sheet 808. Alternatively, if two or more records in the annual summary sheet 808 match the policy number with which the formula 900 is associated, data in the data import sheet 804 for the specific policy may be reported more than once, potentially leading to inaccurate results. Once again, in both cases, data that could be returned by the formula may not be accurate and it is desirable to flag the data as requiring attention instead of relying on potentially-inaccurate results reported by the workbook 800. As a result, if the second condition 906 is true, a second error message 908 is visually displayed in the cell 896.

If the second condition 906 is false, i.e., no error is returned, a third condition 910 is checked. The third condition 910 checks to see if the record in the data import sheet 804 corresponding to the policy number with which the formula 900 is associated is marked as a cancelled policy. If the record in the data import sheet 804 corresponding to the policy number with which the formula 900 is associated is marked as cancelled, a cancelled policy message 912 is visually indicated to denote that the policy has been cancelled.

If the third condition 910 is false (that is, none of the records in the data import sheet 804 corresponding to the policy number with which the formula 900 is associated are marked as cancelled), a fourth condition 914 is checked. The fourth condition 914 checks to see if the record in the data import sheet 804 corresponding to the policy number with which the exemplary formula 900 is associated has an appropriate policy anniversary date. If the record in the data import sheet 804 corresponding to the policy number with which the formula 900 is associated does not have an appropriate policy anniversary date (that is, if the fourth condition 914 is not true), a third error message 916 is visually indicated.

If the fourth condition 914 is true, a fifth condition 918 is checked. The fifth condition 918 checks to see if the record in the annual summary sheet 808 with which the formula 900 is associated includes the appropriate policy issue date. If the record in the annual summary sheet 808 with which the formula 900 is associated does not include the appropriate policy issue date, a fourth error message 920 is visually indicated.

If the record in the annual summary sheet 808 with which the formula 900 is associated includes the appropriate policy issue date, a result 922 is calculated and indicated. The result 922 is the booked premium for the 2000 calendar year retrieved from the corresponding record in the data import sheet 804. Note that the records for which result 922 is calculated do not contain the text string “Cancelled policy”, but may contain other text strings. During the calculation of result 922, an intermediate result is firstly determined by multiplying the calculation by one. If the intermediate result is a number, the result 922 is simply equal to the intermediate result. If, instead, the intermediate result contains a text string, a fifth error message, “#VALUE”, relating to the calculation error in the cell is displayed.

For a record containing a text string, the result 922 would be equal to zero if the intermediate result is not multiplied by one. This would cause a zero premium to be calculated for records containing unexpected text strings. It is therefore desired to flag records containing unexpected text strings so that the unexpected text strings can be examined and rectified.

In this manner, multiple error checks are performed on the consistency of the data from the marketing and sales application and the policy data from the policy administration system and provide a visual indication of errors present therein.

In order to analyze performance of the campaigns, it is helpful to have detailed information about premiums realized and losses incurred. Referring again to FIGS. 20a to 20c, a portion of the broker summary sheet 824 is shown indicating various statistics for each individual broker for each calendar year and a summary across all calendar years. In particular, the statistics include the number of policies, the total premium realized, the total losses incurred, the written loss ratio, the number of losses or paid-out claims, the ratio of claims to the number of policies issued, the maximum single loss, the second-highest single loss, the number of cancelled policies and the retention rate. The information for each broker for each year is retrieved from the respective annual summary sheets 808.

When such summaries are prepared, providing both the maximum and the second-highest single loss can provide a better understanding of other loss metrics. While the calculation of the maximum single loss is not generally difficult, determining the second-highest single loss presents challenges. For purposes of illustration, the determination of an overall maximum loss 1004 and an overall second-highest loss 1008 for broker “B4” over all calendar years as shown in FIG. 20c will now be described.

The overall maximum single loss 1004 for the broker “B4” across all calendar years is determined using the MAX(list/array) function available in Microsoft Excel. As the overall maximum single loss 1004 would also be the maximum single loss for the policies issued by the broker “B4”, only the list of maximum single losses for this broker is required as an argument for the MAX(list/array) formula to determine the overall maximum single loss 1004.

The calculation of the overall second-highest single loss 1008 is, however, more complex. The overall second-highest single loss 1008 can occur in the maximum single loss column for records corresponding to the broker “B4” (i.e., as the maximum single loss for a different calendar year than the one in which the overall maximum single loss occurred). Alternatively, unlike the overall maximum single loss 1004, the overall second-highest single loss 1008 can occur in the second-highest single loss column for the particular calendar year in which the maximum single loss occurred. In either of these cases, it is possible that the overall second-highest single loss 1008 can be equal to the overall maximum single loss 1004.

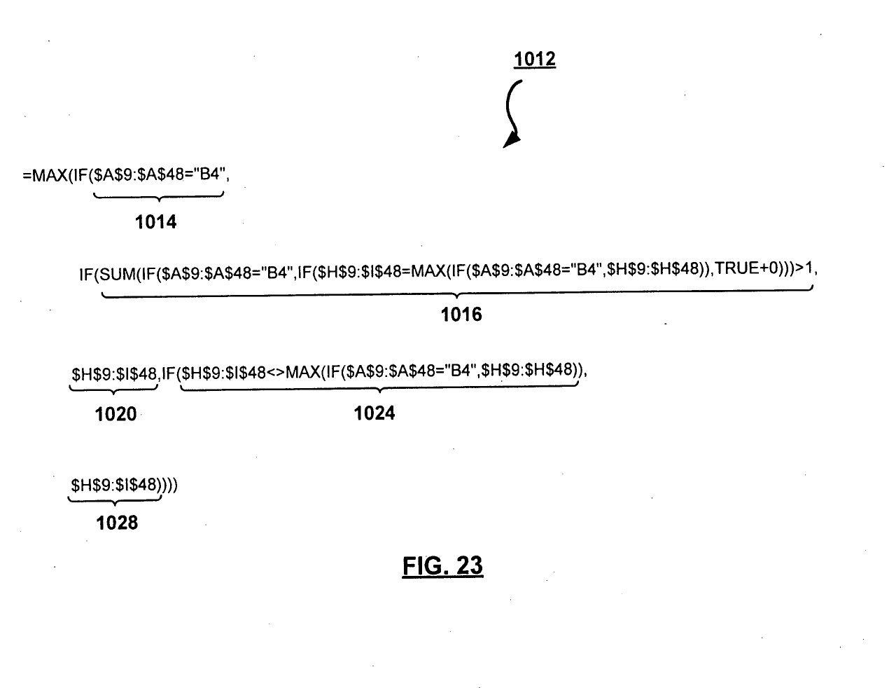

FIG. 23 illustrates a formula 1012 used to determine the overall second-highest single loss 1008. A first condition 1014 is used to select those entries corresponding to a particular broker. A second condition 1016 is used to determine whether there is more than one loss equal to the overall maximum single loss 1004 for the particular broker. The condition is determined by checking how many entries in the maximum single loss and second-highest single loss columns are equal to the overall maximum single loss 1004 for that particular broker using an array function. If it is determined that there is more than one loss in the maximum single loss and second-highest single loss columns equal to the overall maximum single loss 1004 for that particular broker, the overall second-highest single loss 1008 is set equal to the overall maximum highest loss 1008 at 1020. Otherwise, those loss entries for the broker “B4” that are not equal to the maximum single loss are located in the maximum single loss and second-highest single loss columns using the condition 1024, and the highest value from these entries is selected as the overall second-highest single loss at 1028. This is, again, determined using an array function.

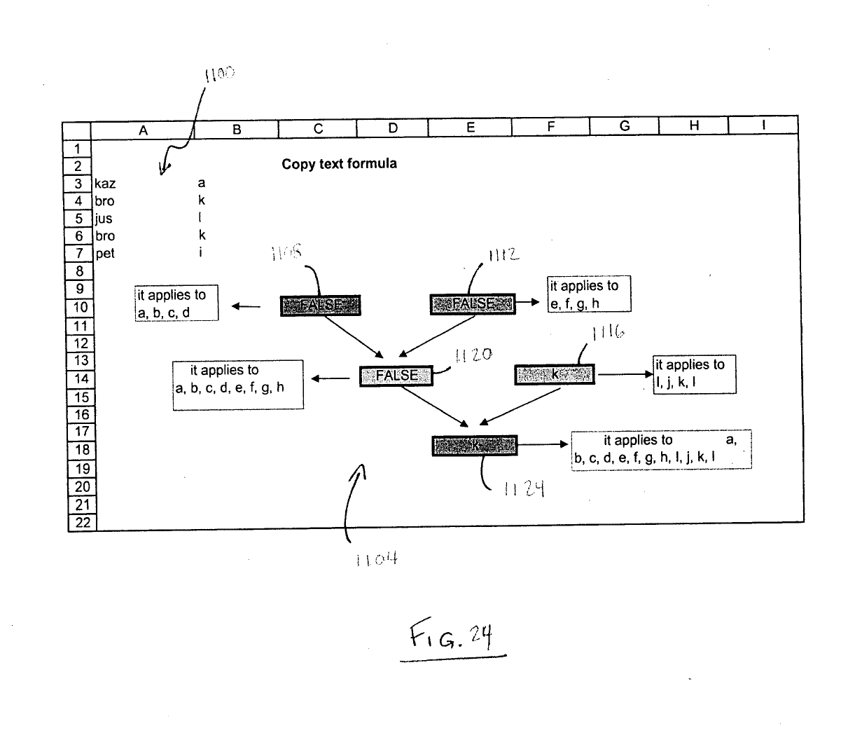

Another application of data-validation formulas similar to that shown in FIG. 22 is illustrated in FIG. 24, wherein an exemplary scenario is employed to validate data and present results. An exemplary data set 1100 is shown comprising five records of data, each having two fields. In order to validate the data to ensure that each record having a first characteristic also has a second characteristic, analysis is performed on the data set 1100 via a set of calculations 1104. The calculations 1104 include a first check calculation 1108, a second check calculation 1112, a third check calculation 1116, a sub-aggregator calculation 1120 and an aggregator calculation 1124. By employing a set of formulas to perform individual checks and then aggregate these checks, the number of checks performed in generating a result can be higher than otherwise possible due to the limitations that presently exist for formula entry boxes in such spreadsheet applications.

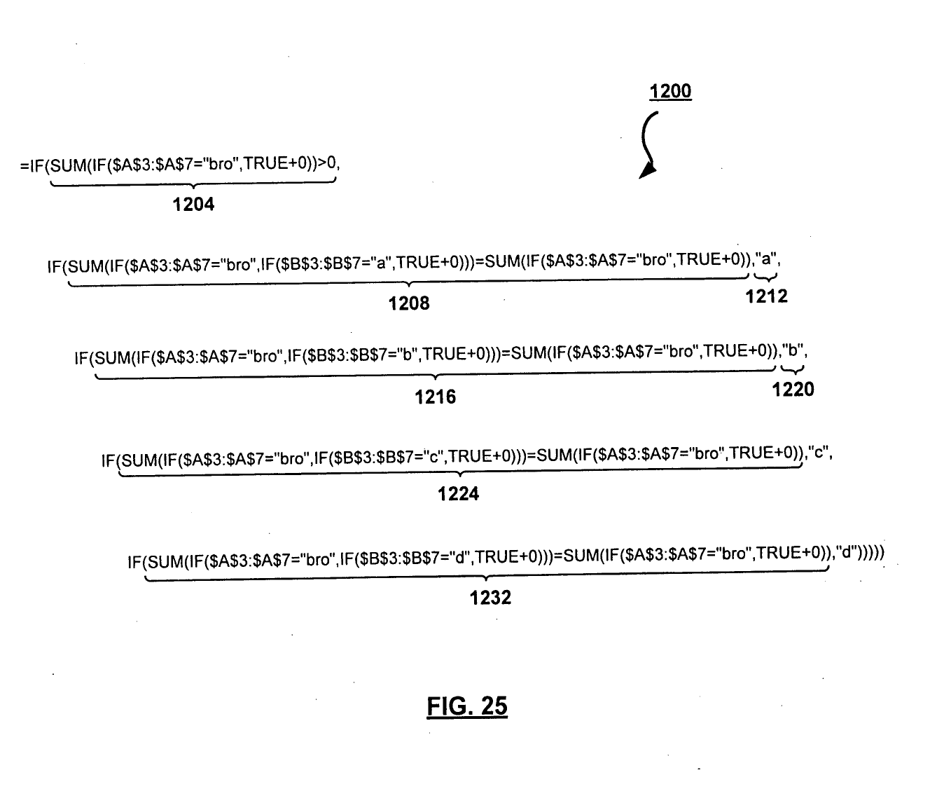

FIG. 25 illustrates a first check formula 1200 performing the first check calculation 1108. An initial condition 1204 is used to determine whether the data set 1100 includes a record with a particular characteristic; that is, whether any of the records in the data set 1100 has the string “bro” in the first field. The initial condition 1204 employs an array formula to check a plurality of records simultaneously, then totals the number of records that have the particular characteristic. If it is determined that one or more records have the particular characteristic (i.e. the string “bro” in the first field), a set of nested conditions is used to determine whether those records have a common second characteristic in a second field. The records are iteratively checked to determine whether there is a one-to-one relationship between the characteristics of the first field and the characteristics of the second field. In a first nested condition 1208, it is determined whether the records with a particular first characteristic (i.e., the string “bro”) match those records with both the first characteristic and a particular second characteristic. If there is a match, the particular second characteristic (i.e., the string “a”) is outputted at 1212. Otherwise a second nested condition 1216 is checked, wherein it is determined whether the records with a particular first characteristic (i.e., the string “bro”) match those records with both the first characteristic and another particular second characteristic (i.e., the string “b”). If there is a match, the particular second characteristic is outputted at 1220. The first nested condition 1208, the second nested condition 1216, a third nested condition 1224 and a fourth nested condition 1232 are checked in sequence upon failure of the preceding condition. If it is determined that there are no records that have the particular characteristic in the first field, “false” is returned. In the case where the records having a common selected second characteristic share a common first characteristic other than “a”, “b”, “c” or “d”, all of the conditions 1208, 1216, 1224 and 1232 fail and “false” is returned. In the case where the records do not share a common second characteristic, all of the conditions 1208, 1216, 1224 and 1232 fail and “false” is returned.

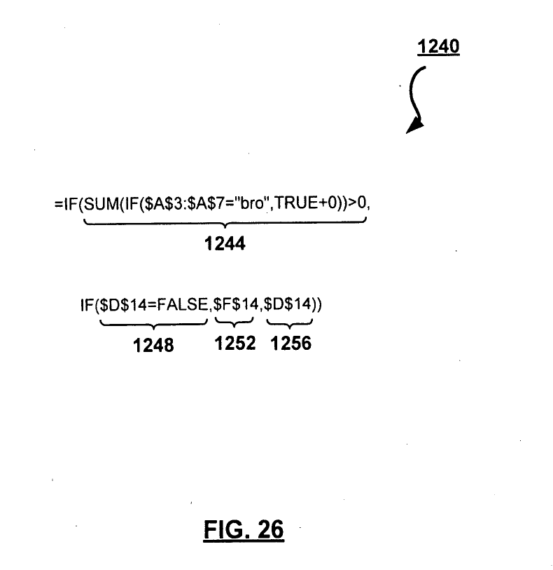

FIG. 26 illustrates an aggregation function 1240 that performs the aggregator calculation 1124. A first condition 1244 is checked to determine if there is an occurrence of the string “bro” in the data set 1100. The first condition 1244 uses an array calculation to check the entire data set 1100 at the same time. If there is an occurrence of the string “bro” in the data set 1100, a second condition 1248 is checked to determine if the sub-aggregator calculation 1120 returns “FALSE”; that is, if any of the eight particular characteristics from the first and second check calculations 1108, 1112 were not found consistently beside each occurrence of the string “bro” in the data set 1100. If the sub-aggregator calculation 1120 returns “FALSE”, the results of the third check calculation 1116 are returned at 1252. Otherwise, the results of the sub-aggregator calculation 1120 are returned.

Such formulas are also used, among other things, for referencing loss values for each record. Using such a formula structure, a plurality of checks can be performed to verify the consistency of the data.

By importing data in ASCII text format into the data import sheet 804 of the workbook 800, the imported data is automatically incorporated in calculated results. The data imported into the data import sheet 804 is first summarized by policy year in the annual summary sheets 808, which use a number of formulas to reference the data for each policy year in the data import sheet 804. All of the reference calculations performed in fields 812 to 828 are automatically calculated from the data in the annual summary sheets 808 through various formulas. The workbook contains tens of thousands of linked formulas and their number increases in each subsequent year that the workbook is employed.

While a method of calculating the overall second-highest loss has been described, the same methodology can be used to calculate a secondary value having a second-highest priority in a list of values using other prioritizations. For example, the second-lowest value in a list of values can be calculated.

Although the above discussion has been made with particular reference to the marketing and sale of insurance, those of skill in the art will appreciate that the systems and methods described herein may be used to market and sell other items.

Also, although embodiments have been described, those of skill in the art will appreciate that variations and modifications may be made without departing from the spirit and scope thereof as defined by the appended claims.

What is claimed is:

1. A method for determining a secondary value having a second-highest priority in a list of values in a spreadsheet, comprising:
determining a primary value having a highest priority in said list of values;
determining if more than one of said values in said list is equal to said primary value; and
determining said secondary value to be equal to said primary value if more than one of the values in said list is equal to said primary value, and determining said secondary value to be equal to one of said list of values not equal to said primary value having a relative highest priority if only one of said values in said list is equal to said primary value.

2. The method of claim 1, wherein said primary value determining comprises determining the maximum value in said list of values.

3. The method of claim 1, wherein said primary value determined comprises determining the minimum value in said list of values.

4. The method of claim 1, wherein said primary value determining is performed using a built-in function.

5. The method of claim 1, wherein said secondary value determining is performed using an array formula.

6. The method of claim 5, wherein said list of values that are not equal to said primary value is determined using an array formula.

7. The method of claim 1, wherein determining if more than one of said values in said list is equal to said primary value is performed using an array formula.

8. A method for verifying data in a spreadsheet, said data including a set of records, said method comprising:
determining if each of a subset of said set of records having a first common trait share a second common trait; and
indicating whether said subset of said sets of records share said second common trait.

9. The method of claim 8, wherein said first common trait corresponds to a first entry in a first field of said records.

10. The method of claim 9, wherein said second common trait corresponds to a second entry in a second field of said records.

11. The method of claim 10, wherein said indicating comprises providing notification text in a cell of said spreadsheet.

12. The method of claim 11, wherein said providing notification text comprises indicating said second common trait if said subset of said set of records share said second common trait.

13. The method of claim 12, wherein said providing notification text further comprises indicating that said subset of said set of records do not share said second common trait.

14. A method of verifying data in a spreadsheet, comprising:
placing a set of records in said spreadsheet;
locating a subset of said records corresponding to an entity;
checking whether said records in said subset are valid; and
providing a visual notification when at least one of the following conditions is met: the number of said records in said subset is undesirable, and at least one of said records in the subset are invalid.

15. The method of verifying data of claim 14, wherein said providing comprises providing said visual notification when said subset contains at least two of said records in the subset are invalid.

16. The method of verifying data of claim 14, wherein said checking comprises determining whether data in said records of said subset satisfies a criteria.

17. The method of verifying data of claim 16, wherein said conditions are nested in a formula.
